(19) United States
(12) Patent Application Publication
(10) Pub. No.: US 2026/0246149 A1
(43) Pub. Date: Aug. 20, 2026

(54) ANTENNA ELEMENT, ANTENNA ARRAY, AND ANTENNA MODULE

(71) Applicant: Sony Semiconductor Solutions Corporation, Kanagawa (JP)

(72) Inventors: Tomomichi Murakami, Tokyo (JP); Yoshitaka Yoshino, Tokyo (JP); Satoru Tsuboi, Kanagawa (JP); Takatoshi Tsuji, Tokyo (JP); Shin Ueda, Kanagawa (JP)

(21) Appl. No.: 19/161,946

(22) PCT Filed: Jan. 31, 2024
(86) PCT No.: PCT/JP2024/002987

§ 371 Date: Sep. 3, 2025

(30) Foreign Application Priority Data
Apr. 11, 2023 (JP) 2023-064170

(51) Int. Cl. H01Q 13/00; H01Q 1/32

(52) U.S. Cl. CPC H01Q 13/00; H01Q 1/32

(57) ABSTRACT

An antenna element according to an embodiment of the present technology includes: a dielectric block; a power feeding terminal provided in the dielectric block; a pair of conductor layers opposing each other with the dielectric block interposed therebetween; and an antenna opening portion which forms, in a plane direction along the pair of conductor layers, a first antenna opening opened in a first axial direction as viewed from the power feeding terminal and a second antenna opening opened in a second axial direction orthogonal to the first axis.

### TECHNICAL FIELD

The present technology relates to an antenna element, an antenna array, and an antenna module that are capable of transmitting or receiving electromagnetic waves of a millimeter wave, for example.

### BACKGROUND ART

In recent years, millimeter wave modules that detect people and obstacles, such as a radar, have prevailed mainly for in-vehicle use. A mainstream antenna device of this type is a phased patch antenna formed on a substrate. However, since radio waves are radiated in a direction perpendicular to a substrate surface, this antenna is difficult to be thinned.

Meanwhile, there is known a horn antenna that uses a technology called a post-wall waveguide (see, for example, Patent Literature 1). The post-wall waveguide is a waveguide including a post wall formed by arranging a plurality of metal columns (conductor posts) that electrically connects upper and lower conductors (copper foils) of a wiring substrate. Since the post-wall waveguide includes an antenna opening on a side surface of the wiring substrate, thinning of the antenna can be realized.

### CITATION LIST

### Patent Literature

Patent Literature 1: WO 2022/097490

### DISCLOSURE OF INVENTION

### Technical Problem

However, in the antenna that radiates radio waves from the post-wall waveguide, the waveguide from a power feeding terminal to the antenna opening is sectioned by a conductor post, so a directivity is narrowed to a forward direction, thus making it difficult to apply the antenna to usages that require detection of objects at a wide viewing angle.

In view of the circumstances as described above, the present technology aims at providing an antenna element, an antenna array, and an antenna module that are capable of detecting an object at a wide viewing angle while realizing thinning of an antenna.

### Solution to Problem

An antenna element according to an embodiment of the present technology includes: a dielectric block; a power feeding terminal provided in the dielectric block; a pair of conductor layers opposing each other with the dielectric block interposed therebetween; and an antenna opening portion which forms, in a plane direction along the pair of conductor layers, a first antenna opening opened in a first axial direction as viewed from the power feeding terminal and a second antenna opening opened in a second axial direction orthogonal to the first axis.

An antenna array according to an embodiment of the present technology includes: a dielectric block; a plurality of power feeding terminals provided in the dielectric block; a pair of conductor layers opposing each other with the dielectric block interposed therebetween; and an antenna opening portion which forms, in a plane direction along the pair of conductor layers, a first antenna opening opened in a first axial direction as viewed from the power feeding terminals and a second antenna opening opened in a second axial direction orthogonal to the first axis.

An antenna module according to an embodiment of the present technology includes: a transmission antenna constituted of the antenna element; and a reception antenna constituted of the antenna array.

### BRIEF DESCRIPTION OF DRAWINGS

FIG. 1 A partial transmissive perspective view showing an antenna element according to an embodiment of the present technology.

FIG. 2 A plan view of the antenna element.

FIG. 3 A cross-sectional side view schematically showing a layer structure of the antenna element.

FIG. 4 An explanatory diagram of the layer structure of a dielectric multilayer substrate constituting the antenna element.

FIG. 5 A schematic diagram for explaining a gap between conductive columnar bodies in the antenna element.

FIG. 6 A partial exploded perspective view showing a configuration example of a power feeding portion in the antenna element.

FIG. 7 A cross-sectional side view of a main portion of the power feeding portion.

FIG. 8 A partial cross-sectional side view showing another configuration example of the power feeding portion.

FIG. 9 A simulation result showing an example of a voltage standing wave ratio (VSWR: Voltage Standing Wave Ratio) of the antenna element.

FIG. 10 A simulation result showing radiation characteristics of the antenna element in an azimuth plane.

FIG. 11 A simulation result showing the radiation characteristics of the antenna element in an elevation plane.

FIG. 12 Another simulation result showing VSWR characteristics of the antenna element.

FIG. 13 A simulation result showing radiation characteristics of an antenna element having the characteristics shown in FIG. 12 in the azimuth plane.

FIG. 14 A simulation result showing the radiation characteristics of the antenna element having the characteristics shown in FIG. 12 in the elevation plane (XZ plane).

FIG. 15 A partial transmissive perspective view showing a configuration of an antenna module according to an embodiment of the present technology.

FIG. 16 A plan view of the antenna module.

FIG. 17 A block diagram showing a circuit configuration of the antenna module.

FIG. 18 A conceptual diagram illustrating a MIMO radar.

FIG. 19 A simulation result showing the VSWR characteristics of each antenna of the antenna module.

FIG. 20 Simulation results showing the radiation characteristics of each reception antenna of the antenna module in the azimuth plane.

FIG. 21 Simulation results showing the radiation characteristics of each reception antenna of the antenna module in the elevation plane.

FIG. 22 A simulation result showing isolation characteristics of each reception antenna with respect to a first transmission antenna in the antenna module.

FIG. 23 A simulation result showing the isolation characteristics of each reception antenna with respect to a second transmission antenna in the antenna module.

FIG. 24 A simulation result showing an example of phase difference characteristics of reception radio waves.

FIG. 25 A plan view of a main portion of an antenna module according to another embodiment of the present technology.

FIG. 26 Simulation result showing the radiation characteristics of each reception antenna of the antenna module in the azimuth plane.

FIG. 27 Simulation results showing the radiation characteristics of each reception antenna of the antenna module in the elevation plane.

FIG. 28 A simulation result showing the isolation characteristics of each reception antenna with respect to the first transmission antenna in the antenna module.

FIG. 29 A simulation result showing the isolation characteristics of each reception antenna with respect to the second transmission antenna in the antenna module.

FIG. 30 A simulation result showing an example of the phase difference characteristics of reception radio waves of the antenna module.

FIG. 31 A plan view of a main portion showing another configuration example of a shield portion in the antenna module.

FIG. 32 A plan view of a main portion showing another configuration example of a waveguide plate portion of the antenna element.

FIG. 33 A plan view of an antenna module according to a fourth embodiment of the present technology as viewed from above.

FIG. 34 A plan view showing an internal structure of the antenna module as viewed from above.

FIG. 35 A plan view of the antenna module as viewed from below.

FIG. 36 A simulation result showing the VSWR characteristics of each antenna of the antenna module.

FIG. 37 Simulation results showing the radiation characteristics of each antenna of the antenna module in the azimuth plane.

FIG. 38 Simulation results showing the radiation characteristics of each antenna of the antenna module in the elevation plane.

FIG. 39 A simulation result showing the isolation characteristics of each reception antenna with respect to one of the transmission antennas in the antenna module.

FIG. 40 A simulation result showing the isolation characteristics of each reception antenna with respect to the other one of the transmission antennas in the antenna module.

FIG. 41 A simulation result showing an example of the phase difference characteristics of reception radio waves of the antenna module.

FIG. 42 A plan view of an antenna module according to a fifth embodiment of the present technology as viewed from above.

FIG. 43 A plan view showing an internal structure of the antenna module as viewed from above.

FIG. 44 A plan view of the antenna module as viewed from below.

FIG. 45 A partial transmissive perspective view showing a main portion of the antenna module.

FIG. 46 A simulation result showing the VSWR characteristics of each antenna of the antenna module.

FIG. 47 Simulation results showing the radiation characteristics of each antenna of the antenna module in the azimuth plane.

FIG. 48 Simulation results showing the radiation characteristics of each antenna of the antenna module in the elevation plane.

FIG. 49 A simulation result showing the isolation characteristics of each reception antenna with respect to one of the transmission antennas in the antenna module.

FIG. 50 A simulation result showing the isolation characteristics of each reception antenna with respect to the other one of the transmission antennas in the antenna module.

FIG. 51 A simulation result showing an example of the phase difference characteristics of reception radio waves of the antenna module.

FIG. 52 A partial transmissive perspective view showing an antenna element according to a sixth embodiment of the present technology.

FIG. 53 A plan view of the antenna element as viewed from above.

FIG. 54 A plan view showing an internal structure of the antenna element.

FIG. 55 A cross-sectional view showing a layer structure of the antenna element.

FIG. 56 Maps showing a temporal change of an electric field intensity distribution in the antenna element.

FIG. 57 A simulation result showing the VSWR characteristics of the antenna element.

FIG. 58 Simulation results showing the radiation characteristics of the antenna element in the azimuth plane and the elevation plane.

FIG. 59 A simulation result showing a relationship between a depth of a second post waveguide and a beam width in the antenna element.

FIG. 60 A partial transmissive perspective view of an antenna module according to a seventh embodiment of the present technology.

FIG. 61 A plan view of the antenna module as viewed from above.

FIG. 62 Maps showing the electric field intensity distribution in the antenna module and an antenna module given as a comparative example.

FIG. 63 A simulation result showing the VSWR characteristics of each antenna of the antenna module.

FIG. 64 Simulation results showing the radiation characteristics of each antenna of the antenna module in the azimuth plane.

FIG. 65 Simulation results showing the radiation characteristics of each antenna of the antenna module in the elevation plane.

FIG. 66 A simulation result showing the isolation characteristics of each reception antenna with respect to each transmission antenna in the antenna module.

FIG. 67 A simulation result showing an example of the phase difference characteristics of the antenna module.

FIG. 68 A cross-sectional view showing a modified example of the configuration of the power feeding portion.

### MODES FOR CARRYING OUT THE INVENTION

Hereinafter embodiments according to the present technology will be described with reference to the drawings.

### First Embodiment

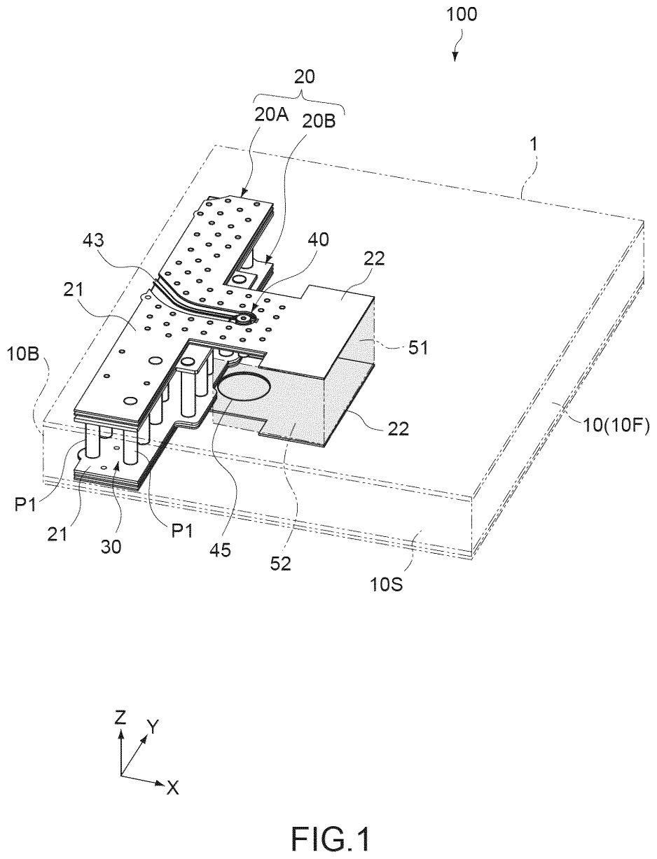

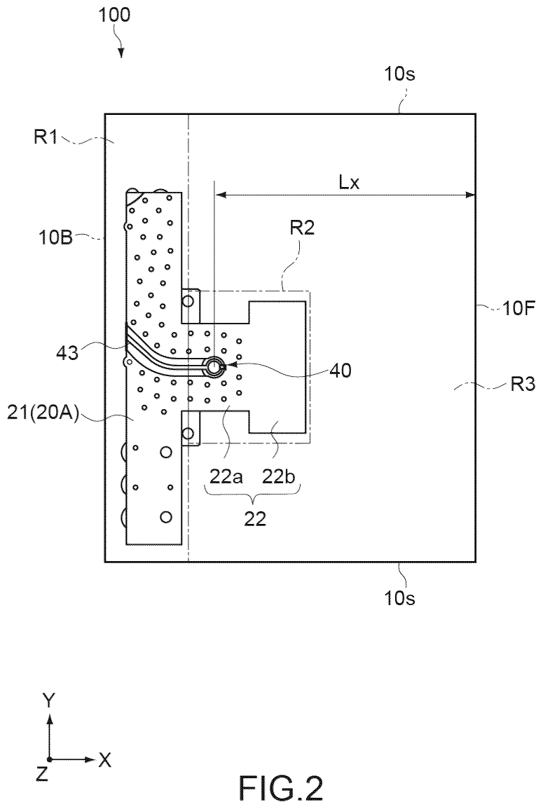

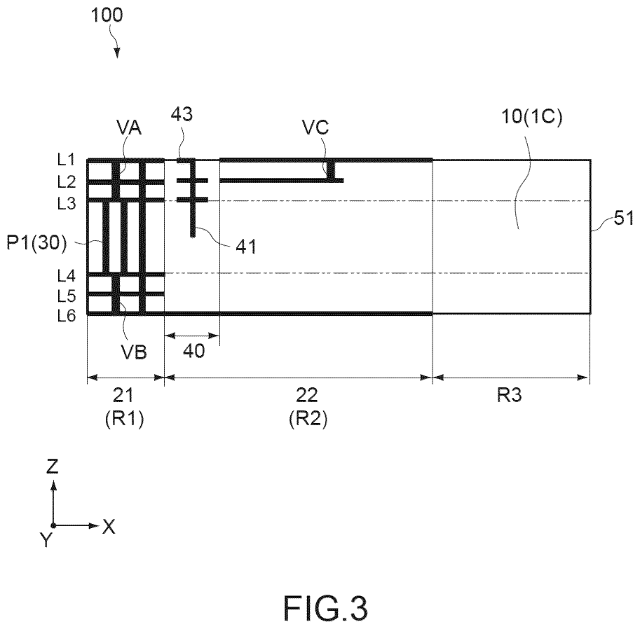

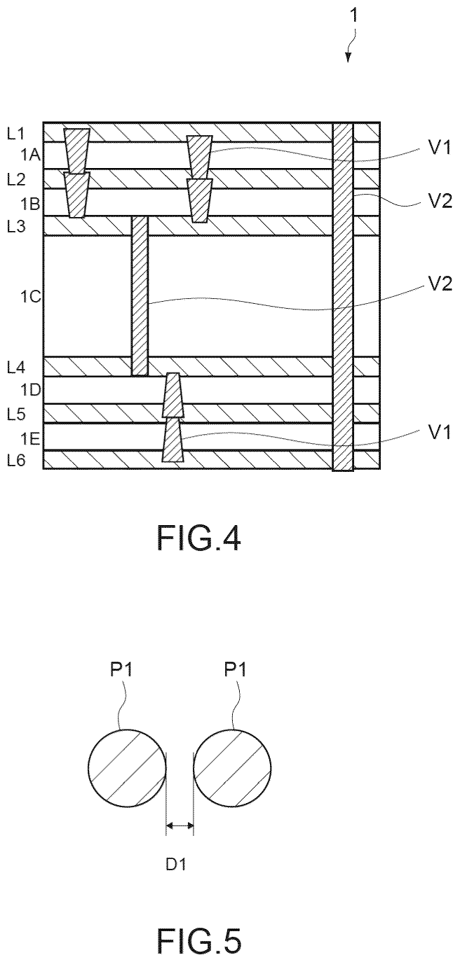

FIG. 1 is a partial transmissive perspective view showing an antenna element 100 according to a first embodiment of the present technology, FIG. 2 is a plan view of the antenna element 100, FIG. 3 is a cross-sectional side view schematically showing a layer structure of the antenna element 100, and FIG. 4 is an explanatory diagram of a layer structure of a dielectric multilayer substrate 1 constituting the antenna element 100.

It is noted that in each figure, an X axis (first axis), a Y axis (second axis), and a Z axis (third axis) indicate three axial directions orthogonal to one another, and respectively correspond to a length direction (front-rear direction), a width direction (left-right direction), and a thickness direction (height direction) of the antenna element 100.

### Antenna Element

The antenna element 100 is constituted of a dielectric multilayer substrate 1 having a thickness direction in the Z axis direction. First, the dielectric multilayer substrate 1 will be described.

### Dielectric Multilayer Substrate

As shown in FIG. 4, the dielectric multilayer substrate 1 includes, from the top, a plurality of (five in this example) dielectric layers 1A to 1E and a plurality of (six in this example) wiring layers L1 to L6 arranged individually among these dielectric layers 1A to 1E. The thickness of the dielectric multilayer substrate 1 is, for example, about 1.6 mm.

The dielectric layers 1A to 1E are formed of an insulating organic material such as an epoxy-based resin and a fluorine-based resins such as polytetrafluoroethylene, or an insulating inorganic material such as ceramics. The dielectric layers 1A to 1E may be formed of the same type of dielectric material, or the layers may be formed of different dielectric materials. A dielectric constant of the dielectric layers 1A to 1E can be set arbitrarily according to a frequency of radio waves to be transmitted or received by the antenna element 100. For example, in a case of transmitting and receiving radio waves (millimeter waves) in a 60 GHz band (60 GHz to 64 GHz in the present embodiment), a material with a dielectric constant of, for example, 3.6 is used for the dielectric layers 1A to 1E.

The thickness of each of the dielectric layers 1A to 1E can also be set arbitrarily, and in the present embodiment, a core material having a larger thickness than the other dielectric layers 1A, 1B, 1D, and 1E is used for the dielectric layer 1C. This makes it easier to ensure rigidity of the dielectric multilayer substrate 1 and enables manufacturing costs of the dielectric multilayer substrate 1 to be reduced as compared to a case where the dielectric layer 1C is constituted of a laminated body of dielectric layers. The thickness of the dielectric layer 1C is set to, for example, 1.1 mm. The dielectric layer 1C corresponds to a dielectric block according to the present technology.

Meanwhile, a prepreg material can be applied to the dielectric layers 1A, 1B, 1D, and 1E. In this case, the dielectric layers 1A, 1B, 1D, and 1E are laminated on both sides of the dielectric layer 1C by a build-up method. When the dielectric constant of the dielectric layers 1A, 1B, 1D, and 1E is set to 3.6, a wavelength of electromagnetic waves that propagate through the dielectric layers 1A, 1B, 1D, and 1E at a frequency of 60 GHz is shortened from about 5 mm to 2.64 mm. In this case, the thickness of each of the dielectric layers 1A, 1B, 1D, and 1E can be set to about 60 μm.

The wiring layers L1 to L6 are typically formed of a metal material, and a copper foil of a predetermined thickness is used in the present embodiment. Each of the wiring layers L1 to L6 is patterned into a predetermined shape. Therefore, in a non-circuit forming area where no wiring exists, the upper and lower dielectric layers are directly laminated without an intervening wiring layer.

The wiring layers L1 to L6 are electrically connected to one another at arbitrary positions. As interlayer connection portions that connect the wiring layers L1 to L6, a form of connecting two adjacent wiring layers (through-holes (also called LVHs) V1 in FIG. 4) or a form of commonly connecting three or more wiring layers (through-holes (also called IVHs) V2 in FIG. 4) can be applied. The through-holes V1 and V2 are not limited to hollow holes and may be constituted of metal columns, the insides of which are filled with a conductor such as a metal plug or metal plating.

Next, respective portions of the antenna element 100 will be described in detail with reference to FIGS. 1 to 3.

The antenna element 100 according to the present embodiment includes a dielectric block 10, a conductor layer 20, a rear post wall 30, and a power feeding portion 40. The antenna element 100 may be configured as a transmission antenna, a reception antenna, or a transmission/reception antenna. Herein, a case where the antenna element 100 is configured as a transmission antenna will be described as an example, but the antenna element 100 may alternatively be configured as a reception antenna or a transmission/reception antenna.

### Dielectric Block

The dielectric block 10 corresponds to the dielectric layer 1C in the dielectric multilayer substrate 1 described above. The dielectric block 10 is constituted of a core material in a single layer, which has a thickness direction in the Z axis direction and is parallel to the XY plane.

As shown in FIG. 2, the dielectric block 10 includes a front surface 10F, a rear surface 10B, and two side surfaces 10S. As shown in FIG. 1, the front surface 10F opposes a first antenna opening 51 of the antenna element 100 in the X axis direction, and both side surfaces 10S respectively oppose second antenna openings 52 of the antenna element 100 in the Y axis direction.

Furthermore, as conceptually shown in FIG. 2, the dielectric block 10 is mainly sectioned into a first region R1, a second region R2, and a third region R3. The first region R1 is a region where the rear post wall 30 is provided, the second region R2 is a region where the power feeding portion 40 is provided, and the third region is a region where radio waves radiated from the first antenna opening 51 and the second antenna openings 52 propagate. The first to third regions R1 to R3 are three-dimensional regions formed across the entire thickness direction of the dielectric block 10. It is noted that the first to third regions R1 to R3 are virtual regions for explaining arrangement regions of the conductor layer 20 and the like.

### Conductor Layer

The conductor layer 20 includes a pair of conductor layers 20A and 20B provided on both main surfaces of the dielectric block 10. Herein, the conductor layer 20 provided on the front surface (upper surface in FIG. 1) of the dielectric block 10 will also be referred to as a first conductor layer 20A, and the conductor layer 20 provided on the back surface (lower surface in FIG. 1) of the dielectric block 10 will also be referred to as a second conductor layer 20B. The first conductor layer 20A corresponds to the wiring layers L1 to L3 in the dielectric multilayer substrate 1, and the second conductor layer 20B corresponds to the wiring layers L4 to L6 in the dielectric multilayer substrate 1.

Each of the first and second conductor layers 20A and 20B includes a base portion 21 and a waveguide plate portion 22. The base portion 21 and the waveguide plate portion 22 are formed integrally and are typically connected to a ground potential.

The base portions 21 are each arranged in the first region R1 of the dielectric block 10 and oppose each other in the thickness direction (Z axis direction) of the dielectric block 10 with the dielectric block 10 interposed therebetween. In the present embodiment, the base portions 21 are each formed in a strip shape elongated in the Y axis direction, but the shape is of course not limited to this. As shown in FIG. 3, the base portion 21 in the first conductor layer 20A is formed by connecting the wiring layers L1 to L3 by a plurality of through-holes VA, and the base portion 21 in the second conductor layer 20B is formed by connecting the wiring layers L4 to L6 by a plurality of through-holes VB.

The waveguide plate portions 22 are each arranged in the second region R2 of the dielectric block 10 and oppose each other in the thickness direction (Z axis direction) of the dielectric block 10 with the dielectric block 10 interposed therebetween, to form a propagation region (waveguide) of radio waves. The waveguide plate portions 22 are each formed to protrude forwardly (+X direction) from the base portion 21 by a predetermined length. As shown in FIG. 3, the waveguide plate portion 22 in the first conductor layer 20A is formed by connecting the wiring layers L1 and L2 by a plurality of through-holes VC, and the base portion 21 in the second conductor layer 20B is formed by the wiring layer L6.

Each of the waveguide plate portions 22 is formed in a generally rectangular shape elongated in the X axis direction. Each of the waveguide plate portions 22 forms a reflection surface that reflects electromagnetic waves at an interface with the dielectric block 10, and radio waves propagate through the second region R2 while being repeatedly reflected by each of the waveguide plate portions 22. In addition, as shown in FIG. 1, the waveguide plate portions 22 form a first antenna opening 51 that radiates the radio waves toward the front direction (+X direction) by a surface orthogonal to tip end portions thereof (end portions on the front side) (a surface parallel to the YZ plane). Further, the waveguide plate portions 22 form the second antenna openings 52 that radiate the radio waves toward both sides (+Y direction and −Y direction) by surfaces orthogonal to both side end portions thereof (surfaces parallel to the XZ plane). In the present embodiment, the waveguide plate portion 22 corresponds to an antenna opening portion.

The shape of the waveguide plate portion 22 can be designed arbitrarily according to desired antenna characteristics. In the present embodiment, as shown in FIG. 2, the waveguide plate portion 22 includes a first waveguide plate region 22a protruding in the X axis direction from the base portion 21 by a first width (e.g., 2 mm) and a second waveguide plate region 22b protruding in the X axis direction from the first waveguide plate region 22a by a second width (e.g., 3 mm) larger than the first width.

In the present embodiment, the first antenna opening 51 and the second antenna openings 52 are covered by the third region R3 of the dielectric block 10. The front surface 10F of the dielectric block 10 opposes the first antenna opening 51 and functions as an antenna opening that radiates radio waves toward the front direction. In addition, the both side surfaces 10S of the dielectric block oppose the second antenna openings 52 and function as antenna openings that radiate radio waves toward the front direction. By providing the third region R3, it is possible to improve the directivity and gain of the antenna element 100 radiated from the antenna openings 51 and 52.

It is noted that a plurality of through-holes may be formed in the third region R3 in accordance with the desired antenna characteristics, or corner portions between the front surface 10F and the both side surfaces 10S may be tapered or curved. Alternatively, the third region R3 may be omitted.

### Rear Post Wall

The rear post wall 30 includes a plurality of conductive columnar bodies P1 (conductive columnar bodies) penetrating the dielectric block 10. The conductive columnar bodies P1 are each a circular cylinder body formed of metal, and connect the base portions 21 of the first and second conductor layers 20A and 20B that oppose each other in the thickness direction (Z axis direction) with the dielectric block 10 interposed therebetween. Each of the conductive columnar bodies P1 may be a cylindrical body formed of metal having the inside filled with an insulator or the like.

The conductive columnar bodies P1 are arrayed along the Y axis direction which is the width direction of the waveguide plate portion 22. Accordingly, the rear post wall 30 that blocks the propagation of radio waves from the second region R2 toward the rear surface 10B side of the dielectric block 10 is formed. In order to block the propagation of radio waves by the rear post wall 30, the conductive columnar bodies P1 are arrayed with a gap D1 of a predetermined size or less as shown in FIG. 5. The gap D1 is favorably ¼ (0.25 λ (0.66 mm) ) or less of a wavelength λ of electromagnetic waves that propagate through the dielectric block 10.

### Power Feeding Portion

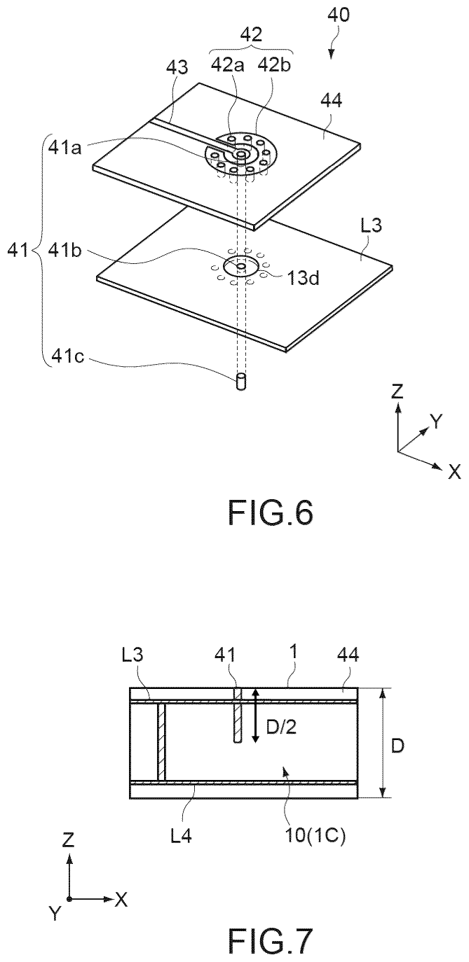

Next, the power feeding portion 40 will be described. FIG. 6 is a partial exploded perspective view showing a configuration example of the power feeding portion 40, and FIG. 7 is a cross-sectional side view of a main portion of the power feeding portion 40.

The power feeding portion 40 is constituted of a microstrip line that is connected to the second region R2 of the dielectric block 10. The power feeding portion 40 functions as a conversion portion that causes a millimeter wave signal introduced from a signal processing circuit (not shown) via a signal line 43 to propagate inside the dielectric block 10.

The power feeding portion 40 includes a power feeding probe 41 (power feeding terminal) that supplies a millimeter wave signal to the second region R2 of the dielectric block 10 and a shield portion 42 formed around the power feeding probe 41.

The power feeding probe 41 is a conductor that extends from the first waveguide plate region 22a to the second region R2 of the dielectric block 10 in the Z axis direction from the first conductor layer 20A toward the second conductor layer 20B, and includes a base end portion 41a, an intermediate portion 41b, and a tip end portion 41c.

The base end portion 41a of the power feeding probe 41 is a through-hole that penetrates an insulating layer 44 corresponding to the dielectric layer 1A (FIG. 4) in the dielectric multilayer substrate 1. The base end portion 41a is connected to the signal processing circuit (not shown) via the signal line 43 on the insulating layer 44. The base end portion 41a and the signal line 43 are formed by a part of the wiring layer L1 constituting the first conductor layer 20A, and are electrically insulated from the base portion 21 and the waveguide plate portion 22.

It is noted that the signal line 43 forms a microstrip line that opposes the wiring layer L2 with the dielectric layer 1A interposed therebetween. The wiring layer L2 is connected to a ground potential. A line width of the signal line 43 is set arbitrarily according to a frequency of the millimeter wave signals to be introduced into the power feeding probe 41 and the dielectric constant of the dielectric layers. For example, when the frequency of the millimeter wave signals is 60 GHz and the dielectric constant of the dielectric layers is 3.6, the line width of the signal line 43 is, for example, about 0.11 mm. By forming the signal line 43 on the uppermost wiring layer of the multilayer wiring substrate 1, the signal line 43 with such a minute line width can be formed stably.

The intermediate portion 41b of the power feeding probe 41 is formed by a part of the wiring layer L3 constituting the first conductor layer 20A. The intermediate portion 41b is provided in a partial insulating layer 13d formed by filling an insulating material into an opening that has been locally provided at a predetermined position of the wiring layer L3, and is thus electrically insulated from the base portion 21 and the waveguide plate portion 22. The intermediate portion 41b is connected to the base end portion 41a.

The tip end portion 41c of the power feeding probe 41 is provided inside the second region R2 of the dielectric block 10. The power feeding probe 41 is formed to have a length smaller than the thickness of the dielectric block 10. In the present embodiment, when the thickness of the dielectric multilayer substrate 1 is represented by D as shown in FIG. 7, the length of the power feeding probe 41 is set to 0.5D (0.8 mm).

Meanwhile, as shown in FIG. 6, the shield portion 42 includes a plurality of columnar portions 42a arranged around the power feeding probe 41 and an arc-shaped support layer 42b that commonly supports each of the columnar portions 42a. The support layer 42b is formed by a part of the conductor layer (wiring layer L1) formed on the front surface of the insulating layer 44, and is electrically insulated from the power feeding probe 41 and the signal line 43. Each of the columnar portions 42a is a through-hole that is electrically connected to the support layer 42b, penetrates the insulating layer 44, and is electrically connected to the wiring layer L3 (the wiring layer L3 around the partial insulating layer 13d).

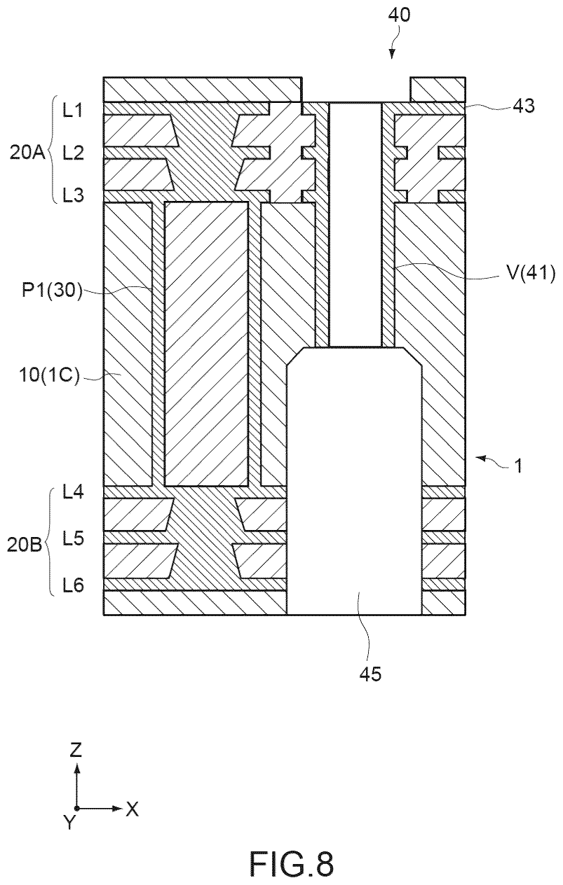

FIG. 8 is a partial cross-sectional side view showing another configuration example of the power feeding portion 40. The antenna element 100 according to the present embodiment adopts the configuration example shown in the figure as the power feeding portion 40.

The power feeding probe 41 shown in FIG. 8 is formed by a through-hole (IVH) V as an interlayer connection portion that extends from the first conductor layer 20A into the dielectric block 10. The length of the power feeding probe 41 in the Z axis direction is set to be half the total thickness of the dielectric multilayer substrate 1 as described above.

Further, as shown in FIGS. 1 and 8, the power feeding portion 40 includes a hole portion 45 having a depth that reaches the power feeding probe 41. The length of the power feeding probe 41 can be adjusted by the depth of the hole portion 45. In this case, after the through-hole V for forming the power feeding probe 41 is formed with a length that penetrates the dielectric block 10, for example, a drilling process is performed on the second conductor layer 20B from the back surface side of the dielectric multilayer substrate 1. In this case, by setting the depth of the hole portion 45 to be half the thickness of the dielectric multilayer substrate 1, the power feeding probe 41 having a desired length can be formed with ease. The inside of the hole portion 45 may be hollow or may be filled with an insulator or the like, and can be designed arbitrarily according to desired antenna characteristics.

### Antenna Characteristics

In the antenna element 100 according to the present embodiment configured as described above, the millimeter wave signal supplied to the second region R2 of the dielectric block 10 via the power feeding portion 40 propagates toward the first antenna opening surface 51 and the second antenna opening surface 52 while being repeatedly reflected between the waveguide plate portions 22. The width and length of the waveguide plate portions 22 are not particularly limited and can be set arbitrarily according to desired band characteristics.

According to the antenna element 100 according to the present embodiment, since the first and second antenna openings 51 and 52 for transmitting radio waves from the front surface 10F and both side surfaces 10S of the dielectric block 10 are formed, the antenna element can be made thinner than a conventional phased patch antenna and the like. For example, when the antenna element 100 is used for an in-vehicle use, the antenna element 100 can be mounted in a small space at a front portion of a vehicle.

Furthermore, according to the present embodiment, since the waveguide region of radio waves that is sandwiched between the pair of waveguide plate portions 22 does not have a post wall waveguide structure and is opened in the front and left-right directions, radio waves can be radiated at a wide viewing angle from the first and second antenna openings 51 and 52. This makes it possible to detect objects at a wide viewing angle.

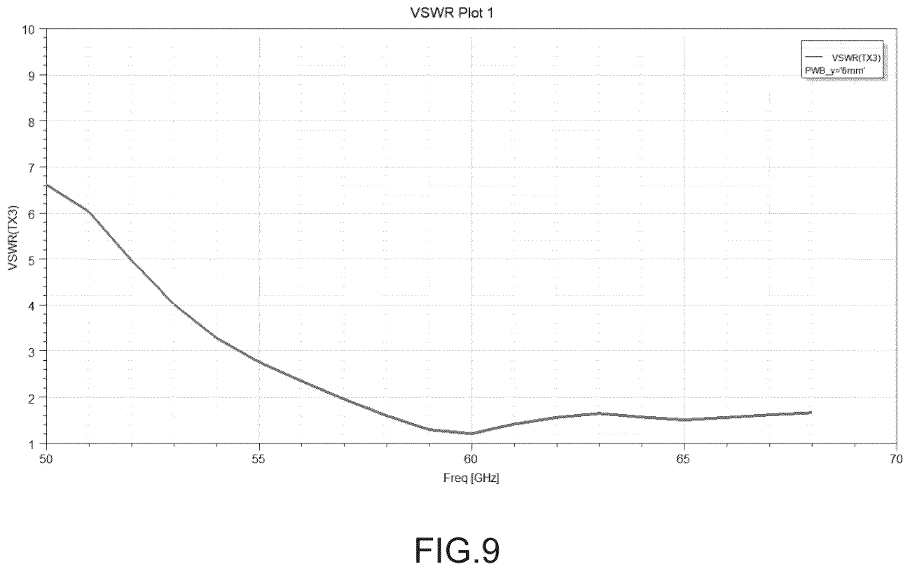

FIG. 9 is a simulation result showing an example of a voltage standing wave ratio (VSWR: Voltage Standing Wave Ratio) of the antenna element 100. As shown in the figure, according to the antenna element 100 of the present embodiment, favorable VSWR characteristics or matching characteristics are obtained in a frequency band used (60 GHz to 64 GHz).

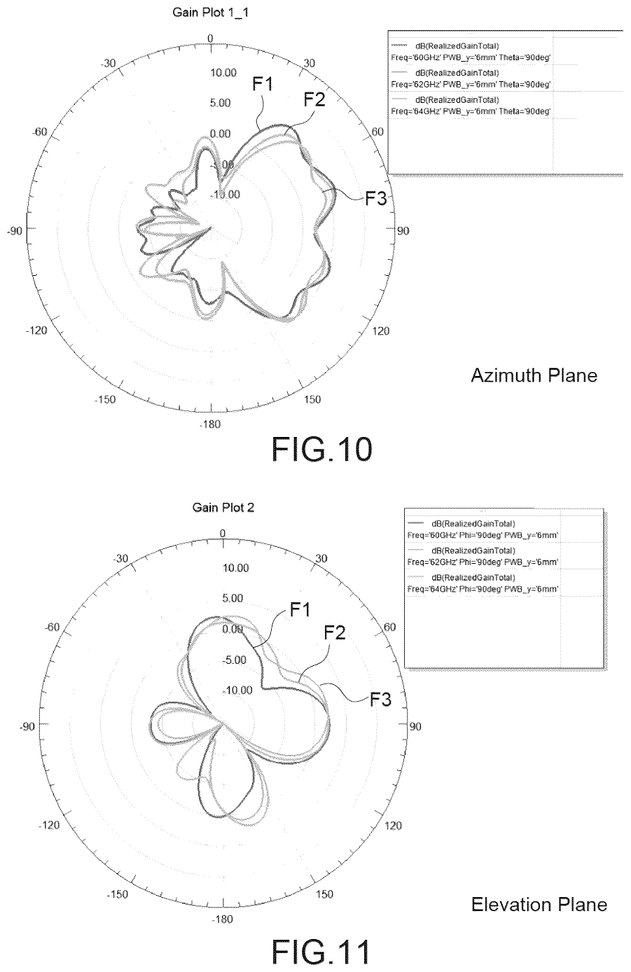

FIG. 10 is a simulation result showing radiation characteristics of the antenna element 100 in an azimuth plane (XY plane), and FIG. 11 is a simulation result showing the radiation characteristics of the antenna element 100 in an elevation plane (XZ plane). In each figure, a 90° direction corresponds to the front direction (+X direction). Further, each figure shows the radiation characteristics of radio waves of different frequencies, with F1 being 60 GHz, F2 being 62 GHz, and F3 being 64 GHz.

According to the present embodiment, as shown in FIG. 10, the directivity of radio waves can be widened across a wide viewing angle range of ±60° (30° to 150°) while centering on the front direction. In addition, since the post wall waveguide structure as in the conventional art is not used, a change in impedance with respect to the frequency is small, thus being able to contribute to a wider bandwidth. Furthermore, as shown in FIG. 11, widening of the directivity in the elevation plane direction can be suppressed by the pair of waveguide plate portions 22.

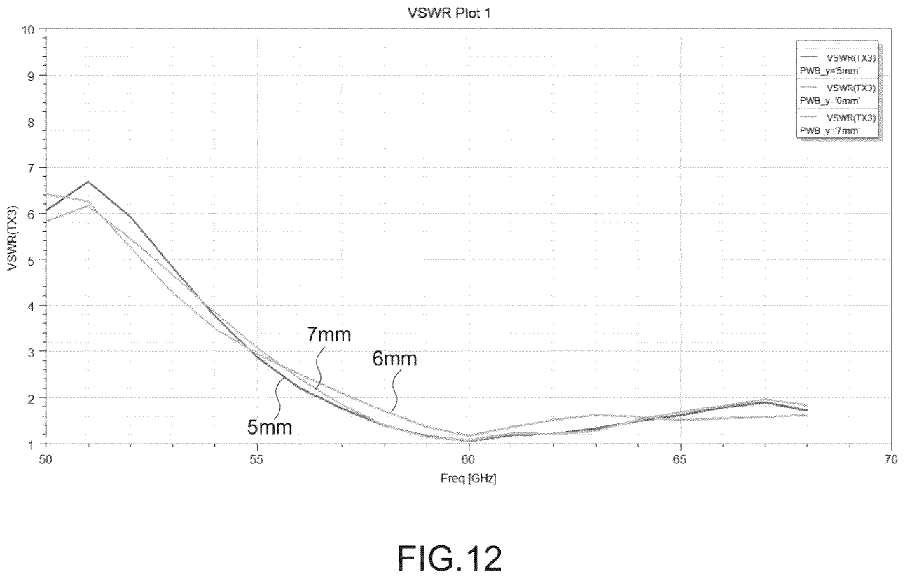

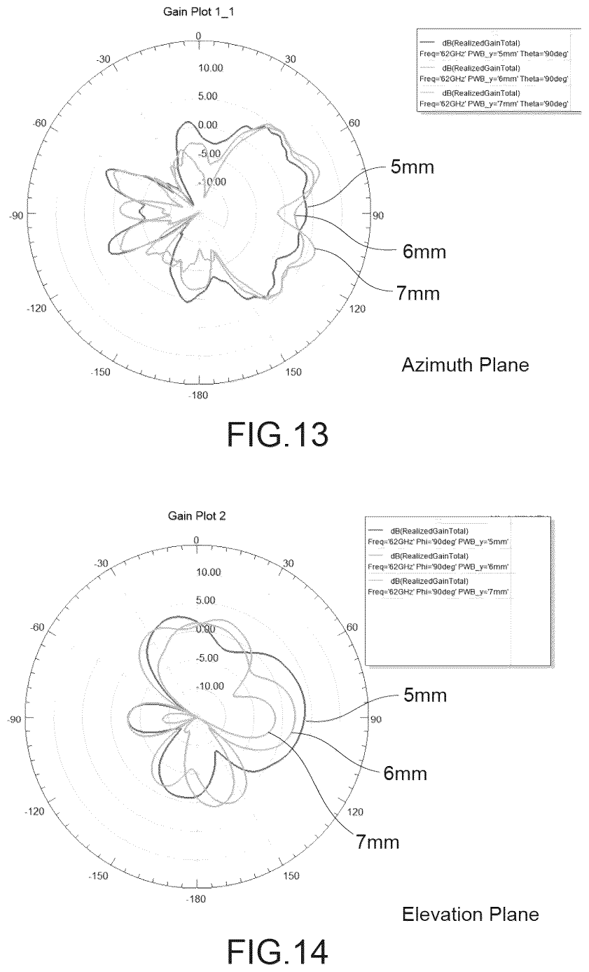

The radiation characteristics of the antenna element 100 can also be adjusted by a length Lx (see FIG. 2) between the power feeding portion 40 and the front surface 10F of the dielectric block 10 along the X axis direction. FIG. 12 is a simulation result comparing the VSWR characteristics of the antenna element 100 when the Lx value is set to 5 mm, 6 mm, and 7 mm. Further, FIG. 13 is a simulation result showing the radiation characteristics of each of the antenna elements 100 in the azimuth plane (XY plane), and FIG. 14 is a simulation result showing the radiation characteristics of each of the antenna elements 100 in the elevation plane (XZ plane). The frequency of radio waves is 62 GHz.

As shown in FIG. 12, favorable VSWR characteristics were obtained even when the length Lx varied from 5 mm to 7 mm. On the other hand, as shown in FIGS. 13 and 14, the larger the length Lx, the more the directivity tends to be narrowed. This is considered to be because the electromagnetic waves are concentrated inside the dielectric block 10, which has a higher dielectric constant (lower impedance) than air.

### Second Embodiment

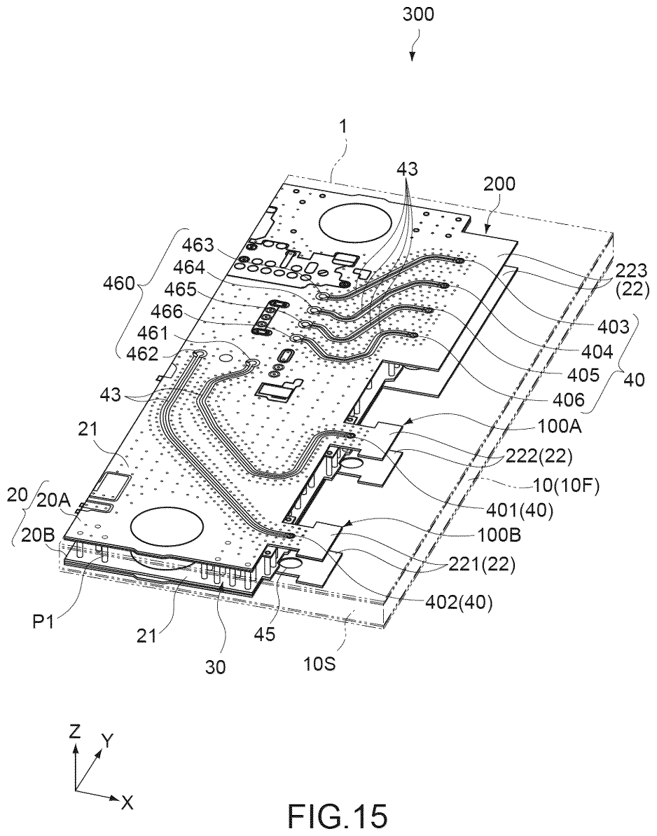

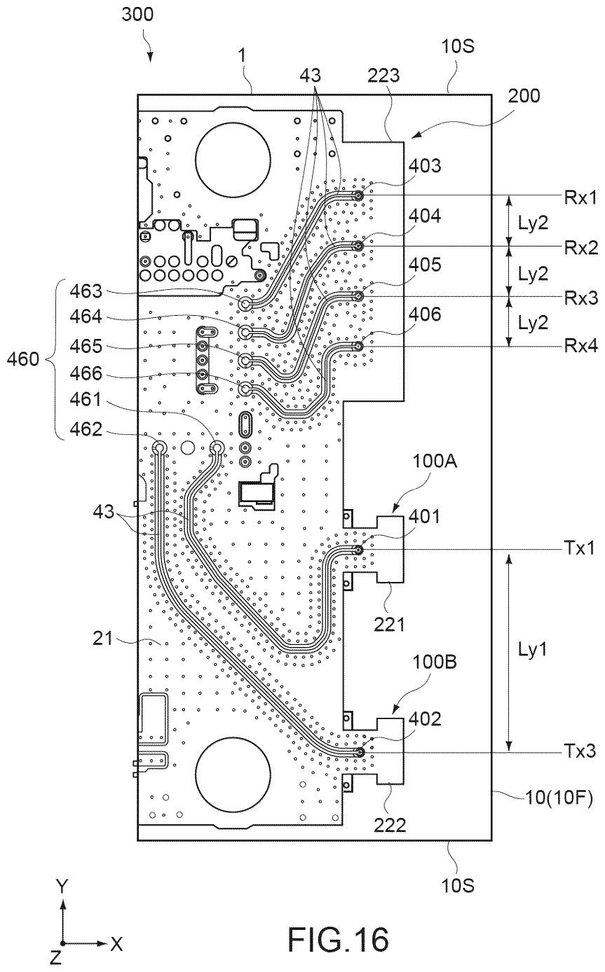

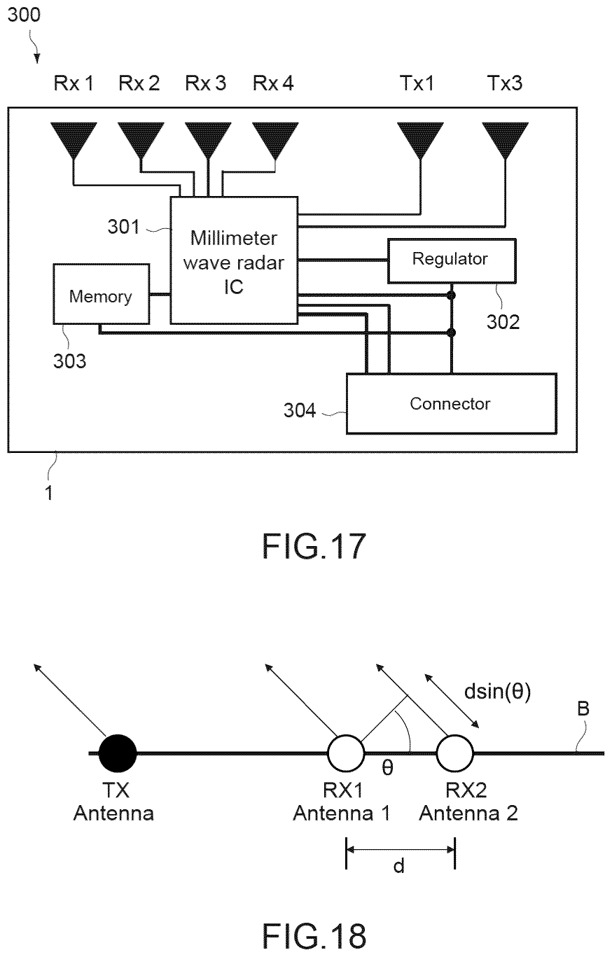

Next, a second embodiment of the present technology will be described. FIG. 15 is a partial transmissive perspective view showing a configuration of an antenna module 300 according to the present embodiment, FIG. 16 is a plan view of the antenna module 300, and FIG. 17 is a block diagram showing a circuit configuration of the antenna module 300. Hereinafter, portions corresponding to those of the first embodiment are denoted by the same symbols, and detailed descriptions thereof will be omitted.

It is noted that in each figure, the X axis (first axis), the Y axis (second axis), and the Z axis (third axis) indicate three axial directions orthogonal to one another, and respectively correspond to the length direction (front-rear direction), the width direction (left-right direction), and the thickness direction (height direction) of the antenna module 300.

### Antenna Module

The antenna module 300 is configured as a transmission/reception antenna including a plurality of (two in the present embodiment) transmission antenna elements 100A and 100B and a reception antenna array 200 including a plurality of (four in the present embodiment) reception antennas.

The antenna module 300 is constituted of the dielectric multilayer substrate 1 having the thickness direction in the Z axis direction. The dielectric multilayer substrate 1 is a rectangular plate material elongated in the Y axis direction, and the transmission antenna elements 100A and 100B and the reception antenna array 200 are arrayed in the Y axis direction with antenna openings facing the front surface 10F side of the dielectric substrate 1 (dielectric block 10).

Basic structures of the transmission antenna elements 100A and 100B and the reception antenna array 200 are similar to that of the antenna element 100 described above in the first embodiment. Of these, the dielectric block 10, the base portions 21 in the pair of conductor layers 20A and 20B, and the rear post wall 30 are common to the transmission antenna elements 100A and 100B and the reception antenna array 200, and the rear post wall 30 is provided at an arbitrary position between the base portions 21. A group of a plurality of input/output terminals 460 (461 to 466) for transmitting and receiving millimeter wave signals are provided in the forming regions of the base portions 21.

Meanwhile, the waveguide plate portions 22 in the pair of conductor layers 20A and 20B are provided with waveguide plate portions 221 and 222 for the transmission antenna elements 100A and 100B, and a common waveguide plate portion 223 is provided for the reception antenna array 200. Similarly for the power feeding portion 40, power feeding portions 401 to 406 are individually provided for the transmission antenna elements 100A and 100B and the four reception antennas constituting the reception antenna array 200.

The transmission antenna element 100A (hereinafter, will also be referred to as transmission antenna Tx1) includes a pair of waveguide plate portions 221 and a power feeding portion 401. The power feeding portion 401 is connected to an output terminal 461 that transmits millimeter wave signals via the signal line 43. The transmission antenna element 100B (hereinafter, will also be referred to as transmission antenna Tx3) includes a pair of waveguide plate portions 222 and a power feeding portion 402. The power feeding portion 402 is connected to an output terminal 462 that transmits millimeter wave signals via the signal line 43.

The waveguide plate portions 221 and 222 in the transmission antennas Tx1 and Tx3 are formed to have the same shape and size, and a distance Ly1 between the power feeding portions 401 and 402 along the Y axis direction is 9.2 mm in the present embodiment.

The reception antenna array 200 includes four reception antennas (first to fourth reception antennas Rx1 to Rx4).

The power feeding portion 403 of the first reception antenna Rx1 is connected to an input terminal 463 that receives millimeter wave signals via the signal line 43. The power feeding portion 404 of the second reception antenna Rx2 is connected to an input terminal 464 that receives millimeter wave signals via the signal line 43. The power feeding portion 405 of the third reception antenna Rx3 is connected to an input terminal 465 that receives millimeter wave signals via the signal line 43. Moreover, the power feeding portion 406 of the fourth reception antenna Rx4 is connected to an input terminal 466 that receives millimeter wave signals via the signal line 43.

Distances Ly2 among the power feeding portions 403 to 406 along the Y axis direction are the same, and are 2.3 mm in the present embodiment. Further, the power feeding portions 401 to 406 for transmission and reception are arranged on the same straight line along the Y axis direction. Distances between the power feeding portions 401 to 406 and tip ends of the waveguide plate portions 22 (221 to 223) along the X axis direction are also the same, and are 2 mm in the present embodiment. A length (width) of the waveguide plate portion 223 along the Y axis direction in this case is, for example, 12 mm.

The input/output terminal group 460 has a multilayer wiring structure formed by using the wiring layers L1 to L3 of the dielectric multilayer substrate 1, for example, and is electrically insulated from the base portion 21 of the conductor layer 20A. The input/output terminal group 460 is connected to each input/output terminal of a millimeter wave radar IC 301 (FIG. 17) mounted on the multilayer wiring substrate 1.

The millimeter wave radar IC 301 is a circuit component that generates millimeter wave signals to be transmitted to the transmission antennas Tx1 and Tx2 and processes millimeter wave signals received by the reception antennas Rx1 to Rx4 to calculate an arrival angle. Further mounted on the dielectric multilayer substrate 1 are, as shown in FIG. 17, a regulator 302 that adjusts a voltage to be supplied to the millimeter wave radar IC, a memory 303 that stores driving parameters of the millimeter wave radar IC and the like, a connector 304 for electrically connecting these millimeter wave radar IC 301, regulator 302, and memory 303 to an external device (not shown), and the like.

The antenna module 300 according to the present embodiment is configured as a MIMO (Multi Input Multi Output) radar antenna. According to the present embodiment, since the respective antennas for transmission and reception are mounted on the same substrate, an antenna device can be made smaller and thinner. Furthermore, since the common waveguide plate portion 223 is used as the waveguide plate portions of the reception antennas Rx1 to Rx4, it is possible to arrange the reception antennas at an interval that is ½ or less of a wavelength of radio wave used, which is required for the MIMO radar.

Herein, the MIMO radar will be briefly described with reference to FIG. 18. FIG. 18 is a conceptual diagram of the MIMO radar. Herein, for simplicity, descriptions will be given while taking a MIMO radar including one transmission antenna TX and two reception antennas RX1 and RX2 as an example.

In the MIMO radar, signals transmitted from the transmission antenna Tx are reflected by an object to be received by both of the reception antennas RX. To reach the second reception antenna RX2 which is farther from the transmission antenna TX, the signal from the object needs to travel an additional distance corresponding to d sin θ (θ represents an incident angle (arrival angle) of radio waves with respect to a baseline B) as compared to the first reception antenna RX1 which is closer to the transmission antenna TX. This corresponds to a phase difference of an angular frequency ω=(2π/λ)d sin θ between the signals received by the two reception antennas RX1 and RX2. Calculating from this phase difference, the arrival angle becomes

$$θ = {sin}^{- 1} ( ωλ / 2 π d ) .$$

Since a value of ω is uniquely determined only within a range of (−π to π), in the case of ω=π, a maximum phase estimation angle (FOV) becomes

$${θ}_{FOV} = \pm {sin}^{- 1} ( λ / 2 d ) .$$

Accordingly, at a time of d=λ/2, the maximum phase estimation angle becomes θ_{FOV}=±90°. In actuality, the wavelength is shortened due to an influence of the dielectric constant of the dielectric multilayer substrate 1 and the like, so the maximum phase estimation angle is achieved by setting the distance between the reception antennas RX to be d=λ/2 or less.

While at least two reception antennas are required to estimate the angle, increasing the number of antennas improves the accuracy of the angle estimation and improves the angle resolution. Regarding the transmission antenna, a distance obtained by multiplying the distance between the reception antennas by the number of reception antennas becomes optimal. Therefore, in the present embodiment, the distance Ly2 among the reception antennas Rx1 to Rx4 is 2.3 mm, and the distance Ly1 between the transmission antennas Tx1 and Tx3 is 9.2 mm.

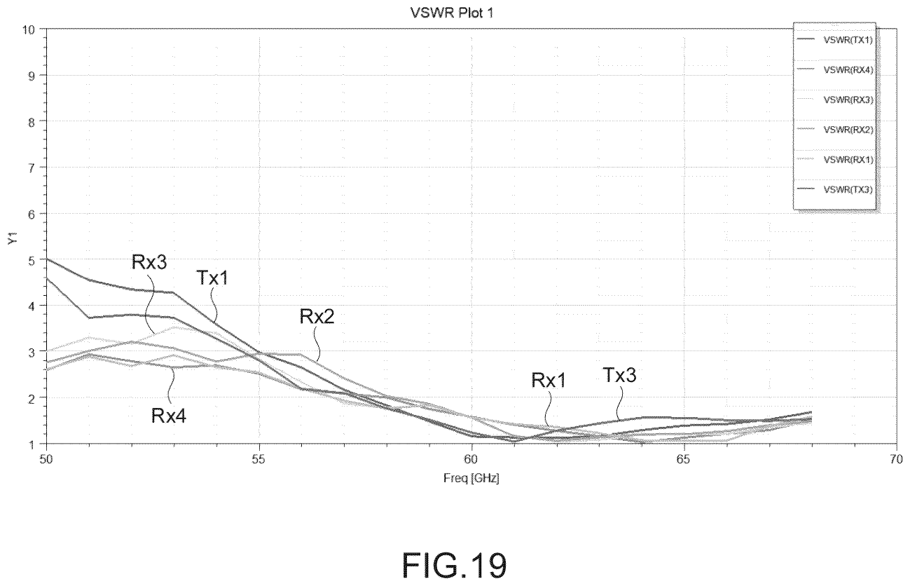

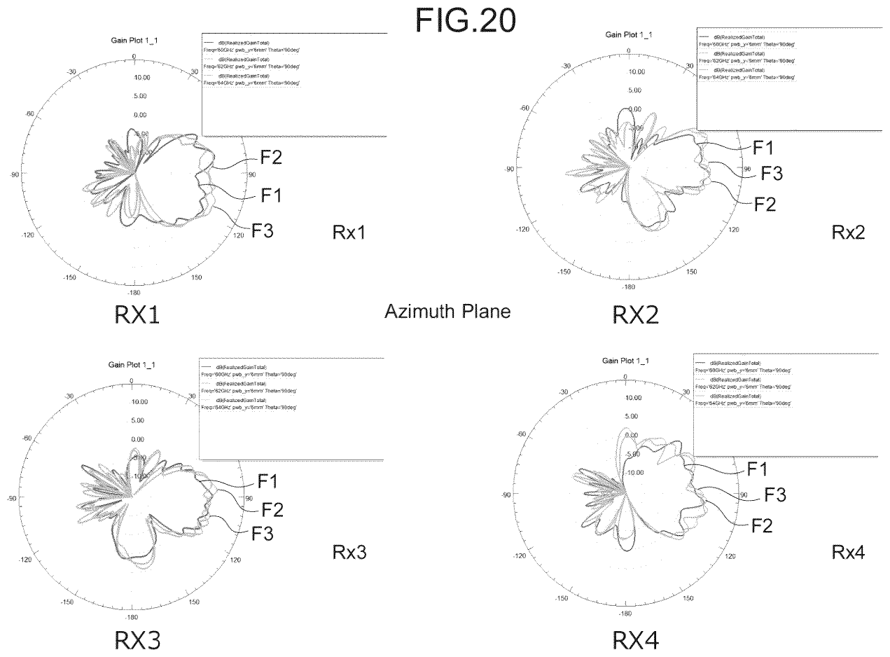

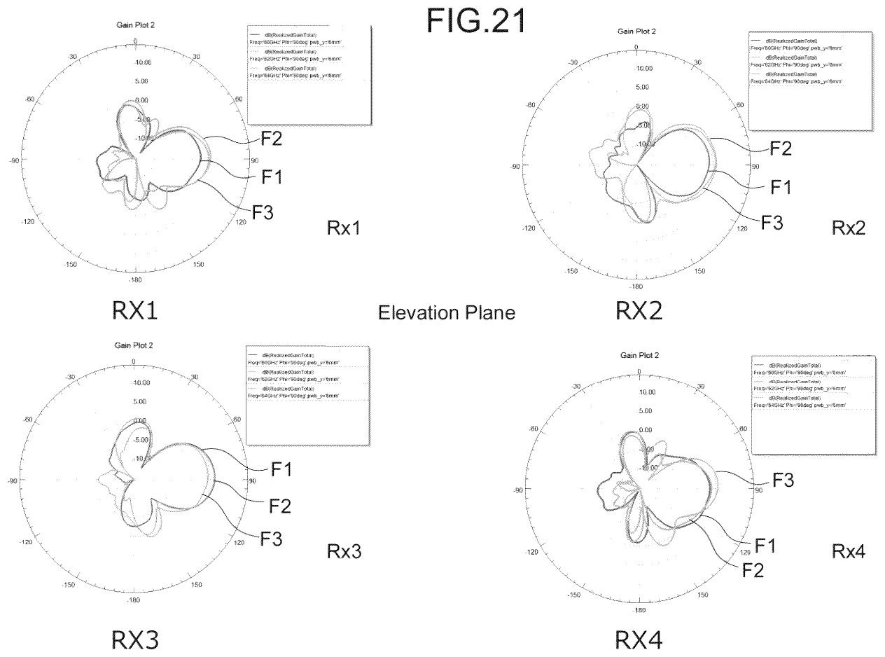

FIG. 19 is a simulation result showing the VSWR characteristics of each antenna of the antenna module 300 according to the present embodiment configured as described above. FIG. 20 shows simulation results showing the radiation characteristics of each of the reception antennas Rx1 to Rx4 of the antenna module 300 in the azimuth plane (XY plane), and FIG. 21 shows simulation results showing the radiation characteristics of each of the reception antennas Rx1 to Rx4 in the elevation plane (XZ plane). In FIGS. 20 and 21, F1 is 60 GHz, F2 is 62 GHz, and F3 is 64 GHz.

According to the present embodiment, since the waveguide plate portion 223 of the reception antenna array 200 is common to the reception antennas Rx1 to Rx4, as shown in FIGS. 19 to 21, the interference among the reception antennas Rx1 to Rx4 can be reduced, and an antenna that has no large null point in directivity can be formed.

### Third Embodiment

### Regarding Influence of Direct Waves and Phase Difference Characteristics Among Reception Antennas

In an antenna module in which a transmission antenna and a plurality of reception antennas are mounted on the same substrate, the following problems may arise regarding the influence of direct waves and the phase difference characteristics among the reception antennas.

A millimeter wave radar estimates the arrival angle θ of millimeter waves that have been transmitted from the transmission antenna and reflected by a detection target, but when the transmission antenna and the reception antenna are provided close to each other, there is an influence of direct waves in which the radio waves transmitted from the transmission antenna are directly input to the reception antenna. In this case, a reception level of the radio waves by the reception antenna becomes higher than the reception level of only the radio waves reflected by the detection target, so the signal level of the reflected waves that are to be detected originally becomes relatively small, and a sufficient S/N ratio cannot be obtained, to thus result in lowering of the detection accuracy.

Further, regarding the phase difference characteristics among the reception antennas, although there is no particular problem if the radio waves reflected by the detection target only travel straight to reach the reception antennas, if the radio waves reflected by a boundary surface are also received due to the influence of the structure, the dielectric constant, and the like of the reception antenna array, fading may occur. This causes an error in phase difference information to thus lower the angle estimation accuracy.

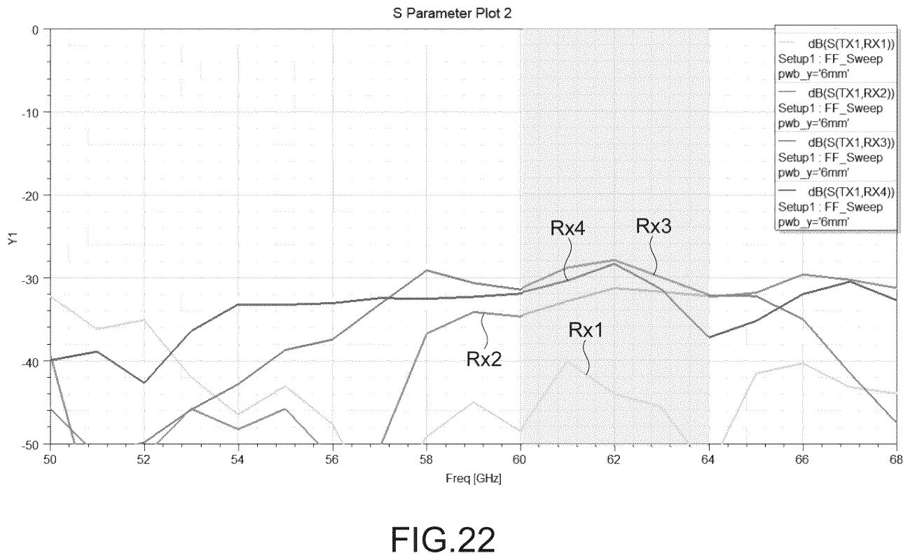

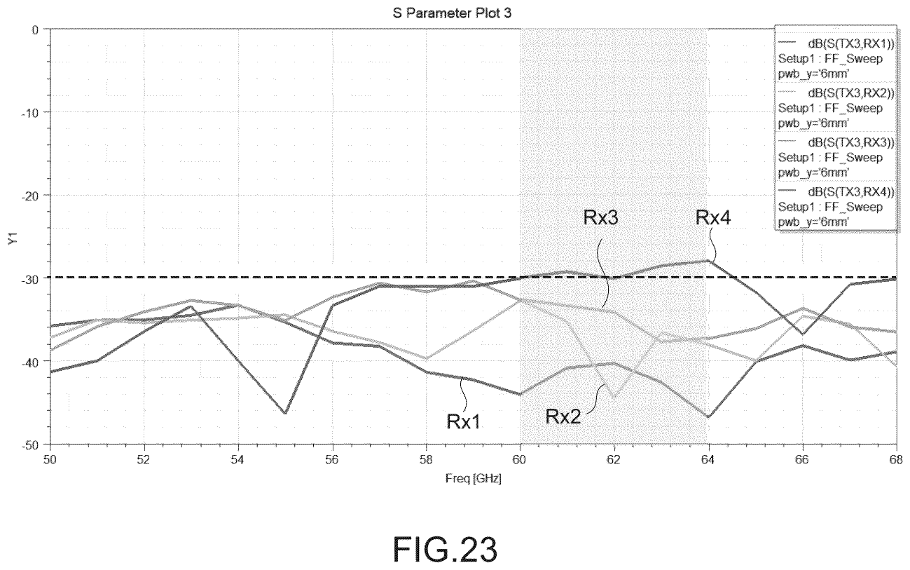

As an index that represents the influence of direct waves, there are isolation characteristics between the transmission antenna and the reception antenna. FIG. 22 is a simulation result showing the isolation characteristics of the reception antennas Rx1 to Rx4 with respect to the first transmission antenna Tx1, and FIG. 23 is a simulation result showing the isolation characteristics of the reception antennas Rx1 to Rx4 with respect to the second transmission antenna Tx3. When the isolation characteristics of −30 dB or less are targeted in the band of 60 GHz to 64 GHz, the values are outside that range in some paths (the reception antennas close to the transmission antenna).

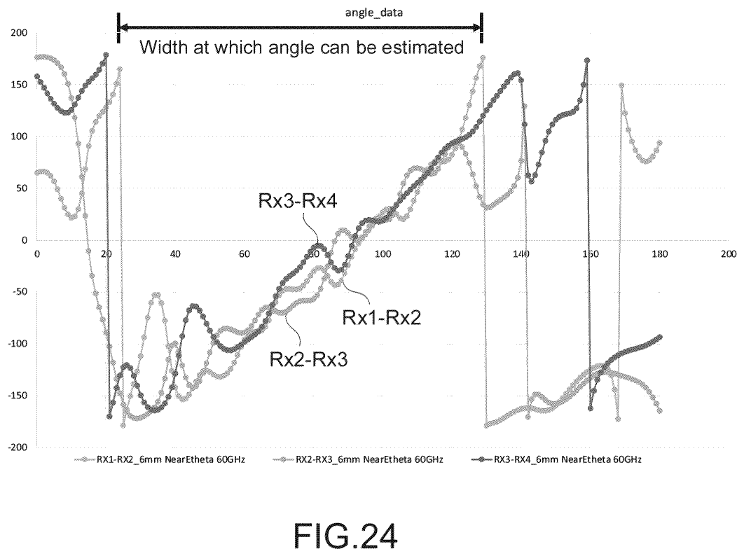

FIG. 24 is a simulation result showing an example of the phase difference characteristics of reception radio waves. The frequency of the radio waves used was set to 60 GHz. In the figure, the horizontal axis represents the actual angle, and the vertical axis represents the angle estimated from the phase difference. It is ideal to obtain a soaring straight line among the reception antennas, but when fading occurs, ripples may appear as shown in the figure. In addition, in the case of detecting a range of ±60 degrees from 30 degrees to 150 degrees at a time 90 degrees is set as a zenith direction, the result in the figure shows that the phase exceeds π and is turned over at around 130 degrees. This narrows the angle that can be estimated, and the detection accuracy is lowered due to the ripples.

### Antenna Module According to Present Embodiment

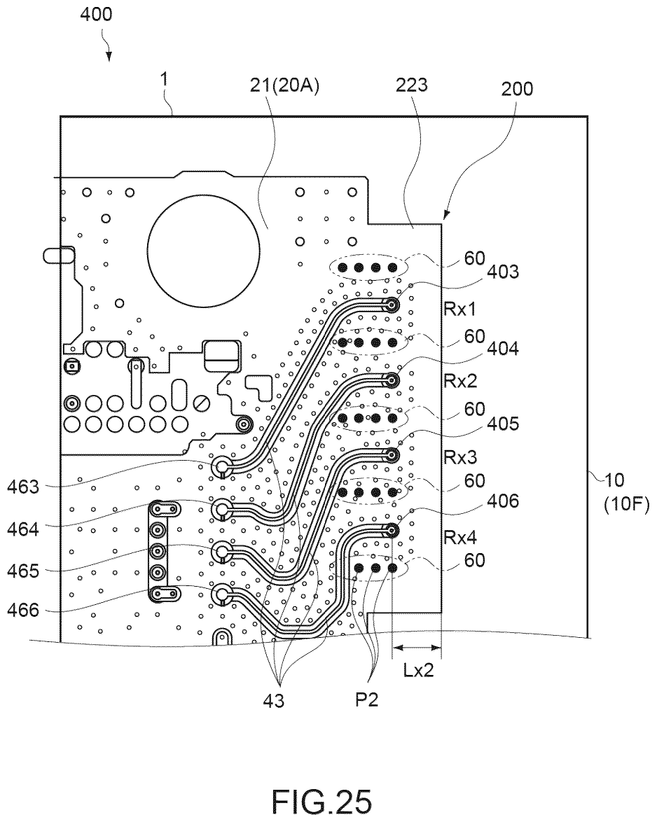

FIG. 25 is a plan view of a main portion of an antenna module 400 according to a third embodiment of the present technology. In the figure, portions corresponding to those of the antenna module 300 in the second embodiment described above are denoted by the same symbols, and detailed descriptions thereof will be omitted.

The antenna module 400 according to the present embodiment differs from the second embodiment in the configuration of the reception antenna array 200. That is, the antenna module 400 according to the present embodiment includes shield portions 60 for suppressing radio wave interference among the adjacent power feeding terminals 403 to 406 in the first to fourth reception antennas Rx1 to Rx4.

The shield portion 60 is constituted of an array of a plurality of columnar bodies P2 arrayed at a predetermined interval in the X axis direction. Each of the columnar bodies P2 penetrates the dielectric block 10 in the thickness direction of the dielectric block 10. The columnar body P2 is typically constituted of a conductive metal post or a through-hole (IVH). The predetermined interval is not particularly limited as long as it is a size with which the shield portions 60 can suppress the entering of radio waves from the Y axis direction, and can be set to be, for example, ¼ or less of the wavelength of radio waves that propagate through the dielectric block 10.

Further, each of the columnar bodies P2 may be constituted of a hollow through-hole. In this case, the impedance characteristics of radio waves that propagate through the dielectric block 10 change in the forming region of the columnar bodies P2, so the interference of radio waves between the adjacent reception antennas can be suppressed. Furthermore, the cross-sectional shape of each of the columnar bodies P2 is not limited to a circular shape shown in the figure, and may be a rectangular shape, an elliptical shape, or the like.

In the present embodiment, the columnar bodies P2 forming the shield portions 60 are arrayed on both sides of the power feeding terminals 403 to 406 of the reception antennas Rx1 to Rx4 (both sides in the width direction (Y axis direction) of the antenna module 400) from positions respectively opposing the power feeding terminals 403 to 406 in the Y axis direction toward the base portion 21 while being parallel to the X axis direction. This makes it possible to suppress the entering of radio waves from a side of the other adjacent power feeding terminal, and thus suppress the interference of reception signals between the adjacent reception antennas. Moreover, since the shield portions 60 are arranged closer to the base portion 21 than the positions where the power feeding terminals 403 to 406 are formed, it becomes possible to receive radio waves that obliquely enter from the first antenna opening 51 (the front surface 10F of the dielectric block 10) side from each of the power feeding terminals 403 to 406, and thus a wide viewing angle can be maintained.

As described above, according to the present embodiment, since the shield portions 60 that shield the reception antennas Rx1 to Rx4 in the width direction are provided, the isolation between the transmission antennas Tx1 and Tx2 and the reception antennas Rx1 to Rx4 can be increased to reduce the influence of direct waves, and by suppressing the reception of radio waves from directions other than the direction to be detected, it is possible to reduce the influence of fading and suppress ripples.

It is noted that in the present embodiment, the distance from the power feeding portion 40 to the tip end of the waveguide plate portion 22 (221 to 223) along the X axis direction is set to 1.5 mm. This is mainly for impedance matching and a fine adjustment of the directivity.

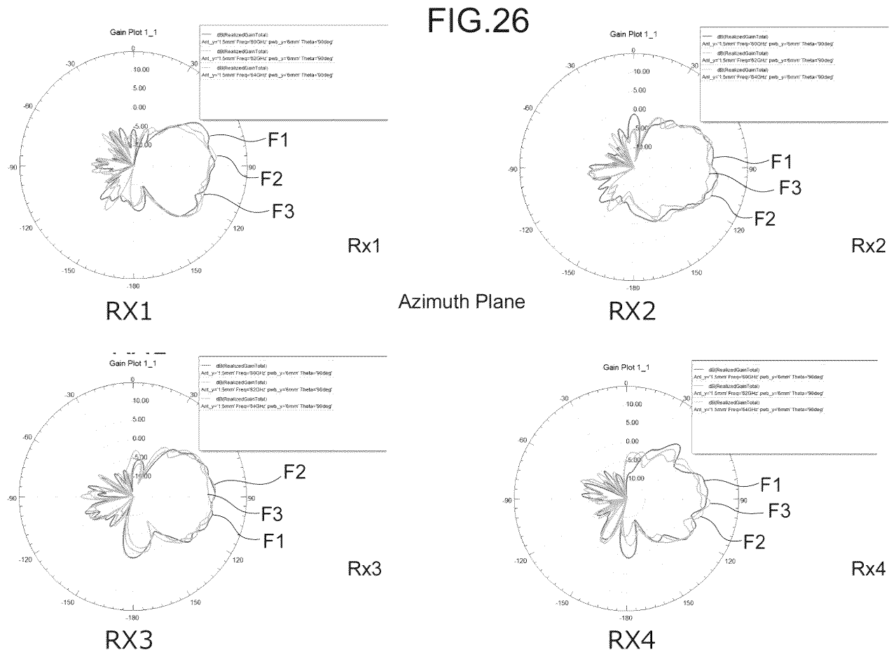

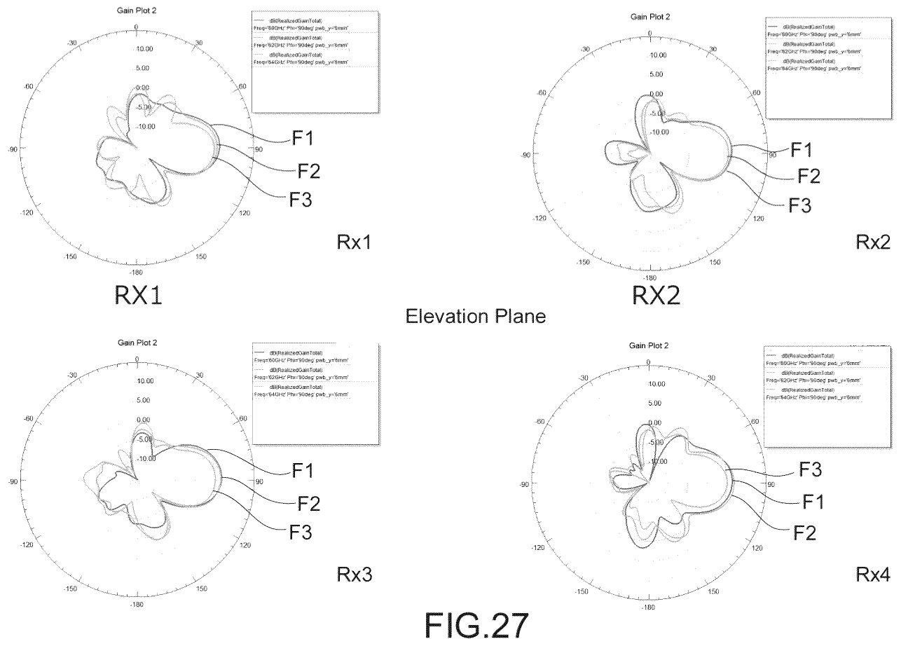

FIG. 26 shows simulation results showing the radiation characteristics of each of the reception antennas Rx1 to Rx4 of the antenna module 400 in the azimuth plane (XY plane), and FIG. 27 shows the simulation results showing the radiation characteristics of each of the reception antennas Rx1 to Rx4 in the elevation plane (XZ plane). In FIGS. 26 and 27, F1 is 60 GHz, F2 is 62 GHz, and F3 is 64 GHz. As shown in FIG. 26, it can be seen that the radiation characteristics in the azimuth direction have less directivity ripples than in the case where there is no shield portion 60 (FIG. 20). This means that the influence of fading is reduced.

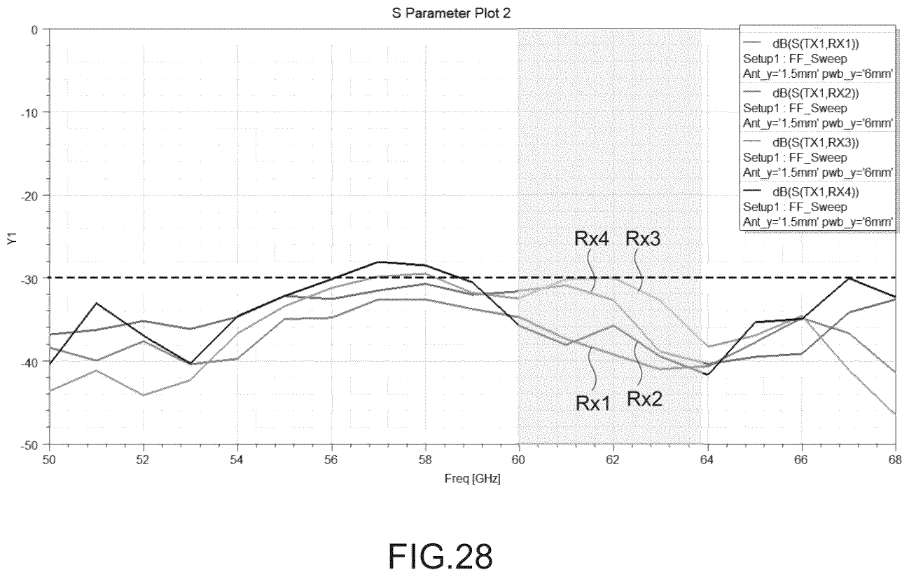

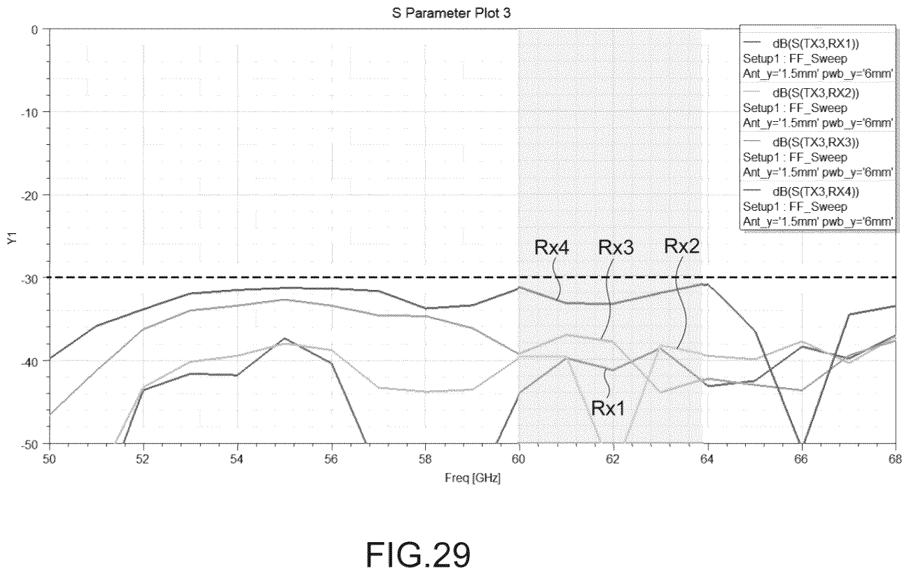

FIG. 28 is a simulation result showing the isolation characteristics of the reception antennas Rx1 to Rx4 with respect to the first transmission antenna Tx1 of the antenna module 400, and FIG. 29 is a simulation result showing the isolation characteristics of the reception antennas Rx1 to Rx4 with respect to the second transmission antenna Tx3. According to the present embodiment, it can be seen that the isolation characteristics are significantly improved compared to the case where there is no shield portion 60 (FIGS. 22 and 23), and all of the reception antennas Rx1 to Rx4 are suppressed to −30 dB or less.

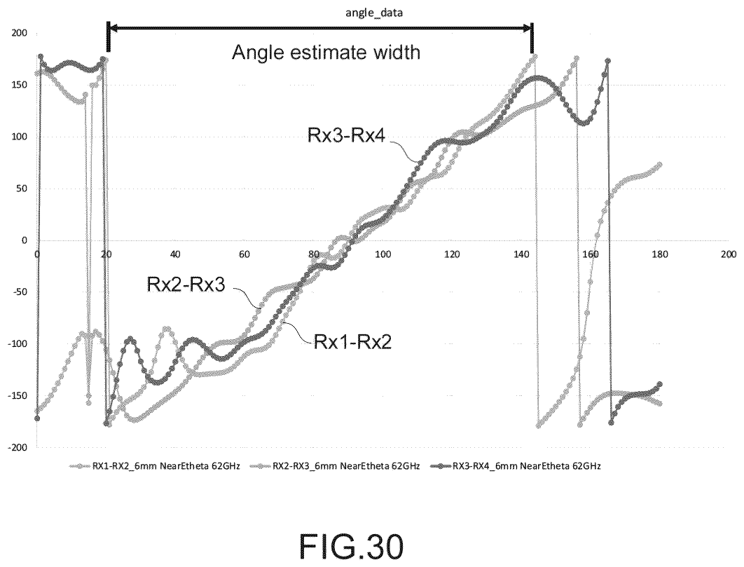

FIG. 30 is a simulation result showing an example of the phase difference characteristics of reception radio waves of the antenna module 400. Also regarding the phase difference characteristics, it has been similarly confirmed that the angle estimation width is significantly widened and the ripples are also significantly improved as compared to the case where there is no shield portion 60 (FIG. 24).

### Another Example of Antenna Element

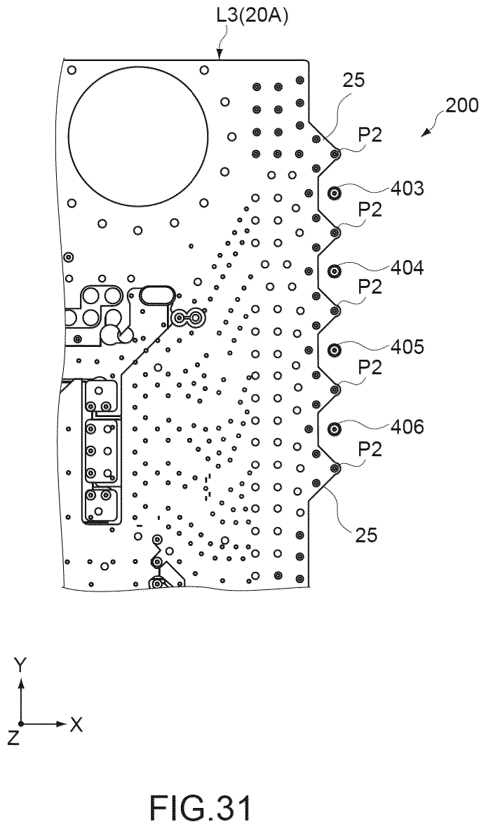

Further, in the third embodiment described above, the shield portion 60 is constituted of the array of the plurality of columnar bodies P2, but the present technology is not limited to this. FIG. 31 is a plan view showing a vicinity of the reception antenna array 200 in the wiring layer L3 forming the first conductor layer 20A. As shown in the figure, protrusion portions 25 that protrude in the X axis direction are formed on both sides of the power supply portions 403 to 406 of the wiring layer L3, and a single or a plurality of columnar bodies P2 is/are provided at or near tip end portions of these protrusion portions 25, to thus obtain an operation and effect similar to those of the shield portions 60 described above.

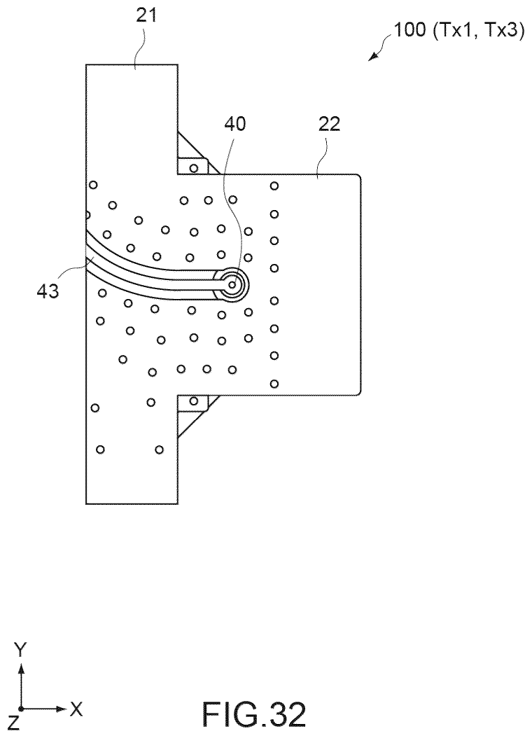

Furthermore, in the first embodiment described above, the shield plate portion 22 of the antenna element 100 has a stepped shape including the first waveguide plate region 22a and the second waveguide plate region 22b, but the present technology not limited to this. For example, as shown in FIG. 32, the entire shield plate portion 22 may be formed to have the same width. This configuration can similarly be applied to the transmission antenna elements Tx1 and Tx3 described in the second and third embodiments.

It is noted that the configuration of the shield portion 60 described above can similarly be applied to not only the reception antenna array 200 but also the transmission antenna elements Tx1 and Tx2. In this case, for example, the wiring layer L3 on the transmission antenna side can also be provided with the protrusion portions 25 and the columnar bodies P2 as shown in FIG. 31.

Furthermore, in order to improve the phase difference characteristics and directivity of the antenna modules 300 and 400, cuts or hollow through-holes may be provided at end portions or corner portions of a region corresponding to the third region R3 of the dielectric block 10. In addition, although the intervals of the reception antennas Rx1 to Rx4 are set to 2.3 mm, these antenna intervals can be arbitrarily adjusted according to a desired viewing angle (FOV) and the like.

### Fourth Embodiment

In the millimeter wave radar system, the phase difference characteristics of reception radio waves (see, for example, FIG. 24 and the like) largely affect performance in the angle estimation and the like. For this reason, it is important to improve linearity of the phase difference characteristics, that is, reduce the ripples that appear in the phase difference characteristics. In the present embodiment, an antenna module configured to improve such points will be described.

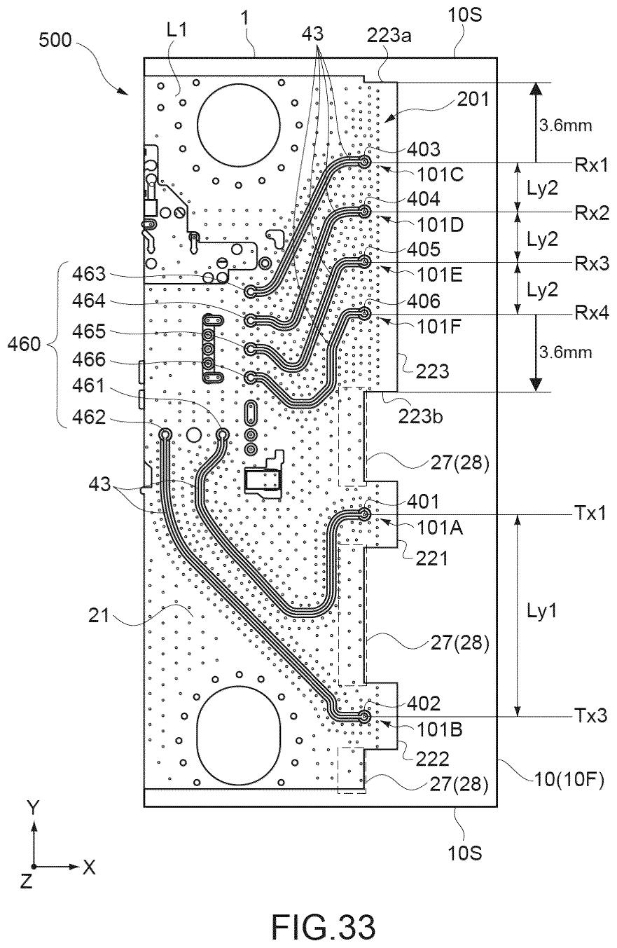

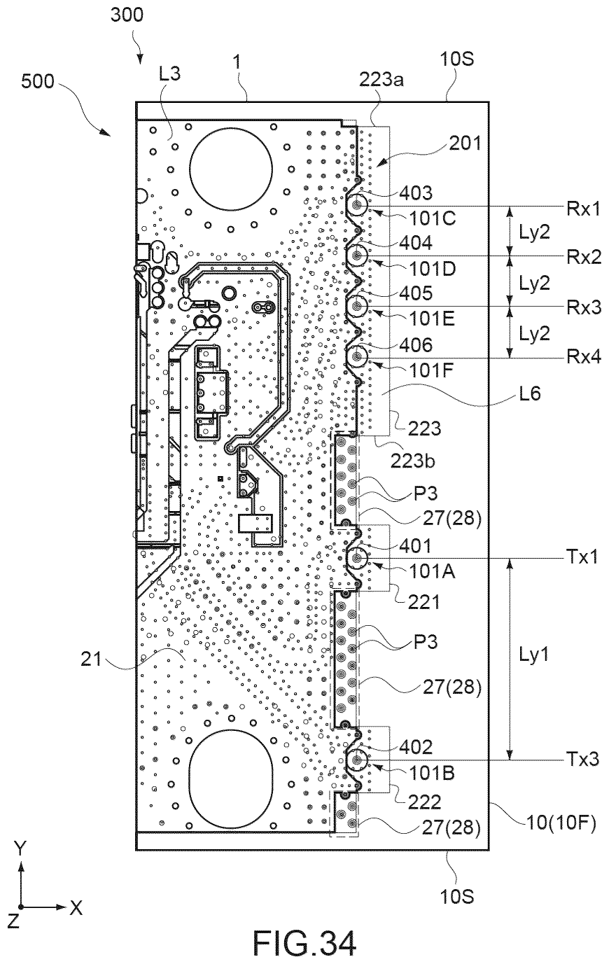

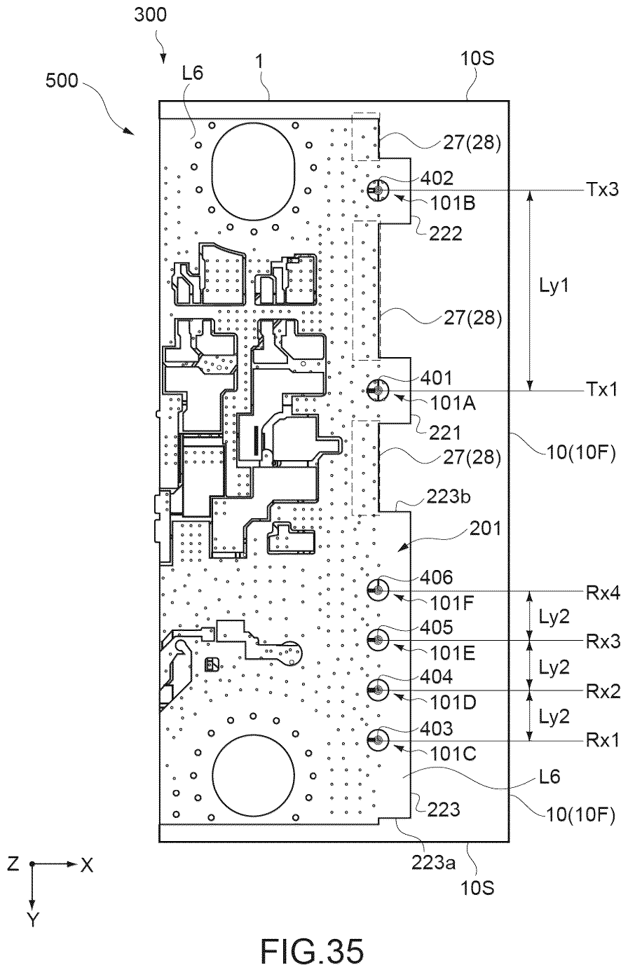

FIG. 33 is a plan view of an antenna module 500 according to a fourth embodiment of the present technology as viewed from above, FIG. 34 is a plan view of an internal structure of the antenna module 500 as viewed from above, and FIG. 35 is a plan view of the antenna module 500 as viewed from below. FIGS. 33 and 35 show the structures of the upper surface (L1) and lower surface (L6) of the antenna module 500, and FIG. 34 shows the structure of L3 which is the wiring layer provided between L1 and L6.

The antenna module 500 is configured as a transmission/reception antenna that includes a plurality of (two in the present embodiment) transmission antenna elements 101A and 101B and a reception antenna array 201 including a plurality of (four in the present embodiment) reception antenna elements 101C to 101F. The basic structure of the transmission antenna elements 101A and 101B is similar to the structure of the antenna element 100 described with reference to FIG. 32, and the basic structure of the reception antenna array 201 (reception antenna elements 101C to 101F) is similar to the structure of the reception antenna array 200 described with reference to FIG. 31. It is noted that the structure of each of the antenna elements 101A to 101F is not limited.

As shown in FIGS. 33 to 35, in the antenna module 500, the width of the waveguide plate portion 223 of the reception antenna array 201 in the Y axis direction is set to be wider than that of the embodiment described above (FIG. 16 and the like). Specifically, an interval between a central axis of the reception antenna element arranged on an outermost side of the reception antenna array 201 that becomes a reception antenna and the second antenna opening 52 is set to be larger than the interval among the power feeding terminals in the reception antenna array 201.

For example, the reception antenna element 101C farthest from the transmission antenna element 101A and the reception antenna element 101F closest to the transmission antenna element 101A are the reception antenna elements arranged on the outermost side of the reception antenna array 201. In this case, the intervals from the central axes of the reception antenna elements 101C and 101F (axes that are parallel to the X axis and respectively pass through the power feeding terminals 403 and 406) to end sides 223a and 223b (second antenna openings 52) on sides of the waveguide plate portion 223 are set to a value (herein, 3.6 mm) larger than that of the interval among the power feeding terminals (herein, 2.3 mm).

In this manner, by increasing the width of the copper foil (the waveguide plate portion 223 of the conductor layer 20) of the reception antenna array 201, it is possible to reduce components that are reflected at the edge of the copper foil and cause a phase difference out of the radio waves received by the reception antenna array 201. Accordingly, the effect of reducing ripples generated in the phase difference characteristics can be expected.

As shown in FIGS. 33 and 35, the antenna module 500 has a configuration in which front end edge portions 27 of the pair of conductor layers 20 (conductor layers 20A and 20B) that are different from the waveguide plate portions (221, 222, 223) are extended further toward the front direction than in the embodiment described above (FIG. 16 and the like). Herein, the end edge portion 27 of the conductor layer 20 is, for example, a strip-like region provided along a front end side of the conductor layer 20 excluding the waveguide plate portion. In the present embodiment, the end edge portions 27 are formed by the outermost wiring layers (L1 and L6).

Specifically, the antenna module 500 has a configuration in which the front end side of the end edge portion 27 is extended to the power feeding terminals 401 to 406. That is, the pair of conductor layers 20 include the end edge portions 27 that extend to the positions of the power feeding terminals 401 to 406 in the X axis direction, between the transmission antenna element 101A and the reception antenna element 101F or between the transmission antenna elements 101A and 101B constituting the transmission antenna. It is noted that herein, the end edge portion 27 on the outer side (the lower side in the figure) of the transmission antenna element 101B is also extended in a similar manner.

In this manner, by extending the end side of the copper foil (end edge portions 27) to positions right beside the power feeding terminals 401 to 406, it becomes possible to reduce the directivity toward the rear side of the antenna and reduce the reflection of components that travel toward the rear side, and the like. Accordingly, the effect of reducing ripples that are generated in the phase difference characteristics can be expected.

It is noted that a portion where the end side is arranged so as to be aligned with the power feeding terminals may be provided only between the transmission antenna element 101A and the reception antenna element 101F. This makes it possible to sufficiently suppress the reflection components that travel to the reception antenna array 201. Alternatively, the end side may be arranged to be aligned with the power feeding terminals only between the transmission antenna elements 101A and 101B.

Further, as shown in FIG. 34, in the antenna module 500, a plurality of conductive columnar bodies P3 (VIA) that connects the wiring layers L1 and L6 is arranged along the Y axis direction with respect to the copper foil (end edge portion 27) extended to the position right beside the power feeding terminals 401 to 406. Accordingly, a post wall 28 provided along the Y axis direction is formed by the end edge portion 27 and the plurality of conductive columnar bodies P3.

It is noted that the conductive columnar bodies P3 constituting the post wall 28 are not covered by the copper foil regarding the wiring layers L2 to L5 on the inner side. For example, as shown in FIG. 34, the wiring layer L3 is configured not to come into contact with the conductive columnar bodies P3. In this manner, the post wall 28 has a structure in which the plurality of conductive columnar bodies P3 that penetrates the dielectric block 10, is connected to the end edge portion 27, and is electrically isolated from other conductor layers is arranged along the Y axis direction.

By providing such a post wall 28, it becomes possible to provide an L component (inductance) and a C component (capacitance) and cause LC resonance in the post wall 28. This makes it possible to absorb the radio waves that travel toward the rear side, for example, and reduce the directivity in unnecessary directions (unnecessary reflection components). In the present embodiment, the post wall 28 corresponds to a post absorption wall.

Hereinafter, the respective characteristics of the antenna module 500 will be described. Herein, the transmission antenna elements 101A and 101B will respectively be referred to as the transmission antennas Tx1 and Tx3. In addition, the reception antenna elements 101C, 101D, 101E, and 101F will respectively be referred to as the reception antennas Rx1, Rx2, Rx3, and Rx4.

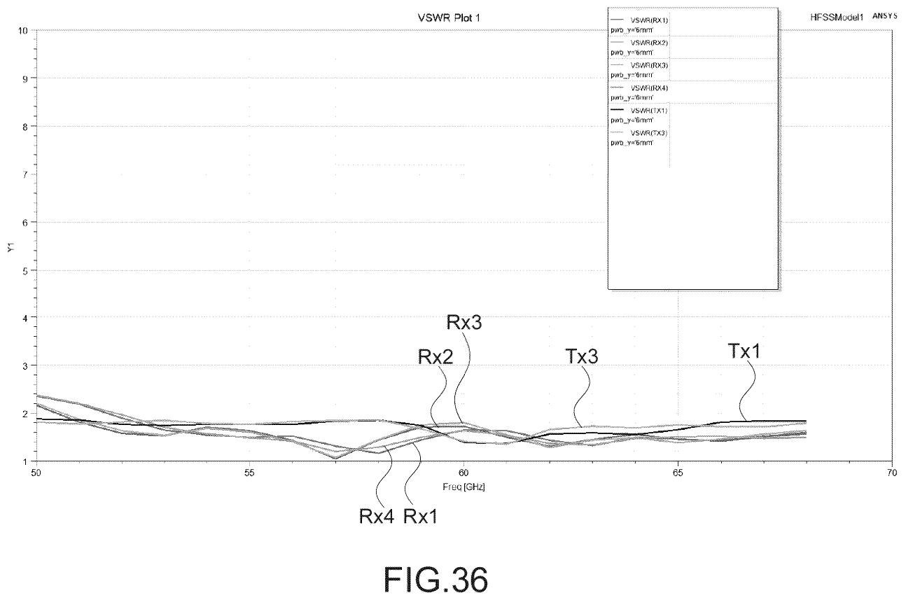

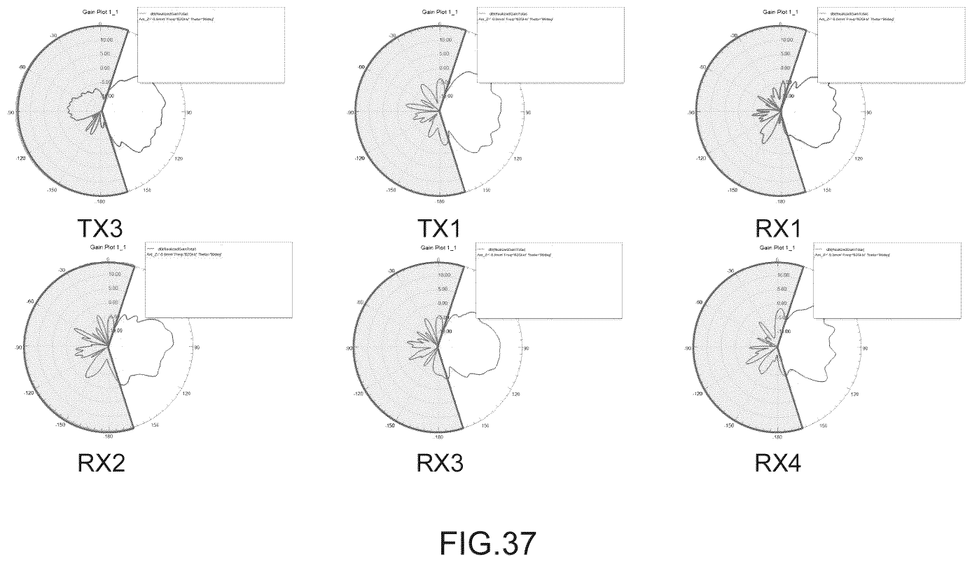

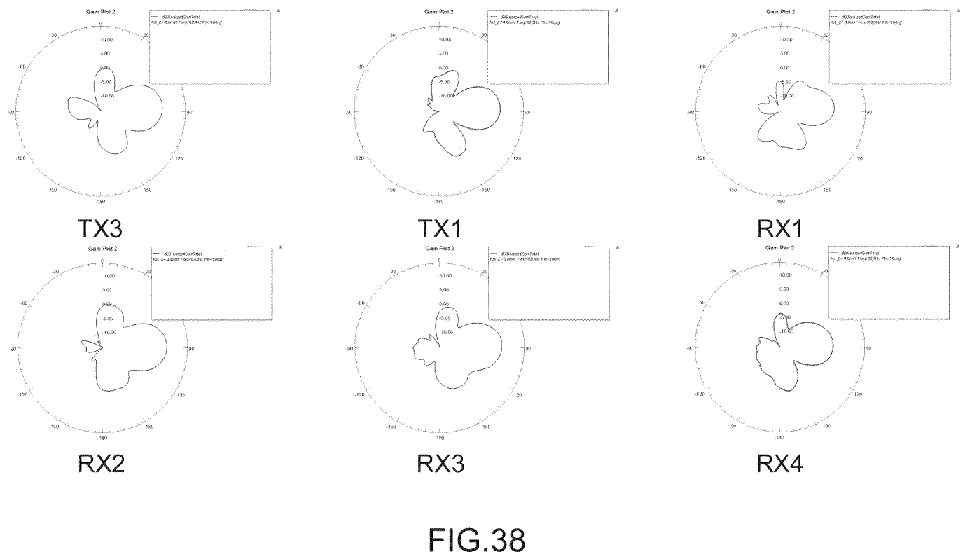

FIG. 36 is a simulation result showing the VSWR characteristics of each antenna of the antenna module 500 according to the present embodiment. FIG. 37 shows simulation results showing the radiation characteristics of each antenna of the antenna module 500 in the azimuth plane (XY plane), and FIG. 38 shows simulation results showing the radiation characteristics of each antenna in the elevation plane (XZ plane). In FIGS. 37 and 38, the frequency of radio waves is 62 GHz.

As shown in FIG. 36, the VSWR in the frequency band used (60 GHz to 64 GHz) is 2 or less, and favorable VSWR characteristics or matching characteristics are obtained. Further, it can be seen from the results shown in FIG. 37 that the directivity toward the rear side of the antenna is reduced as compared to the case where the post wall 28 that absorbs radio waves that travel toward the rear side, or the like is not provided (FIG. 20 and the like), for example. Furthermore, it can be seen that unnecessary ripples with respect to the radiation direction are reduced. Moreover, also from the results shown in FIG. 38, it can be said that the directivity toward the rear side of the antenna is reduced.

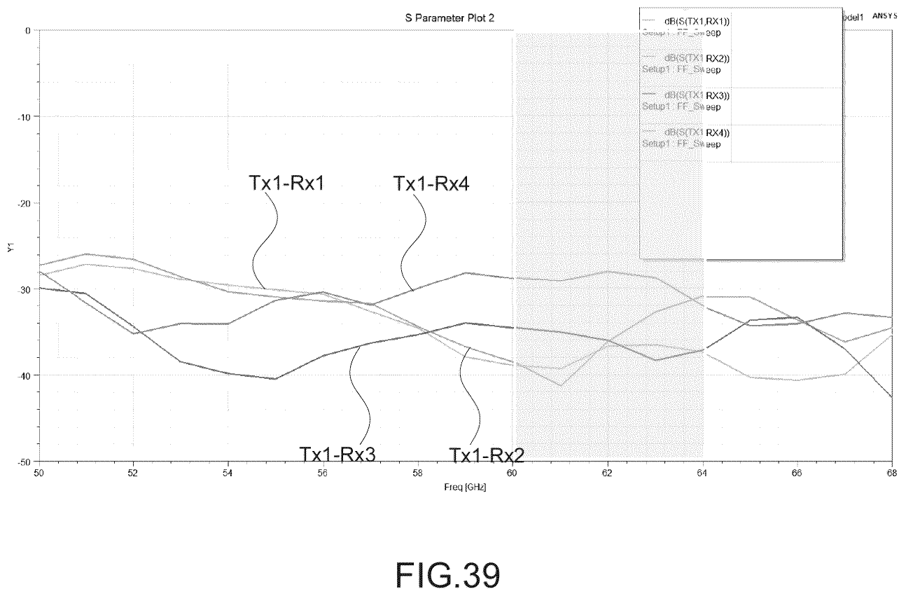

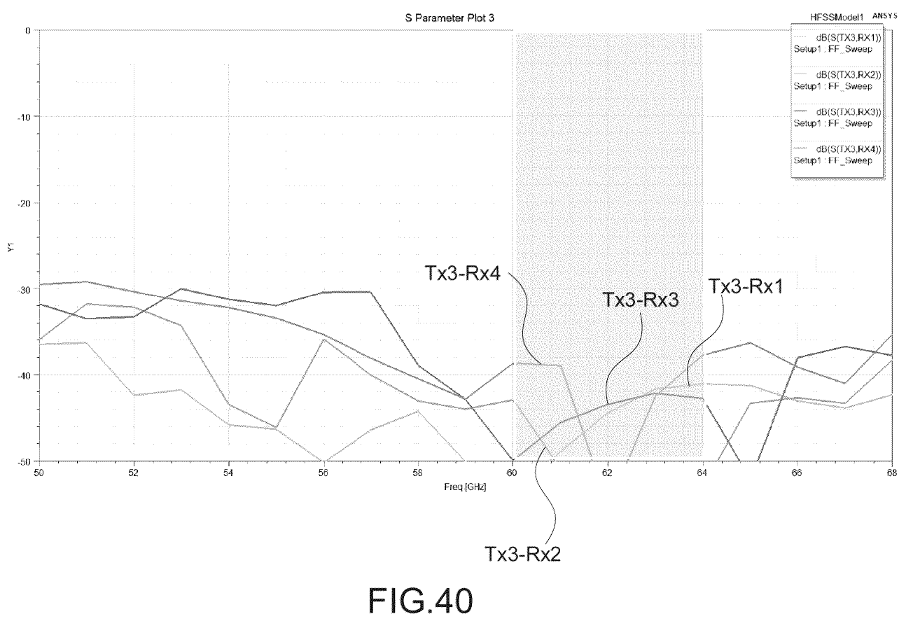

FIG. 39 is a simulation result showing the isolation characteristics of the reception antennas Rx1 to Rx4 with respect to the transmission antenna Tx1, and FIG. 40 is a simulation result showing the isolation characteristics of the reception antennas Rx1 to Rx4 with respect to the transmission antenna Tx3. In the present embodiment, an improvement in the isolation characteristics was observed especially on the Tx3 side.

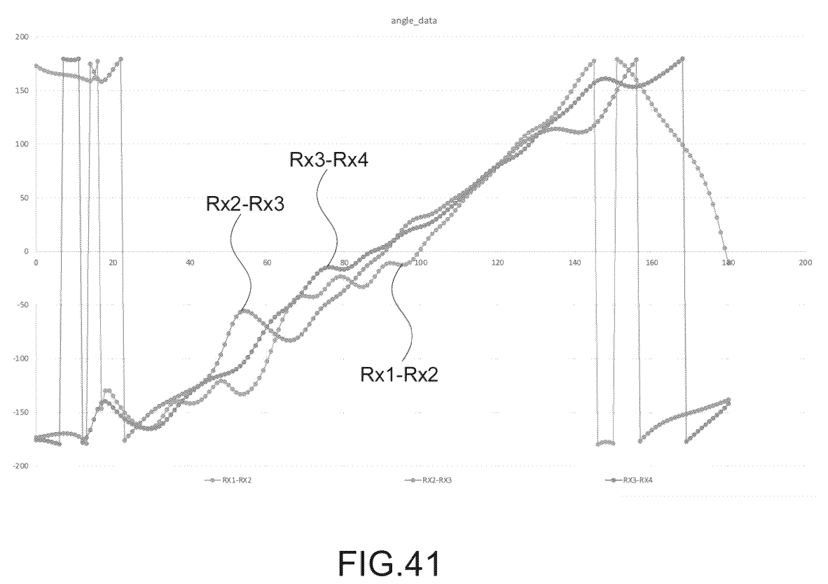

FIG. 41 is a simulation result showing an example of the phase difference characteristics of the reception radio waves of the antenna module 500. Also regarding the phase difference characteristics, it was confirmed that the angle estimation width is widened and the ripple are also significantly improved as compared to FIG. 24, for example. This is considered to be due to the effect of the suppression of reflected waves by the waveguide plate portion 223 and the absorption of direct waves by the post wall 28. Accordingly, it becomes possible to improve the angle estimation performance in the millimeter wave radar system.

### Fifth Embodiment

In the millimeter wave radar system, the angle estimation accuracy is improved by improving the isolation characteristics between the transmission antenna and the reception antenna. In the present embodiment, a configuration for improving the isolation characteristics by reducing direct waves that reach the reception antenna from the transmission antenna will be described.

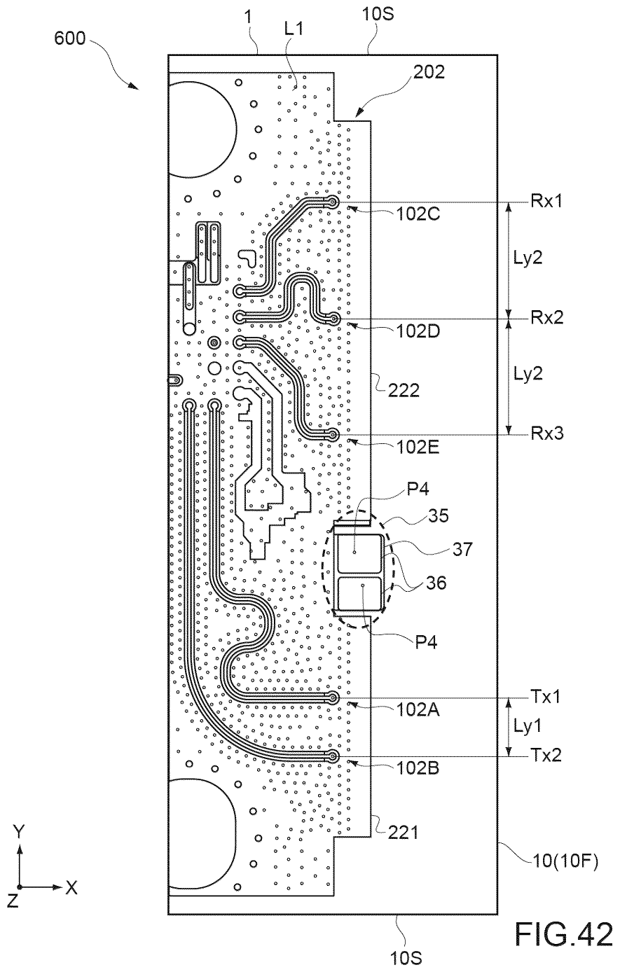

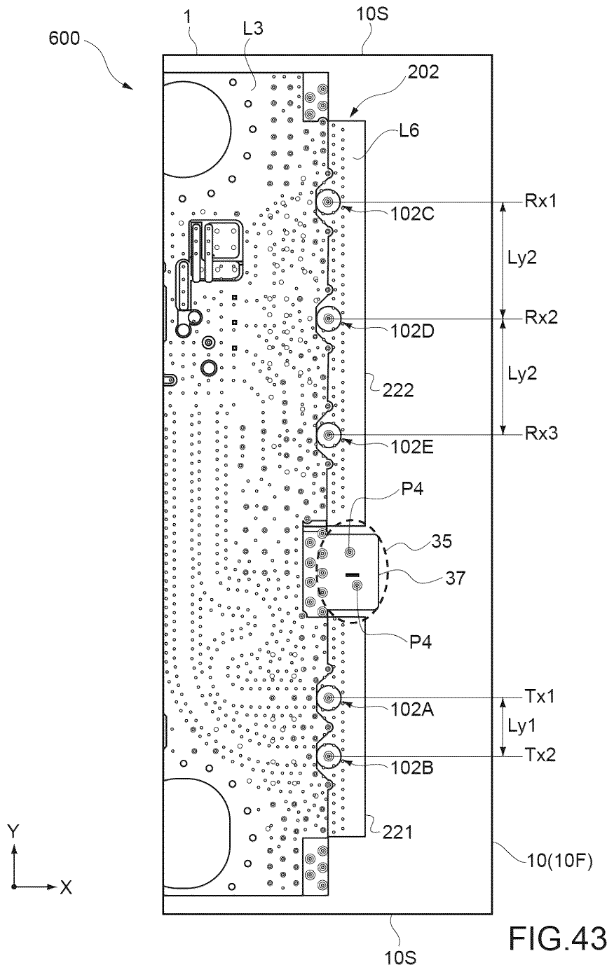

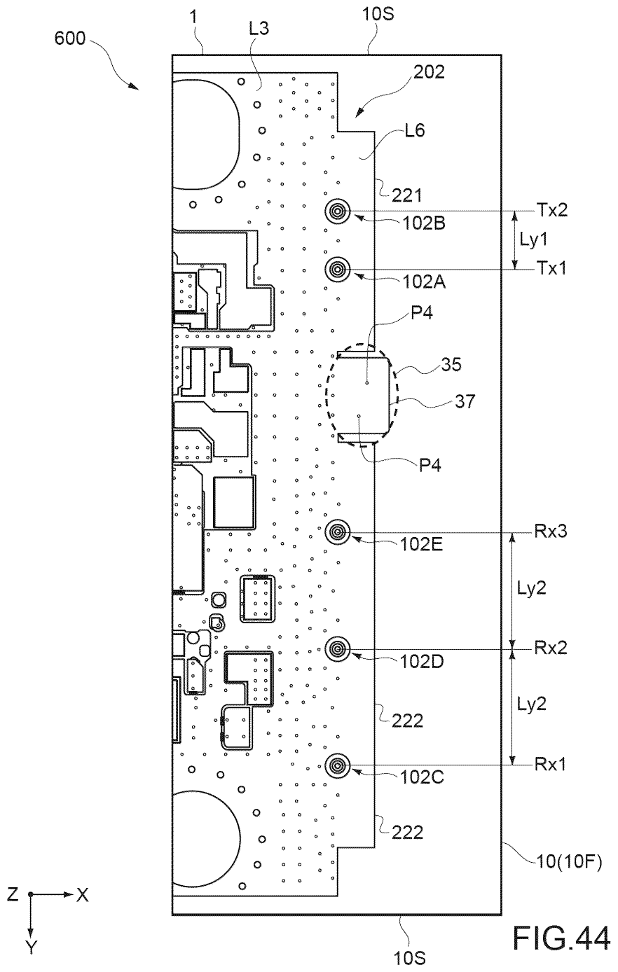

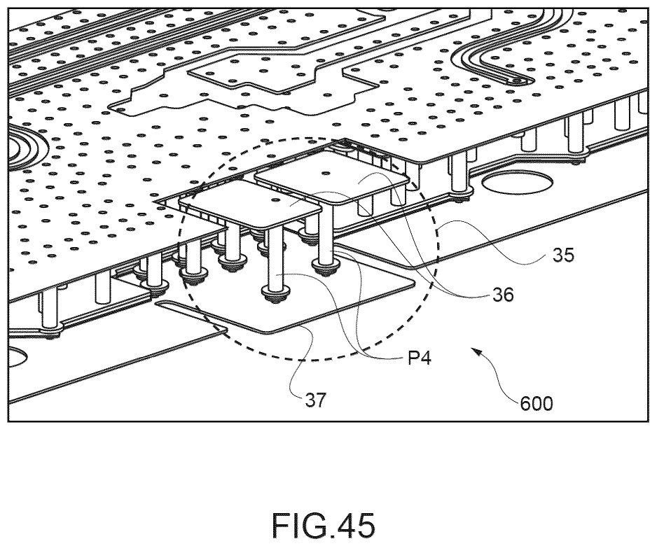

FIG. 42 is a plan view of an antenna module 600 according to the present embodiment as viewed from above, FIG. 43 is a plan view of an internal structure of the antenna module 600 as viewed from above, FIG. 44 is a plan view of the antenna module 600 as viewed from below, and FIG. 45 is a partial transmissive perspective view showing a main portion of the antenna module 600. FIGS. 42 and 44 show the structures of the upper surface (L1) and lower surface (L6) of the antenna module 600, and FIG. 43 shows the structure of L3 which is the wiring layer provided between L1 and L6.

The antenna module 600 is configured as a transmission/reception antenna that includes a plurality of (two in the present embodiment) transmission antenna elements 102A and 102B and a reception antenna array 202 including a plurality of (three in the present embodiment) reception antenna elements 102C to 102E. The basic structure of each of the antenna elements 102A to 102E is similar to the structure of the antenna element 100 described with reference to FIG. 32. It is noted that the structure of each of the antenna elements 102A to 102E is not limited.

In the present embodiment, the distance Ly2 between the reception antenna elements 102C and 102D (or the reception antenna elements 102D and 102E) along the Y axis direction is set to be larger than the distance Ly1 between the transmission antenna elements 102A and 102B along the Y axis direction. Since the antenna module 600 is a MIMO radar, the optimal distance Ly2 between the reception antennas is a distance obtained by multiplying the distance Ly1 between the transmission antennas by the number of transmission antennas (see FIG. 18 and the like). Therefore, for example, Ly1 is set to a length that is ½ the wavelength of the radio waves used (e.g., 2.3 mm), and Ly2 is set to a length of one wavelength of the radio waves used (e.g., 4.6 mm).

In order to improve the isolation described above, the antenna module 600 uses an LC resonator 35 that absorbs radio waves. In general, it is difficult to achieve isolation between the transmission antenna element 102A (Tx1) and the reception antenna element 102E (Rx3), which are closest to each other, so the LC resonator 35 is arranged at that position. In this manner, the antenna module 600 includes the LC resonator 35 arranged between the transmission antenna and the reception antenna.

The LC resonator 35 includes separated copper foils 36, conductive columnar bodies P4, and a protrusion portion 37. The separated copper foil 36 is a copper foil separated from one of the pair of conductor layers 20. As shown in FIGS. 42 and 45, in the present embodiment, two separated copper foils 36 are formed by the uppermost wiring layer L1. The separated copper foil 36 is an island-shaped pattern (herein, a rectangular pattern with rounded corners) that is not connected to the main body of the wiring layer L1. The separated copper foils 36 are arranged side by side in the Y axis direction in a region between the waveguide plate portion 221 of the transmission antenna element 102A and the waveguide plate portion 223 of the reception antenna element 102E. In the present embodiment, the separated copper foil 36 correspond to a separated conductive foil.

The conductive columnar bodies P4 penetrate the dielectric block 10 and connect the separated copper foils 36 to the other conductor layer 20. In the present embodiment, as shown in FIGS. 44 and 45, the protrusion portion 37 protruding from the lowermost wiring layer 16 is formed at a position of the wiring layer L6 that overlaps with the separated copper foils 36. The conductive columnar bodies P4 electrically connect the separated copper foils 36 and the protrusion portion 37. It is noted that as shown in FIG. 43, the conductive columnar bodies P4 are not connected to the middle wiring layer (herein, the wiring layer L3). Accordingly, the LC resonator 35 is formed.

The LC resonator 35 has a structure in which one separated copper foil 36 is connected to the other conductor layer 20 (protrusion portion 37) by one conductive columnar body P4. This structure is similar to that of a so-called patch antenna, and the impedance can be adjusted by adjusting the position of the conductive columnar body P4 (VIA) in the XY plane. Therefore, by arranging the conductive columnar body P4 at a position where the best isolation can be obtained in a desired band (a position where radio wave absorption efficiency in the desired band is the highest), it becomes possible to sufficiently improve the isolation.

By providing the LC resonator 35 between the transmission antenna element 102A and the reception antenna element 102E in this manner, it becomes possible to absorb and shield extra signals at that portion. This reduces the direct waves that enter the reception antenna from the transmission antenna without passing through a measurement target. As a result, it becomes possible to improve the isolation and increase a dynamic range in the input of the millimeter wave radar IC.

It is noted that in the present embodiment, the post wall 28 described with reference to FIG. 33 and the like is provided for suppressing reflection of radio waves that travel toward the rear side, and the like. The LC resonator 35 is arranged in front of the post wall 28. By using the post wall 28 and the LC resonator 35 in combination in this manner, it becomes possible to significantly suppress direct waves.

Descriptions below will be given on the respective characteristics of the antenna module 600. Herein, the transmission antenna elements 102A and 102B will respectively be referred to as the transmission antennas Tx1 and Tx2, and the reception antenna elements 102C, 102D, and 102E will respectively be referred to as the reception antennas Rx1, Rx2, and Rx3.

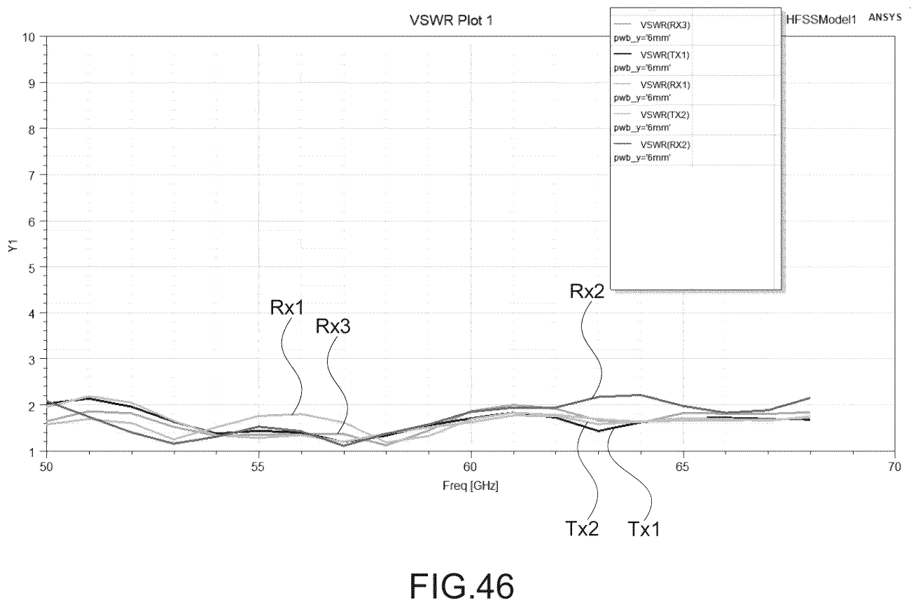

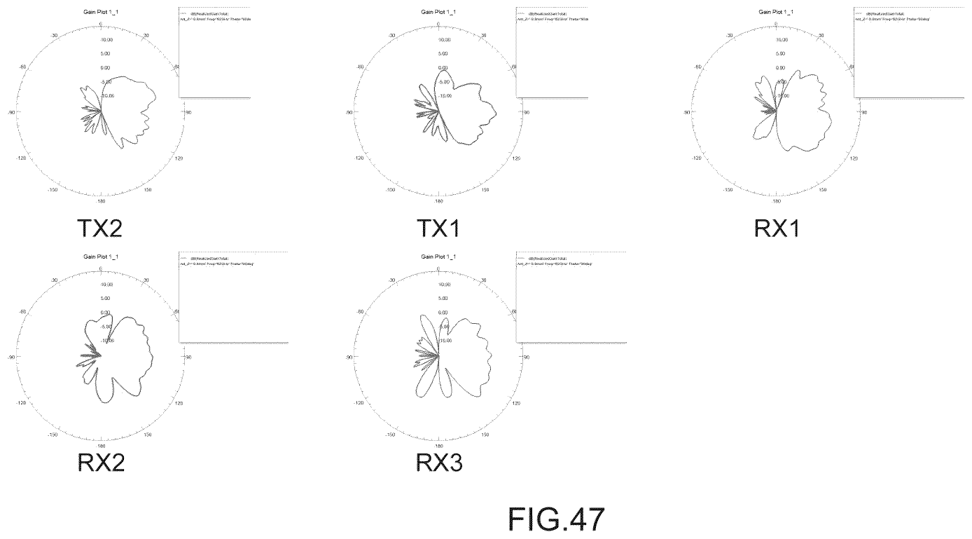

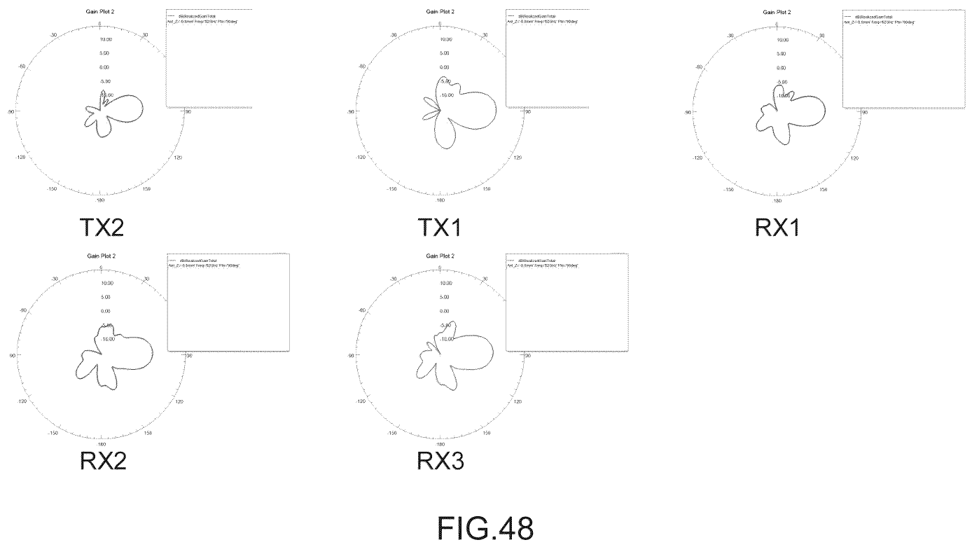

FIG. 46 is a simulation result showing the VSWR characteristics of each antenna of the antenna module 600 according to the present embodiment. FIG. 47 shows simulation results showing the radiation characteristics of each antenna of the antenna module 600 in the azimuth plane (XY plane), and FIG. 48 shows simulation results showing the radiation characteristics of each antenna in the elevation plane (XZ plane). In FIGS. 47 and 48, the frequency of radio waves is 62 GHz.

As shown in FIG. 46, the VSWR in the frequency band used (60 GHz to 64 GHz) is 2 or less, and favorable VSWR characteristics or matching characteristics are obtained. Also, it can be seen from the results shown in FIGS. 47 and 48 that the directivity toward the rear side of the antenna is reduced in both the azimuth plane and the elevation plane.

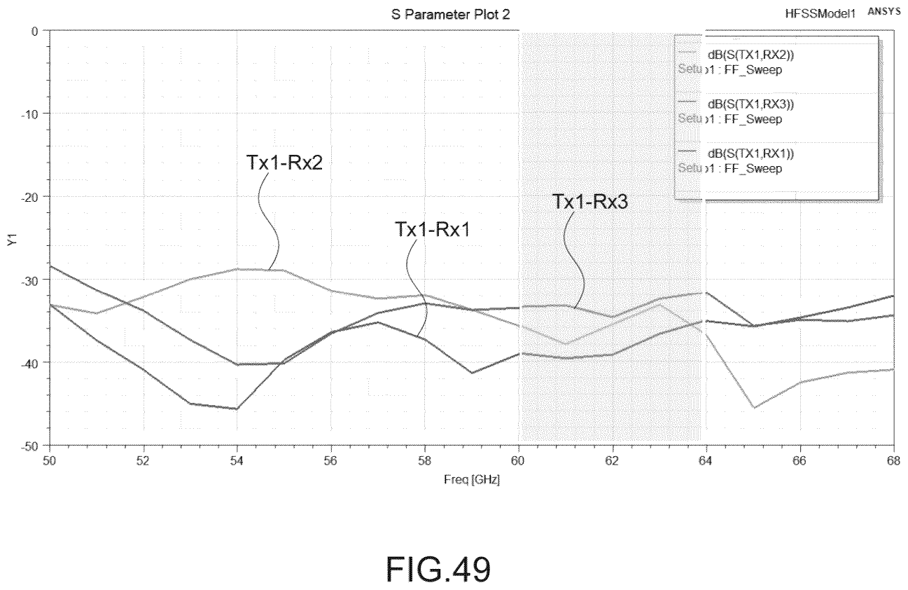

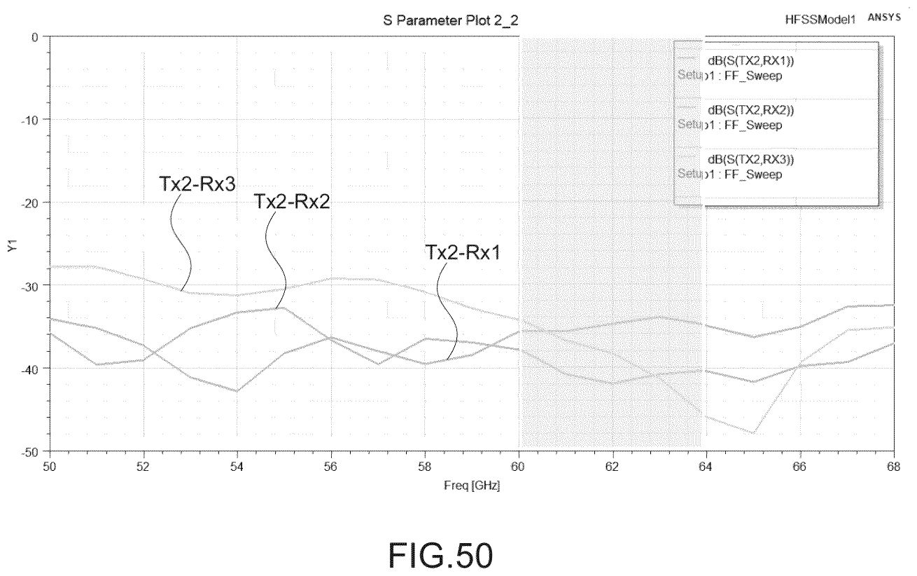

FIG. 49 is a simulation result showing the isolation characteristics of the reception antennas Rx1 to Rx3 with respect to the transmission antenna Tx1, and FIG. 50 is a simulation result showing the isolation characteristics of the reception antennas Rx1 to Rx3 with respect to the transmission antenna Tx2. In FIGS. 49 and 50, the values of the isolation characteristic are both −48 or less in the frequency band used (60 GHz to 64 GHz), and the isolation is sufficiently improved as compared to the case where the LC resonator 35 is not provided (FIGS. 22 and 23). This is considered to be due to the effect of the LC resonator 35 sufficiently absorbing the direct waves.

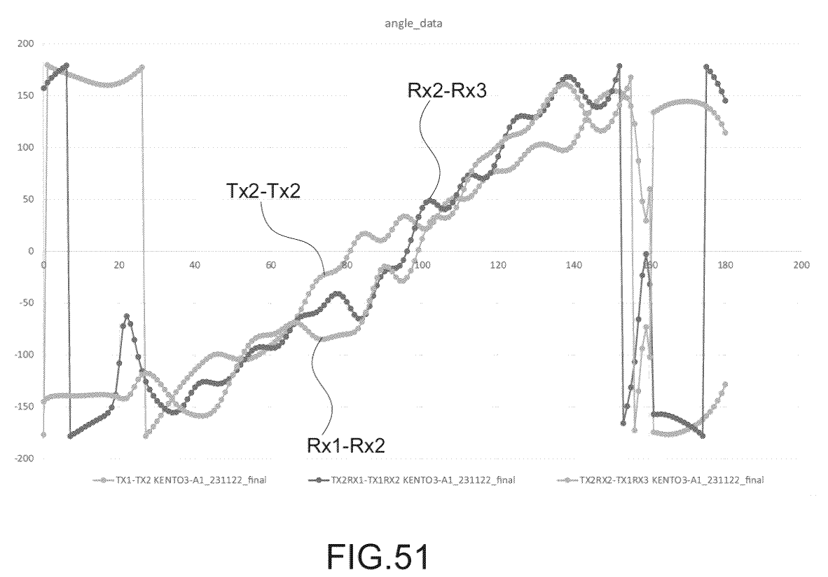

FIG. 51 is a simulation result showing an example of the phase difference characteristics of reception radio waves of the antenna module 600. It was found that also for the phase difference characteristics, the angle estimation width is widened as compared to FIG. 24, for example.

### Sixth Embodiment

An interface between a dielectric body and air is formed at the end portion of the dielectric multilayer substrate used in the antenna module or the like. It is known that radio waves are reflected at this interface due to a difference in the dielectric constant between the dielectric body and air. For example, when radio waves radiated from a transmission antenna are reflected at the interface at the end portion of the substrate, the radio waves remain within the substrate without being radiated outside the substrate. The radio waves that have remained within the substrate in this manner may propagate through the dielectric layer to reach the reception antenna. In this case, the radio waves propagating through the dielectric layer become direct waves that cause lowering of isolation between the transmission side and the reception side in a MIMO radar antenna constituted of a plurality of antennas.

In the present embodiment, an antenna element capable of improving the isolation as described above while realizing a wide viewing angle will be described.

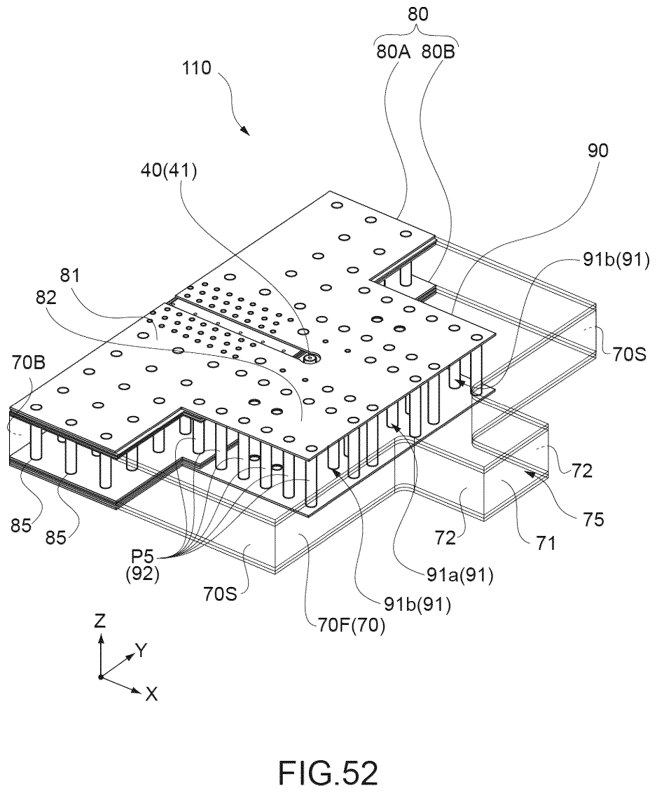

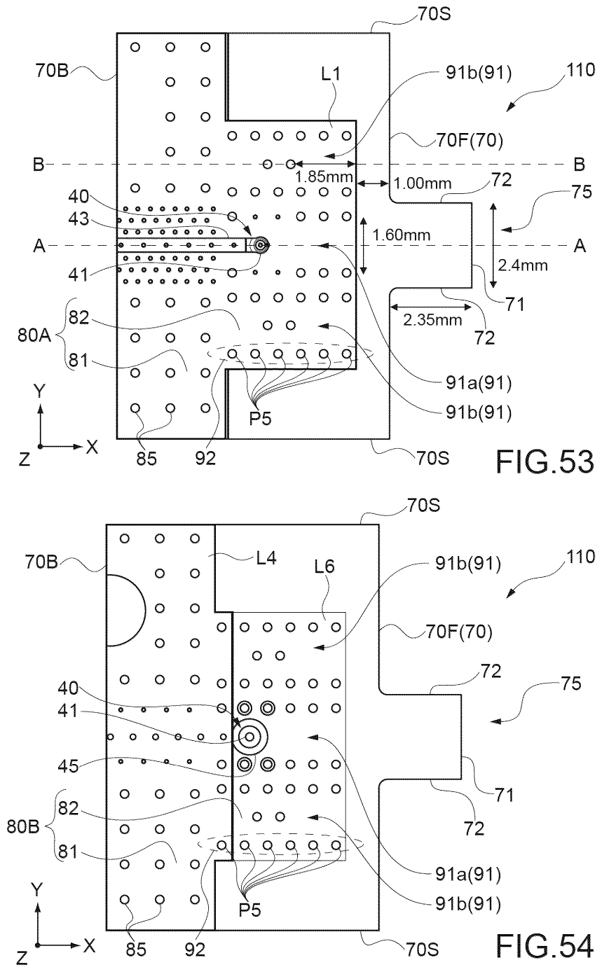

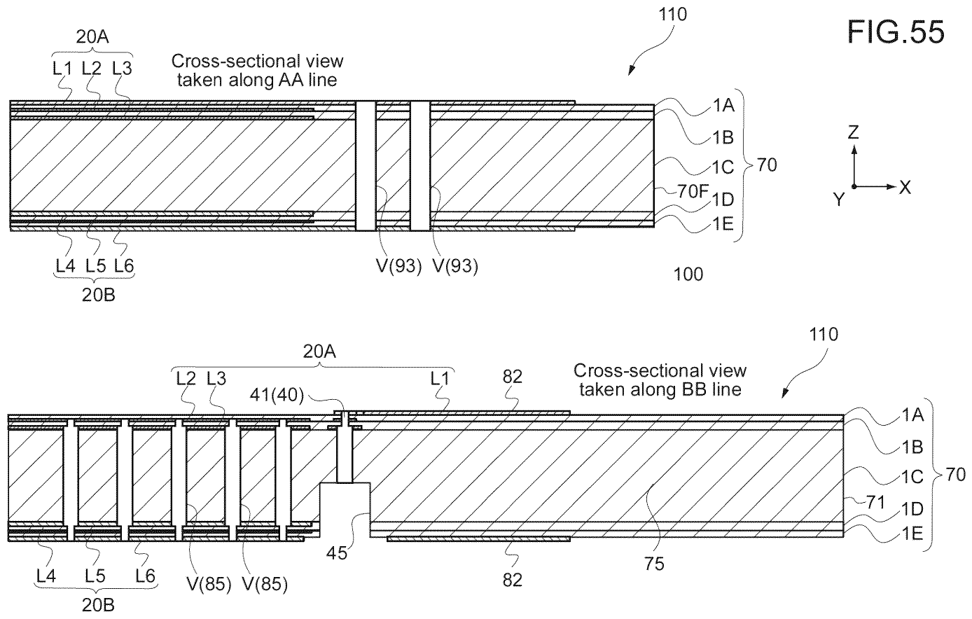

FIG. 52 is a partial transmissive perspective view showing an antenna element 110 according to a sixth embodiment of the present technology, FIG. 53 is a plan view of the antenna element 110 as viewed from above, FIG. 54 is a plan view showing an internal structure of the antenna element 110, and FIG. 55 is a cross-sectional view showing a layer structure of the antenna element 110.

In each figure, the X axis (first axis), the Y axis (second axis), and the Z axis (third axis) indicate three axial directions orthogonal to one another and respectively correspond to the length direction (front-rear direction), the width direction (left-right direction), and the thickness direction (height direction) of the antenna element 110.

### Dielectric Multilayer Substrate

The upper and lower figures of FIG. 55 are cross-sectional views in the XZ plane, which have respectively been taken along a line AA and a line BB in FIG. 53. As shown in FIG. 55, the antenna element 110 is constituted of the dielectric multilayer substrate 1 including a plurality of dielectric layers and a plurality of wiring layers arranged among the dielectric layers. In the present example, five dielectric layers 1A to 1E are laminated in order from the top. Also in the dielectric multilayer substrate 1, six wiring layers L1 to L6 having the dielectric layers 1A to 1E respectively interposed therebetween are arranged. The thickness of the dielectric multilayer substrate 1 is, for example, about 1.6 mm. This structure is similar to the structure described with reference to FIG. 4, for example.

The dielectric layers 1A to 1E are each constituted of a dielectric body having a dielectric constant corresponding to the frequency of radio waves to be transmitted or received by the antenna element 110. Of these, the dielectric layer 1C is a core material that is thicker than the other dielectric layers, and a thickness thereof is set to, for example, 1.1 mm. Further, the other dielectric layers 1A, 1B, 1D, and 1E are formed of a prepreg material or the like, and a thickness of each layer is set to, for example, 60 μm.

The wiring layers L1 to L6 are formed of, for example, a copper foil having a predetermined thickness and are patterned into a predetermined shape. In addition, the wiring layers L1 to L6 are electrically connected to one another at arbitrary positions by a through-hole V (LVH) that connects two adjacent wiring layers or a through-hole V (IVH) that commonly connects three or more wiring layers.

Next, respective portions of the antenna element 110 will be described in detail with reference to FIGS. 52 to 55.

The antenna element 110 according to the present embodiment includes a dielectric block 70, a conductor layer 80, a plurality of conductive columnar bodies 85, a power feeding portion 40, a convex dielectric waveguide 75, and a post waveguide portion 90. The antenna element 110 may be configured as a transmission antenna, a reception antenna, or a transmission/reception antenna. Herein, a case where the antenna element 110 is configured as a transmission antenna will be described as an example.

### Dielectric Block

The dielectric block 70 corresponds to the dielectric layer 1C which is the core of the dielectric multilayer substrate 1. The dielectric block 70 includes a front surface 70F, a rear surface 70B, and two side surfaces 70S. The front surface 70F is an end surface that is formed at a front of the antenna element 110 and is orthogonal to the X axis direction. The rear surface 70B is a rear end surface on the opposite side of the front surface 70F. The both side surfaces 70S are end surfaces orthogonal to the Y axis direction. Furthermore, in the dielectric block 70, the convex dielectric waveguide 75 to be described later is formed to protrude from the front surface 70F.

### Conductor Layer

The conductor layer 80 includes a pair of conductor layers 80A and 80B. Herein, the conductor layer 80 provided on a surface (upper surface in FIG. 1) of the dielectric block 70 will also be referred to as a first conductor layer 80A, and the conductor layer 80 provided on a back surface (lower surface in FIG. 1) of the dielectric block 70 will also be referred to as a second conductor layer 80B. The first conductor layer 80A corresponds to the wiring layers L1 to L3 in the dielectric multilayer substrate 1, and the second conductor layer 80B corresponds to the wiring layers L4 to L6 in the dielectric multilayer substrate 1.

The first conductor layer 80A and the second conductor layer 80B each include a base plate portion 81 and a waveguide plate portion 82. The base plate portion 81 and the waveguide plate portion 82 are formed integrally and are typically connected to a ground potential. The base plate portion 81 is a portion where various wirings including a microstrip line to be connected to the power feeding portion 40, and the like are formed. The waveguide plate portion 82 is a portion that constitutes the post waveguide portion 90 to be described later.

FIG. 53 is a plan view of the first conductor layer 80A as viewed from above and shows the uppermost wiring layer L1. Further, FIG. 54 is a plan view of the second conductor layer 80B arranged below the dielectric block 70, as viewed from above, and shows the wiring layer L4 arranged immediately below the dielectric block 70 and the wiring layer L6 arranged as the lowermost layer.

As shown in FIG. 53, the pattern of the wiring layer L1 includes a strip-like region that is provided on the rear side of the power feeding portion 40 along the Y axis direction and a rectangular protrusion region that protrudes a predetermined distance from the strip-like region more toward the front side (+X direction) than the power feeding portion 40. Further, as shown in FIG. 54, the wiring layer L4 includes a strip-like region similar to the pattern of the wiring layer L1 and a protrusion region that protrudes toward the front side from the strip-like region so as not to overlap with the power feeding portion 40. It is noted that the patterns of the other wiring layers L2, L3, and L5 provided as the inner layers are similar to that of the wiring layer L4, and the pattern of the wiring layer L6 is similar to that of the wiring layer L1.

In the present embodiment, in each of the wiring layers L1 to L6, the strip-like region provided on the rear side of the power feeding portion 40 functions as the base plate portion 81. In addition, the rectangular protrusion region protruding toward the front side from the base plate portion 81 functions as the waveguide plate portion 82. Herein, in the wiring layers L1 and L6, a distance from a front end of the waveguide plate portion 82 to the front surface 70F of the dielectric block 70 is set to 1.00 mm.

### Conductive Columnar Body

The plurality of conductive columnar bodies 85 penetrates the dielectric block 10 (core material) and is connected to the pair of conductor layers 80. The conductive columnar bodies 85 are, for example, through-holes also called IVHs, and electrically connect the first conductor layer 80A and the second conductor layer 80B. Therefore, the conductive columnar bodies 85 are basically at a ground potential.

As shown in FIG. 52 and the like, the antenna element 110 is provided with a large number of conductive columnar bodies 85 throughout the entire conductor layer 80 including the base plate portion 81 and the waveguide plate portion 82. Of these, the conductive columnar bodies 85 connected to the waveguide plate portion 82 constitute the post waveguide portion 90 together with the waveguide plate portion 82.

### Power Feeding Portion

The power feeding portion 40 converts millimeter wave signals introduced from the signal processing circuit (not shown) via the signal line 43 into radio waves that propagate inside the dielectric block 10. The power feeding portion 40 includes the power feeding probe 41 (power feeding terminal) that is connected to the signal line 43. Further, the signal line 43 is arranged on the dielectric layer 1A and forms a microstrip line that opposes the wiring layer L2 with the dielectric layer 1A interposed therebetween.

In the present embodiment, a structure similar to that of the power feeding portion 40 described with reference to FIG. 8 is used. That is, the power feeding probe 41 is first formed as a VIA that penetrates the dielectric multilayer substrate 1. Then, the VIA is drilled from the back surface by a drilling process or the like to form the hole portion 45 as shown in the lower figure of FIG. 55. The length of the power feeding probe 41 is adjusted by the depth of the hole portion 45. This makes it possible to easily form the power feeding probe 41 with a desired length. The length of the power feeding probe 41 is adjusted to, for example, about half the thickness of the dielectric multilayer substrate 1. It is noted that the configuration of the power feeding portion 40 is not limited, and power feeding portions 40 having other structures (e.g., the power feeding portion 40 shown in FIG. 6 and FIG. 7, or the like) may be used.

### Convex Dielectric Waveguide

The convex dielectric waveguide 75 is a waveguide formed on the front surface 70F of the dielectric block 70, and is formed to protrude beyond a first post waveguide 91a to be described later. As shown in FIGS. 53 and 54, the convex dielectric waveguide 75 is a waveguide that has a rectangular planar shape and a rectangular parallelepiped shape as a whole. Further, a central axis of the convex dielectric waveguide 75 along the X axis direction coincides with a central axis of the first post waveguide 91a (an axis that passes through the power feeding probe 41).

The convex dielectric waveguide 75 forms a first antenna opening 71 opened in the X axis direction and second antenna openings 72 opened in the Y axis direction. The first antenna opening 71 is a surface parallel to the YZ plane and is an end surface that opposes an opening end of the first post waveguide 91a in the X axis direction. The second antenna openings 72 are surfaces parallel to the XZ plane and are end surfaces on both sides that oppose each other in the Y axis direction with the convex dielectric waveguide 75 interposed therebetween. In the present embodiment, the convex dielectric waveguide 75 corresponds to an antenna opening portion.

The thickness (the width in the Z axis direction) of the convex dielectric waveguide 75 is determined by the thickness of the dielectric multilayer substrate 1 constituting the antenna element 110. Therefore, the thickness of the convex dielectric waveguide 75 is equal to the thickness of the laminated dielectric layers 1A to 1E, for example.

Incidentally, in a wave guide or a waveguide, radio waves propagate by causing resonance. For this reason, it is also necessary for the convex dielectric waveguide 75 to have a width of at least about half the wavelength of the frequency to be used. In this regard, the width of the convex dielectric waveguide 75 in the Y axis direction is set to a length close to ½ the wavelength λ of the radio waves used. Herein, the width is set to 2.4 mm, which is close to a length of a half wavelength of the frequency of 59 GHz. Accordingly, radio waves that have entered the convex dielectric waveguide 75 propagate through the convex dielectric waveguide 75 in a HE11 mode, which is a basic mode in the dielectric waveguide, and are efficiently radiated toward the front side of the convex dielectric waveguide 75 as a point-symmetric or line-symmetric beam.

Furthermore, a degree of the reflection due to a difference in dielectric constant between a tip end of the dielectric waveguide and air changes in accordance with the length of the waveguide with respect to the wavelength. Therefore, the length of the convex dielectric waveguide 75 (the length protruding in the X axis direction from the front surface 70F of the dielectric block 70) is set so as to be optimized with respect to the reflection at the tip end (first antenna opening 71) of the convex dielectric waveguide 75. In other words, the length of the convex dielectric waveguide 75 is set so as to suppress the amount of reflection of radio waves at the tip end. Herein, the length of the convex dielectric waveguide 75 is set to 2.35 mm.

In this manner, by the convex dielectric waveguide 75 in the rectangular parallelepiped shape, which includes the first antenna opening 71 and the second antenna openings 72, it becomes possible to efficiently radiate a beam having a certain spread toward the front side of the antenna element 110. In other words, it becomes possible to reduce radio waves that travel toward the rear side. This makes it possible to improve the isolation as compared to, for example, a case where the convex dielectric waveguide 75 is not provided.

### Post Waveguide Portion

The post waveguide portion 90 includes a plurality of post waveguides 91 (herein, three post waveguides 91). Herein, the post waveguide 91 is a waveguide surrounded by the pair of conductor layers 80 and the plurality of conductive columnar bodies 85. Hereinafter, the plurality of conductive columnar bodies 85 constituting the post waveguide 91 in the post waveguide portion 90 will be referred to as conductive columnar bodies P5.

The post waveguide 91 includes a post wall 92 in which the plurality of conductive columnar bodies P5 is arranged along the X axis direction. The interval of the conductive columnar bodies P5 constituting the post wall 92 is set such that radio waves do not pass through the post wall 92, and is set to, for example, an interval that is ¼ or less of the wavelength of radio waves used in the dielectric block 70. Thus, the post wall 92 functions as a wall surface of the waveguide that confines the radio waves, similar to the conductor layer 80.

As described above, the post waveguide 91 is formed in the waveguide plate portion 82 of the conductor layer 80. That is, the post waveguide 91 is formed by sectioning a space between the waveguide plate portion 82 of the first conductor layer 80A and the waveguide plate portion 82 of the second conductor layer 80B by a pair of post walls 92 provided along the X axis direction.

In the present embodiment, the post waveguide portion 90 is provided with the first post waveguide 91a and two second post waveguides 91b and 91c.

The first post waveguide 91a is a post waveguide that is connected to the power feeding probe 41 and is formed from the power feeding probe 41 along the X axis direction. As shown in FIGS. 53 and 54, the first post waveguide 91a is a waveguide that is sectioned by the two post walls 92 (first post walls) arranged opposed to each other in the Y axis direction with the power feeding probe 41 interposed therebetween, and extends from the power feeding probe 41 to a front end of the waveguide plate portion 82.

Further, the first post waveguide 91a generates radio waves by the millimeter wave signals supplied to the power feeding probe 41, and radiates the generated radio waves from a front opening. The radio waves radiated from the first post waveguide 91a enter the convex dielectric waveguide 75 provided in front of the first post waveguide 91a.

In general, a basic mode of radio waves that propagate through the post waveguide is a TE10 mode. Further, as described above, the basic mode of radio waves that propagate through the dielectric waveguide is the HE11 mode. Both the TE10 mode and the HE11 mode are modes of vertically-polarized waves. Therefore, the post waveguide can efficiently excite electromagnetic waves with respect to the dielectric waveguide. For such a reason, in the antenna element 110, by providing the first post waveguide 91a in front of the convex dielectric waveguide 75, it becomes possible to efficiently excite radio waves with respect to the convex dielectric waveguide 75 as compared to a case where the post waveguide is not used, for example.

The second post waveguides 91b and 91c are waveguides that are formed adjacent to the first post waveguide 91a along the X axis direction, and have one end opened and the other end closed in the same direction as the first post waveguide 91a. As shown in FIGS. 53 and 54, the second post waveguides 91b and 91c are respectively formed on the left side (the upper side in the figures) and the right side (the lower side in the figures) of the first waveguide 91a when viewed in the front direction from the power feeding probe 41.

The second post waveguides 91b and 91c are opened at the front. Meanwhile, the conductive columnar bodies P5 (hereinafter, will be referred to as bottom posts 93) are provided in the waveguide at a certain distance from the front opening. Herein, two conductive columnar bodies P5 are provided in each waveguide as the bottom posts 93, but the number of conductive columnar bodies P5 may be one. For example, a distance from the front opening to the bottom post 93 becomes a depth of that post waveguide 91.

In this manner, the second post waveguides 91b and 91c not having the power feeding portion 40 are arranged on both sides of the first post waveguide 91a. With such a configuration, radio waves radiated from the opening of the first post waveguide 91a at the center are diffracted and scattered by the adjacent second post waveguides 91b and 91c. Accordingly, a phase of the radiated electromagnetic waves can be shifted to control a beam width.

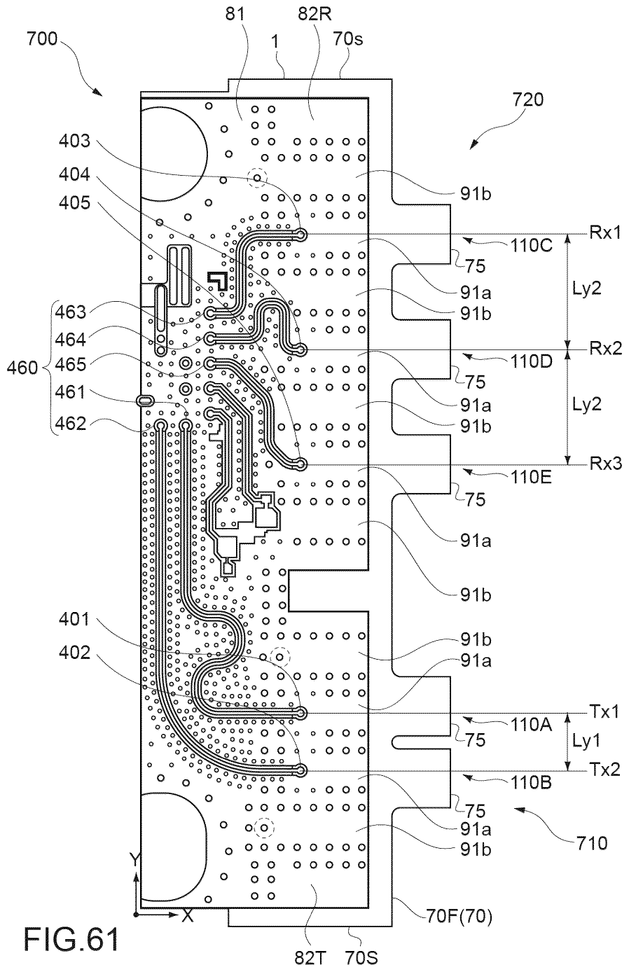

In the present embodiment, the first post waveguide 91a and the second post waveguide 91b (or 91c) are arrayed in the Y axis direction at an interval that is ½ the wavelength λ of radio waves used. Specifically, the interval between the central axes of the respective post waveguides 91 is set to λ/2. Accordingly, in the second post waveguides 91b and 91c, the diffraction and reflection of the radio waves that have exited the first post waveguide 91a are caused efficiently. In addition, by setting the interval between the central axes to λ/2, it becomes easy to configure the MIMO radar or the like (see FIG. 61 and the like). Herein, the interval between the central axes of the respective post waveguides 91 is set to 2.3 mm, which is close to a length of a half wavelength of the frequency of 59 GHz.

Further, the second post waveguides 91b and 91c are constituted of the post wall 92 (second post wall) different from the post wall 92 (first post wall) constituting the first post waveguide 91a. In other words, the first post waveguide 91a and the second post waveguides 91b and 91c do not share the post wall 92. This makes it possible to independently set the width of each post waveguide 91 in the Y axis direction and the interval (the distance between the central axes) of the respective post waveguides 91. Herein, the width of each post waveguide 91 in the Y axis direction is set to 1.6 mm.

Further, the first post waveguide 91a and the second post waveguides 91b and 91c have opening ends at the same position in the X axis direction. That is, the post waveguides 91 are configured such that the opening ends are aligned along the Y axis direction. This makes it possible to efficiently diffract and reflect the radio waves that have exited the first post waveguide 91a.

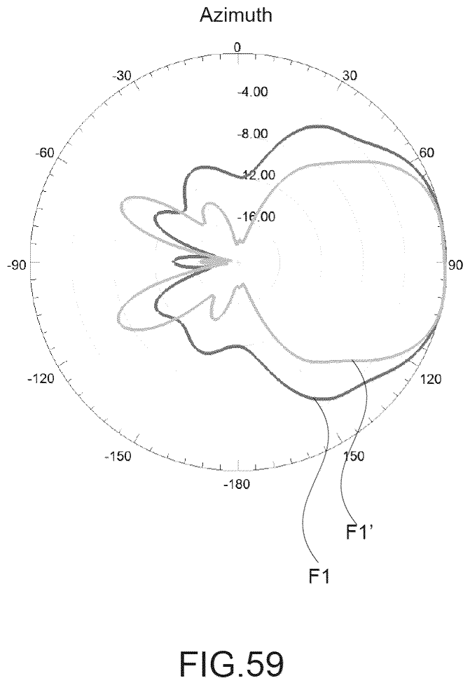

Furthermore, the depth of the second post waveguides 91b and 91c (the distance from the opening end to the bottom post 93 on the front side) is not necessarily the same as the depth of the first post waveguide 91a (the distance from the opening end to the power feeding probe 41). Herein, the depth of the second post waveguides 91b and 91c is set to 1.85 mm, which is smaller than the depth of the first post waveguide 91a. It is noted that by adjusting the depth of the second post waveguides 91b and 91c, it is possible to easily control the diffraction and reflection of radio waves (see FIG. 59 and the like).

Furthermore, the size of the convex dielectric waveguide 75 described above may be set in accordance with the size of each of the post waveguides 91. For example, the width of the convex dielectric waveguide 75 in the Y axis direction may be set to be equal to or larger than the width of the first post waveguide 91a in the Y axis direction and equal to or smaller than a center-to-center distance of the second post waveguides 91b and 91c provided on both sides of the first post waveguide 91a. This makes it possible to realize the isolation of a required level while widening the beam width, for example.

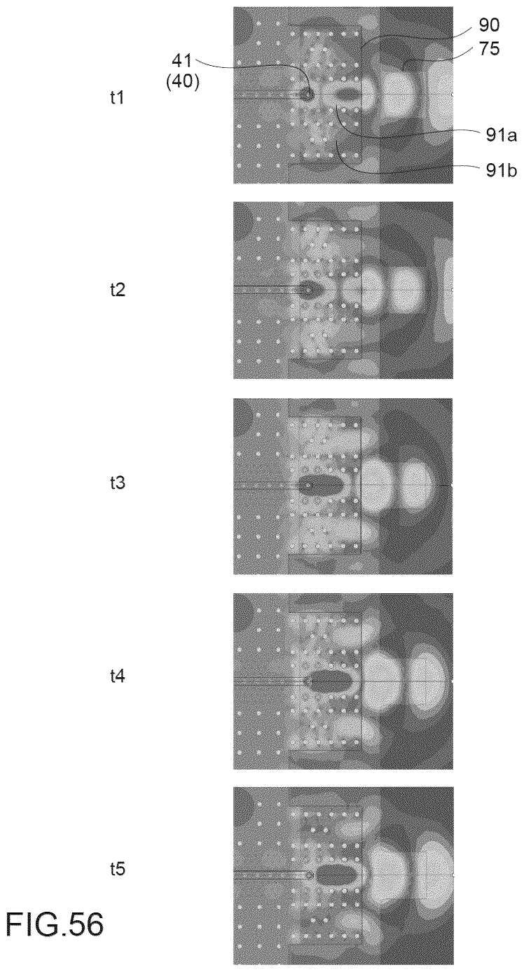

FIG. 56 shows maps showing a temporal change of an electric field intensity distribution in the antenna element 110. In FIG. 56, time passes at regular intervals in the order from times t1 to t5. For example, in the map of t1, it can be seen that the electric field intensity is increased in the vicinity of the power feeding portion 40 in the first post waveguide 91a, and radio waves are generated in the basic mode (TE10 mode). Moreover, while four regions having a high electric field intensity are generated on the right side of the power feeding portion 40, these regions are distributions caused by the propagation of radio waves generated in the basic mode before the time t1.

For example, as shown in the maps of t1 to t5, radio waves generated in the vicinity of the power feeding portion 40 enter the convex dielectric waveguide 75 from the first post waveguide 91a. At this time, in the convex dielectric waveguide 75, the radio waves are excited in the basic mode (HE11 mode) of the dielectric waveguide. This makes it possible to efficiently transfer the radio waves to the convex dielectric waveguide 75.

Furthermore, since the radio waves that propagate through the convex dielectric waveguide 75 are excited in the basic mode, the radio waves become a beam that spreads in point symmetry or line symmetry when radiated in the front direction. In this manner, in the antenna element 110, radio waves can be propagated through the convex dielectric waveguide 75 and radiated smoothly in the front direction. Accordingly, the reflection at the interface between the dielectric body and air is suppressed, and the gain is improved. Furthermore, since the reflection components at the interface are reduced, the isolation can be improved.

Further, in the antenna element 110, the radio waves are diffracted to the second post waveguides 91b and 91c adjacent to the first post waveguide 91a. For example, the maps of t2 to t3 show a state where the radio waves are diffracted and come around to the second post waveguides 91b and 91c from the opening of the first post waveguide 91a. In addition, the maps of t4 to t5 show a state where components diffracted and reflected by the second post waveguides 91b and 91c form a beam having a wider spread. In this manner, by providing the second post waveguides 91b and 91c and diffracting and reflecting the radio waves, it becomes possible to further widen the beam width in the plane parallel to the substrate (XY plane).

In this manner, the antenna element 110 according to the present embodiment has a configuration in which three post waveguides 91a to 91c are arranged using the dielectric multilayer substrate 1, and the convex dielectric waveguide 75 is provided on the same straight line as the post waveguide 91a at the center. This makes it possible to improve the isolation while maintaining a wide beam width. In addition, the antenna element 110 radiates a beam along a plane direction (an in-plane direction of the XY plane) of the dielectric multilayer substrate 1. This makes it possible to realize thinning of the element as compared to, for example, the phased patch antenna.

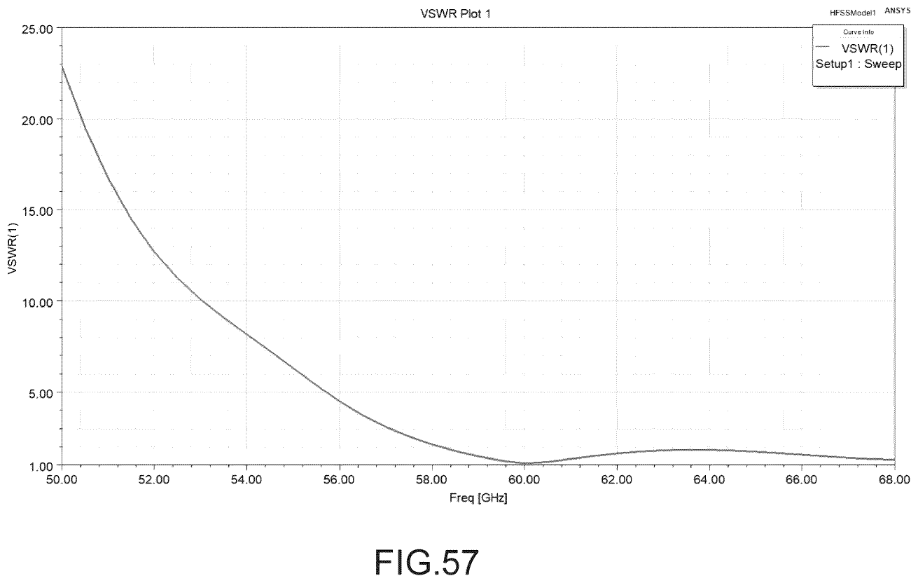

FIG. 57 is a simulation result showing an example of the voltage standing wave ratio (VSWR) of the antenna element 110. As shown in the figure, according to the antenna element 110 of the present embodiment, the VSWR value is 2 or less in the frequency band used (59 GHz to 63 GHz), and favorable VSWR characteristics or matching characteristics are obtained.

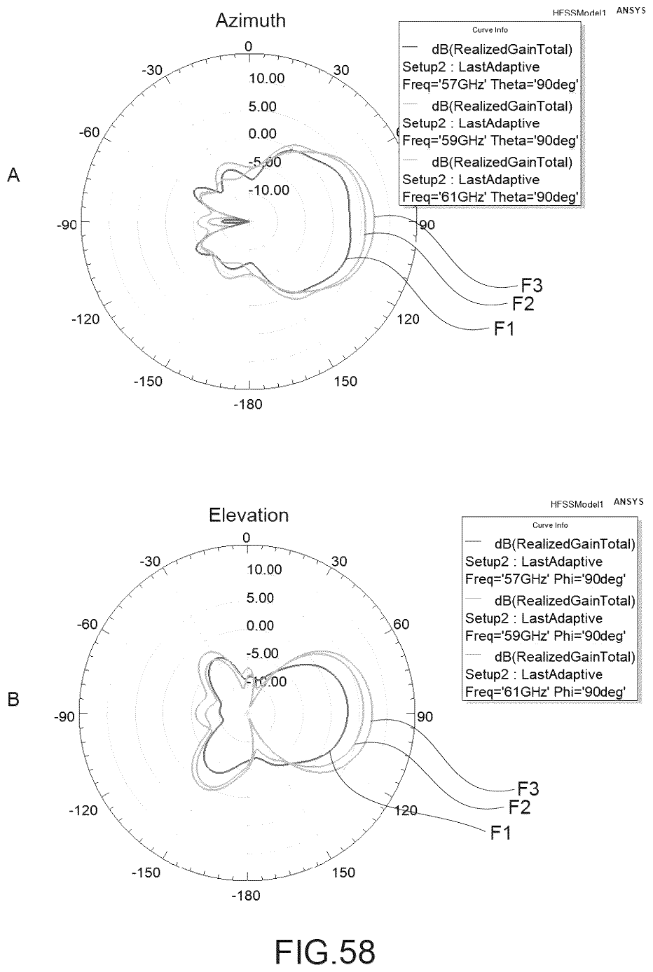

FIG. 58A is a simulation result showing the radiation characteristics of the antenna element 110 in the azimuth plane (XY plane), and FIG. 58B is a simulation result showing the radiation characteristics of the antenna element 110 in the elevation plane (XZ plane). In each figure, the 90° direction corresponds to the front direction (+X direction). Further, each figure shows the radiation characteristics of radio waves of different frequencies, with F1 being 57 GHz, F2 being 59 GHz, and F3 being 61 GHz.

According to the present embodiment, as shown in FIG. 58A, the directivity of radio waves can be expanded across a wide viewing angle range of ±60° (30° to 150°) centered on the front direction. Furthermore, as shown in FIG. 58B, the expansion of the directivity in the elevation plane direction is suppressed by using the convex dielectric waveguide 75. As a result, it becomes possible to radiate an elliptical beam that is wide in the horizontal direction (azimuth) and narrow in the vertical direction (elevation).

FIG. 59 is a simulation result showing a relationship between the depth of the second post waveguide and the beam width. The plot F1 in FIG. 59 is the same as F1 (57 GHz) in FIG. 58A. In contrast, the plot F1′ shows the radiation characteristics of radio waves at 57 GHz in a configuration in which the depth of the second post waveguides 91b and 91c is adjusted to be shallow.

Specifically, the position of the bottom post 93 in the X axis direction is changed to the same position as the frontmost post (conductive columnar body P5) constituting the post wall 92 in the second post waveguides 91b and 91c shown in FIGS. 53 and 54. In this case, the beam width can be narrowed as indicated by the plot F1′. In this manner, it is possible to change the beam width in the horizontal direction by changing the depth of the second post waveguides 91b and 91c.

### Seventh Embodiment

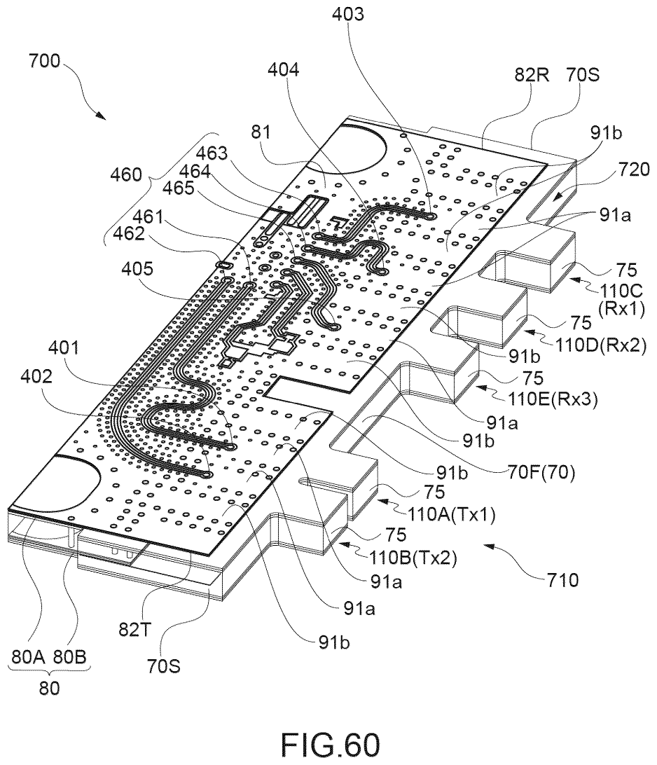

In the present embodiment, as a MIMO radar antenna, an antenna module in which the antenna element 110 described in the sixth embodiment is arranged plurally will be described. FIG. 60 is a partial transmissive perspective view of an antenna module 700 according to a seventh embodiment of the present technology, and FIG. 61 is a plan view of the antenna module 700 as viewed from above. Hereinafter, portions corresponding to those of the sixth embodiment are denoted by the same symbols, and detailed descriptions thereof will be omitted.

In each figure, the X axis (first axis), the Y axis (second axis), and the Z axis (third axis) indicate three axial directions orthogonal to one another, and respectively correspond to the length direction (front-rear direction), the width direction (left-right direction), and the thickness direction (height direction) of the antenna module 700.

### Antenna Module

The antenna module 700 is configured as a transmission/reception antenna that includes a transmission antenna array 710 including a plurality of (two in the present embodiment) transmission antenna elements 110A and 110B and a reception antenna array 720 including a plurality of (three in the present embodiment) reception antenna elements 110C to 110E.

The antenna module 700 is constituted of the dielectric multilayer substrate 1 having a thickness direction in the Z axis direction. The dielectric multilayer substrate 1 is a rectangular plate material elongated in the Y axis direction, and the antenna elements 110A to 110E constituting the transmission antenna array 710 and the reception antenna array 720 are arrayed in the Y axis direction such that the convex dielectric waveguides 75 protrude from the front surface 70F of the dielectric multilayer substrate 1 (dielectric block 70).

The basic structure of each of the antenna elements 110A to 110E is similar to that of the antenna element 110 described above in the sixth embodiment. Of these, the dielectric block 70 and the base plate portions 81 in the pair of conductor layers 80A and 80B are common to the antenna elements 110A to 110E and are provided at arbitrary positions. In addition, the group of the plurality of input/output terminals 460 (461 to 465) for transmitting and receiving millimeter wave signals are provided in the forming region of the base plate portion 81.

As the waveguide plate portion 82 in each of the pair of conductor layers 80A and 80B, a waveguide plate portion 82T common to the transmission antenna array 710 (transmission antenna elements 110A and 110B) is provided, and a waveguide plate portion 82R common to the reception antenna array 720 (reception antenna elements 110C to 110E) is provided. As for the power feeding portion 40, the power feeding portion 40 (power feeding terminals 401 to 405) is individually provided for each of the antenna elements 110A to 110E.

Further, the post waveguide portion 90 is formed in each of the waveguide plate portion 82T of the transmission antenna array 710 and the waveguide plate portion 82R of the reception antenna array 720. The post waveguide portion 90 includes the plurality of post waveguides 91 formed along the X axis direction. The plurality of post waveguides 91 includes the first post waveguide 91a provided for each of the power feeding portions 40. Moreover, the plurality of post waveguides 91 also includes the second post waveguide 91b not having the power feeding portion.

For example, as described with reference to FIGS. 53, 54, and the like, in the antenna element 110, the post waveguides 91 (first post waveguide 91a and second post waveguide 91b) provided in the post waveguide portion 90 can be arranged at an interval that is ½ the wavelength of radio waves used. Therefore, this arrangement can be applied even when the antenna array is configured. That is, in the transmission antenna array 710 and the reception antenna array 720, the center-to-center distance of the adjacent post waveguides 91 out of the plurality of post waveguides 91 is set to be ½ the wavelength of radio waves used (λ/2). This makes it possible to easily realize the arrangement of each of the antenna elements that uses λ/2 as a unit, in the MIMO radar described with reference to FIG. 18 and the like.

Further, as shown in FIG. 53, in the antenna element 110, the distance from the opening end of each of the post waveguides 91a to 91c (the front end of the waveguide plate portion 82) to the front surface 70F of the dielectric block 70 is set to 1.00 mm, but this distance may be shorter. Accordingly, in the dielectric block 70, a path along which the radio waves propagate in the Y axis direction becomes narrow, and thus direct waves can be suppressed.

First, a configuration of the transmission antenna array 710 will be described. The transmission antenna element 110A (hereinafter, will also be referred to as the transmission antenna Tx1) includes the power feeding terminal 401 connected to the output terminal 461. The transmission antenna element 110B (hereinafter, will also be referred to as the transmission antenna Tx2) includes the power feeding terminal 402 connected to the output terminal 462.

In the transmission antenna array 710, the distance Ly1 between the power feeding terminals 401 and 402 along the Y axis direction is set to λ/2 (herein, 2.3 mm). That is, a center-to-center distance between the first post waveguides 91a respectively constituting the transmission antennas Tx1 and Tx2 (the center-to-center distance between the convex dielectric waveguides 75) is set to λ/2.

In this case, for example, the first post waveguide 91a of the transmission antenna Tx2 functions as the second post waveguide 91b for the transmission antenna Tx1. Conversely, the first post waveguide 91a of the transmission antenna Tx1 functions as the second post waveguide 91b for the transmission antenna Tx2. It is noted that the second post waveguides 91b not having the power feeding portion are respectively formed on the outer side of the two first post waveguides 91a arranged next to each other.

Next, a configuration of the reception antenna array 720 will be described. The reception antenna element 110C (hereinafter, will also be referred to as the reception antenna Rx1) includes the power feeding terminal 403 connected to the input terminal 463. The reception antenna element 110D (hereinafter, will also be referred to as the reception antenna Rx2) includes the power feeding terminal 404 connected to the input terminal 464. The reception antenna element 110E (hereinafter, will also be referred to as the reception antenna Rx3) includes the power feeding terminal 405 connected to the input terminal 465.

As described above, the transmission antenna array 710 is provided with the two transmission antennas Tx1 and Tx2 provided with the interval of λ/2. Therefore, in the reception antenna array 720, the distance Ly2 among the power feeding terminals 403 to 405 along the Y axis direction is set to 2×λ/2=λ (herein, 4.6 mm). That is, the interval among the first post waveguides 91a respectively constituting the reception antennas Rx1 to Rx3 (the interval among the convex dielectric waveguides 75) is set to λ.

In this case, in the reception antennas Rx1 to Rx3, the second post waveguides 91b not having the power feeding portion 40 are provided among the three first post waveguides 91a arranged next to one another. This second post waveguide 91b is shared by the antenna elements on both sides. It is noted that second post waveguides 91b not having the power feeding portion are also formed on the outer side of the three first post waveguides 91a arranged next to one another.

Furthermore, an interval between the transmission antenna array 710 and the reception antenna array 720 is set as large as possible in order to improve the isolation. Herein, an interval between the reception antenna Rx3 and the transmission antenna Tx1 is set to 10 mm.

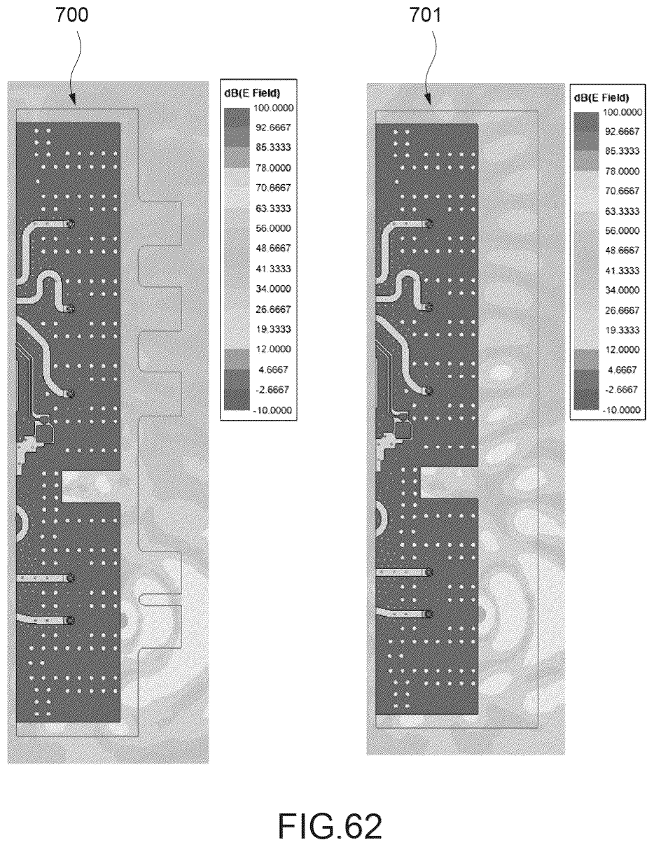

FIG. 62 shows maps showing the electric field intensity distribution in the antenna module 700 and an antenna module 701 given as a comparative example. In the antenna module 701 given as the comparative example, a post waveguide 91 similar to that of the antenna module 700 is provided, and the convex dielectric waveguide 75 is not provided. It is noted that in the antenna module 701, the position of the front surface 70F of the dielectric block 70 in the X axis direction is the same as the position of the front end (first antenna opening 71) of the convex dielectric waveguide 75 in the antenna module 700.

In each map shown in FIG. 62, radio waves are emitted from the transmission antenna Tx2 on the lowermost side of the figure. For example, in the antenna module 701, it can be seen that the radio waves propagate upwardly in the figure along the front surface 70F of the dielectric block 70, and direct waves reach the reception antenna array 720 side.

On the other hand, in the antenna module 700 provided with the convex dielectric waveguide 75 according to the present embodiment, the beam is radiated in a widened manner toward the front side from the transmission antenna Tx2, but almost no radio waves propagate along the front surface 70F of the dielectric block 70. Therefore, it can be seen that the direct waves that reach the reception antenna array 720 side are suppressed. In this manner, by providing the convex dielectric waveguide 75, it is possible to significantly improve the isolation.

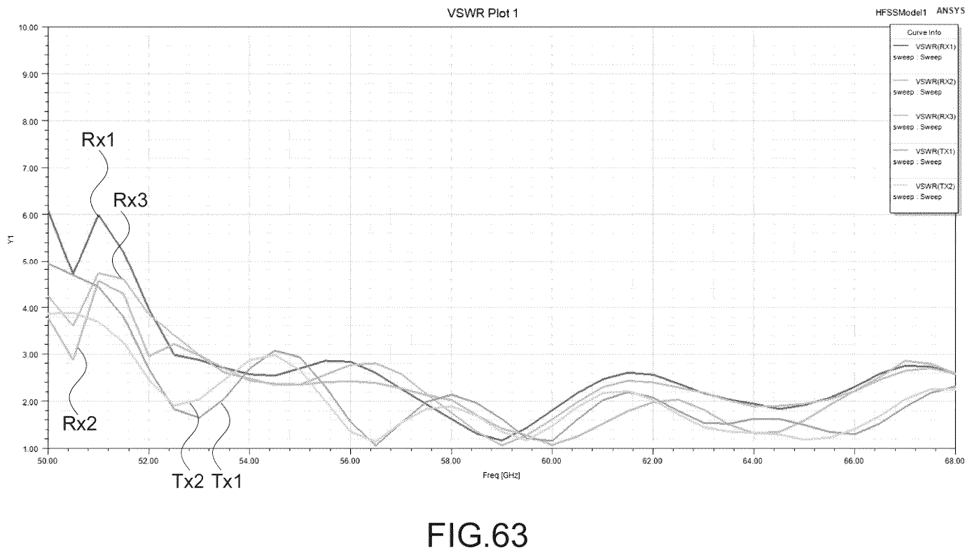

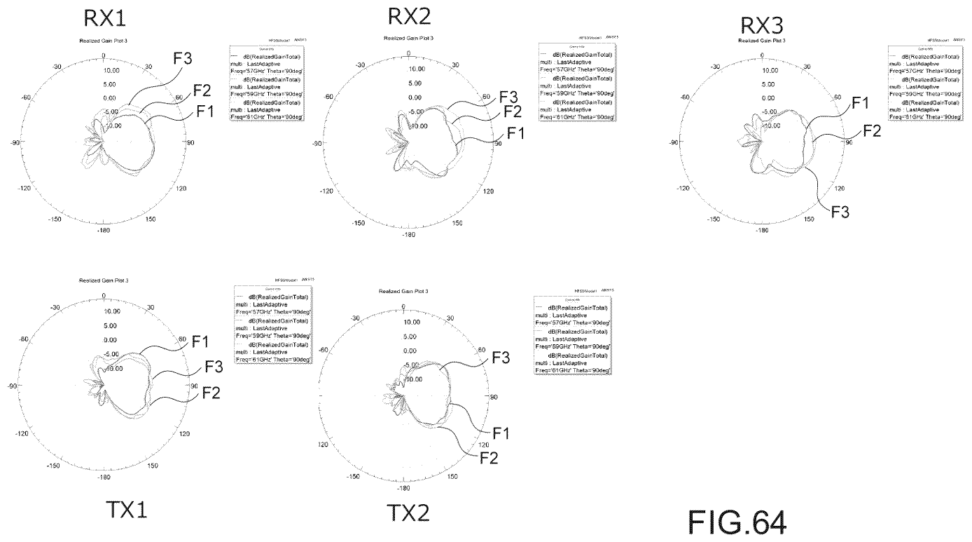

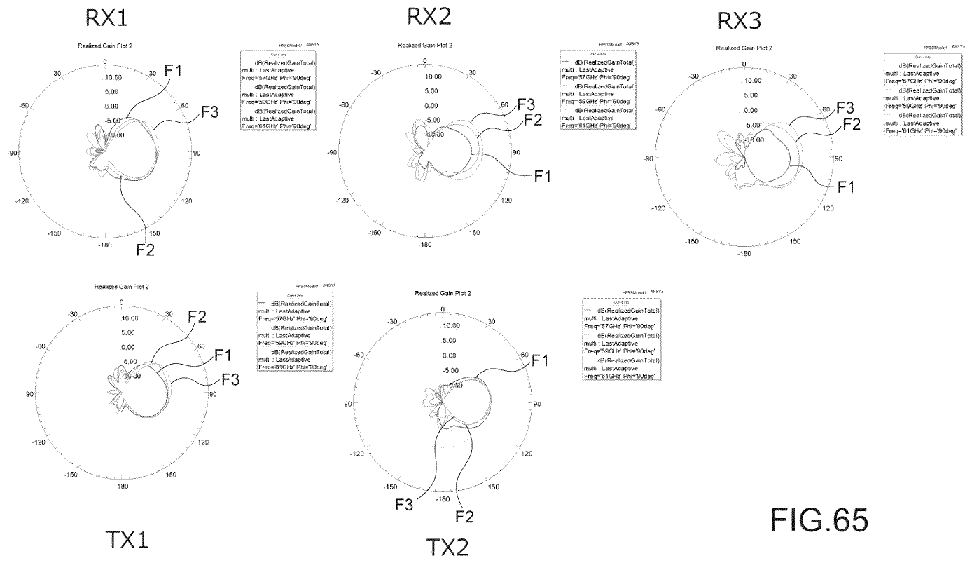

FIG. 63 is a simulation result showing the VSWR characteristics of each antenna of the antenna module 700 according to the present embodiment. FIG. 64 shows simulation results showing the radiation characteristics of each antenna of the antenna module 700 in the azimuth plane (XY plane), and FIG. 65 shows simulation results showing the radiation characteristics of each antenna in the elevation plane (XZ plane). In FIGS. 64 and 65, F1 is 57 GHz, F2 is 59 GHz, and F3 is 61 GHz.

From the results shown in FIGS. 63 to 65, when compared with the characteristics of the antenna alone, changes in the characteristics are seen in the antennas configured as the antenna array, and differences in characteristics are also seen among the antennas. This is because arranging the plurality of antennas next to one another leads to an increase of the influence of the conductors and dielectric bodies in the periphery of the antennas on the characteristics.

For example, in FIG. 63, the VSWR in the frequency band used (59 GHz to 63 GHz) is somewhat higher than that of the antenna alone. On the other hand, the VSWR value in the present band is 3 or less, and thus it can be said that favorable VSWR characteristics or matching characteristics are also obtained in the antenna module 700.

As shown in FIG. 64, a wide beam width is realized in all of the transmission antennas Tx1 and Tx2 and the reception antennas Rx1 to Rx3. In addition, as shown in FIG. 65, it can be seen that the spread of the beam in the elevation plane is suppressed as compared to the azimuth plane in each of the antennas.

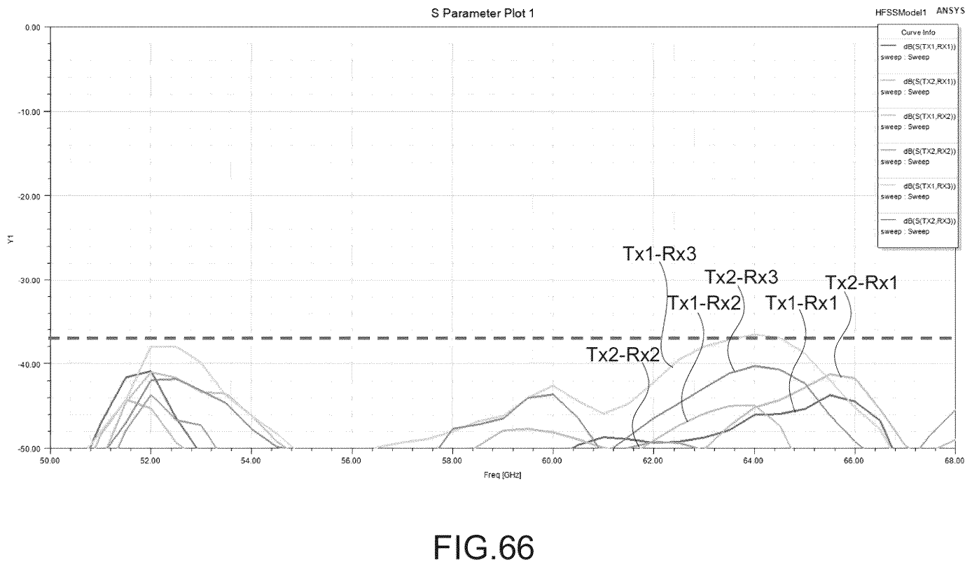

FIG. 66 is a simulation result showing the isolation characteristics of the reception antennas Rx1 to Rx3 with respect to the transmission antennas Tx1 and Tx2 in the antenna module 700. It can be seen from the result shown in FIG. 66 that the isolation characteristics are improved as a whole as compared to the isolation characteristics shown in FIG. 22 in the configuration not provided with the convex dielectric waveguide 75, for example. For example, in FIG. 22, the value of the isolation characteristics is about −28 at worst. In contrast, in FIG. 66, the value of the isolation characteristics is about −37 at worst. Since the isolation with direct waves suppressed can be secured in this manner, it becomes possible to ensure a dynamic range on the reception side and improve detection accuracy of the radar, for example.

Next, the phase difference characteristics of the antenna module 700 will be described. For example, a large difference in phase characteristics of the respective antennas included in the antenna module 700 affects the phase difference characteristics between the antennas, to thus eventually lead to deterioration of the object detection accuracy. In this regard, in this antenna, the depth of the second post waveguide 91b adjacent to the first post waveguide 91a for power feed is adjusted to reduce the difference in phase characteristics of the respective antennas.

In the example shown in FIG. 61, for example, in order to improve the difference in phase characteristics of the respective antennas, the position of the via (bottom post 93) is displaced to adjust the depth of the second post waveguide 91b. Herein, the position of the bottom post 93 at a position surrounded by a thin dotted circle is adjusted.

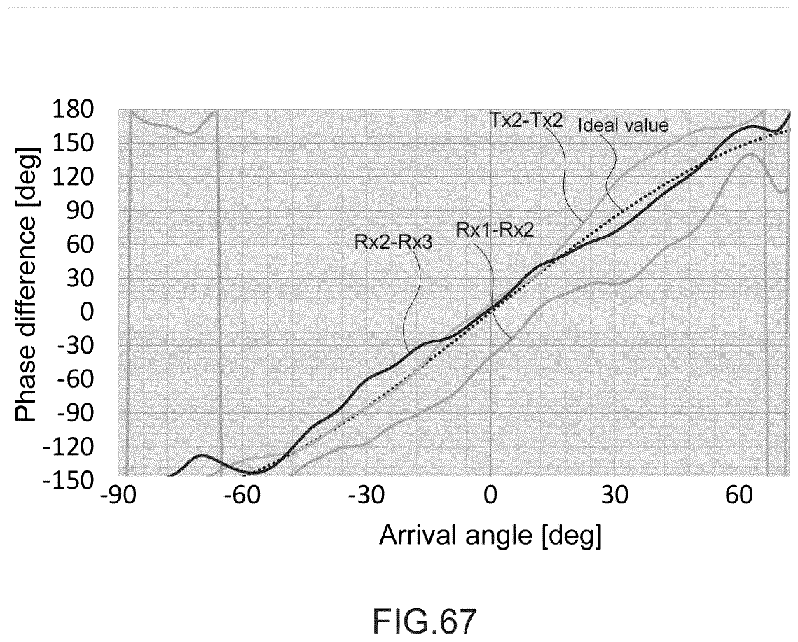

FIG. 67 is a simulation result showing an example of the phase difference characteristics of the antenna module 700. The result shows the phase characteristics when viewed at an angle 30 cm away from the origin where the antenna module 700 is arranged. It is noted that in each graph of Rx1−Rx2 and Rx2−Rx3, the phase characteristics between the transmission antennas (Tx1−Tx2) is subtracted. It can be seen that by displacing the position of the bottom post 93 and adjusting the depth of the waveguide as described above, the ripples in each plot become smaller and the characteristics close to an ideal value are obtained as compared to the phase difference characteristics shown in FIG. 24 or the like in the case where the post waveguide is not provided. This makes it possible to improve the detection accuracy of the radar.

In the MIMO radar antenna constituted of the plurality of antennas, it is important to realize sufficient isolation between the transmission side and the reception side. Meanwhile, the reflection of the radio waves emitted from the transmission antenna at the interface between the dielectric substrate and air causes deterioration of the isolation. If the isolation deteriorates, an SN ratio of reflected waves from an object becomes small, and a detection target may become more likely to be overlooked.

For example, as an isolation improvement method that uses a post wall, there is a method of providing a post wall between antennas. There is also a method of drilling a hole in an antenna to adjust impedance and improve directivity, to thus improve the isolation. In these methods, large costs may be required for the process of antennas and the like.

The antenna module 700 according to the present embodiment is provided with the antenna elements 110 each including the convex dielectric waveguide 75. Accordingly, the radio waves converted by the power feeding portion 40 propagate through the convex dielectric waveguide and are efficiently radiated in the front direction, and the radio waves reflected at the interface between the dielectric body and air are less likely to propagate to the adjacent antenna.

Furthermore, the plurality of post waveguides 91 is set at the interval that is ½ the wavelength in the antenna element 110. Accordingly, the radio waves radiated from each of the antenna elements 110 are diffracted and reflected by the adjacent post waveguides, thus making it possible to realize a wide beam width in the horizontal direction.

Furthermore, in the antenna element 110 according to the present embodiment, the convex dielectric waveguide 75 can be formed by merely modifying the outer shape of the dielectric multilayer substrate 1, for example, so manufacturing costs can be suppressed. Moreover, by forming the convex dielectric waveguide 75, it becomes possible to sufficiently improve the isolation while realizing a wide beam width in the horizontal direction.

### Modified Examples

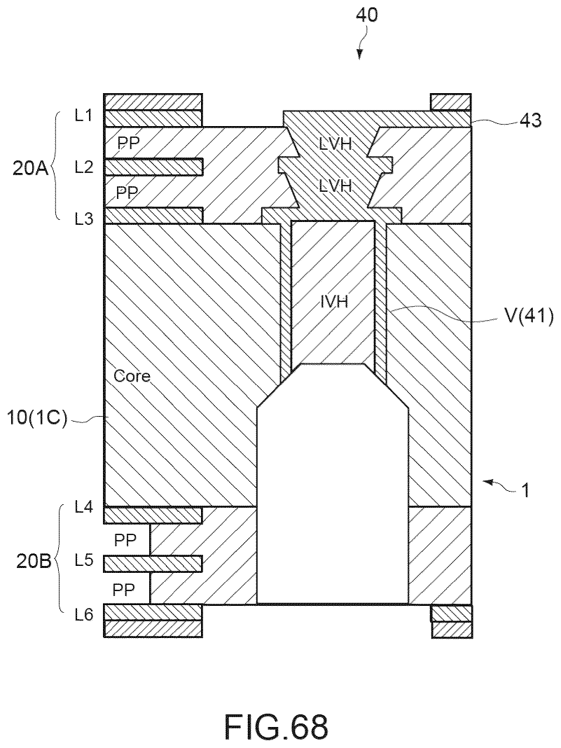

In the embodiments above, the entire power feeding portion 40 (power feeding probe 41) is formed by a through-hole (IVH) as shown in FIG. 8, but the present technology is not limited to this, and the wiring layers L1 to L3 of the first conductor layer 20A that correspond to the upper portion of the power feeding portion 40 may be connected by individual vias (LVH) as shown in FIG. 68, for example. In this case, the portion of the power feeding portion 40 provided inside the dielectric block 10 can be formed by the through-hole (IVH) similar to that shown in FIG. 8.

Further, although the hole portion 45 is formed in the dielectric block 10 by back drilling for adjusting the length of the power feeding probe 41, the hole portion 45 may be filled with a resin in consideration of long-term reliability. Furthermore, instead of forming the hole portion 45, the power feeding probe 41 may be shorted to the wiring layer L6 in the second conductor layer 20B.

It is noted that although not described in the above embodiments, a protective layer (solder resist) for protecting the wiring may be provided on both surfaces of the dielectric multilayer substrate 1. An influence of the dielectric loss (tan δ) differs according to the presence or absence of this protective layer, the difference in the materials, and the like, but in the present technology, the presence or absence of the protective layer and the difference in the materials are not particularly important.

When providing the solder resist, since the resist material has a large dielectric loss tangent, a loss in the transmission line (signal line) of millimeter wave signals may become large. On the other hand, when not providing the solder resist, gold plating or the like is required to avoid corrosion or the like at that portion. In this manner, from the viewpoint of long-term reliability and costs, it is favorable to minimize the area to not apply the solder resist as much as possible.

In this regard, when providing the solder resist, the application of the solder resist may be avoided only in the periphery of the transmission line of millimeter wave signals. Accordingly, it becomes possible to reduce the loss in the transmission line and reduce an area of the area where gold plating or the like is to be performed. It is noted that also for the antenna portion, the loss can be reduced more when not applying the resist. Meanwhile, by applying the resist also to the antenna portion, radiation in unnecessary directions is also suppressed. Whether or not to apply the resist to the antenna portion may be determined by taking these characteristics into consideration.

Of the feature portions according to the present technology described above, at least two of the feature portions can be combined. In other words, the various feature portions described in the respective embodiments may be arbitrarily combined without distinction of the embodiments. Moreover, the various effects described above are mere examples and are not limited, and other effects may also be exerted.

It is noted that the present technology can also take the following configurations.
(1) An antenna element, including:
   a dielectric block;
   a power feeding terminal provided in the dielectric block;
   a pair of conductor layers opposing each other with the dielectric block interposed therebetween; and
   an antenna opening portion which forms, in a plane direction along the pair of conductor layers, a first antenna opening opened in a first axial direction as viewed from the power feeding terminal and a second antenna opening opened in a second axial direction orthogonal to the first axis.
(2) The antenna element according to (1), further including:
   a plurality of conductive columnar bodies which is arranged in a first region of the dielectric block and penetrate the dielectric block in a thickness direction of the dielectric block, in which
   the power feeding terminal is arranged in a second region of the dielectric block,
   the pair of conductor layers each include a base portion which is arranged in the first region and is connected to the plurality of conductive columnar bodies and a waveguide plate portion which is arranged in the second region and protrudes in the first axial direction from the base portion, and
   the waveguide plate portion forms, as the antenna opening portion, the first antenna opening opened in the first axial direction and the second antenna opening opened in the second axial direction.
(3) The antenna element according to (2), in which
   the plurality of conductive columnar bodies forms a post wall in which the plurality of conductive columnar bodies is arrayed along the second axial direction at an interval that is ¼ or less of a wavelength of electromagnetic waves that propagate through the dielectric block.
(4) The antenna element according to (2) or (3), in which
   the power feeding terminal extends from one of the pair of conductor layers to another one of the pair of conductor layers, and
   a length of the power feeding terminal along the thickness direction of the dielectric block is smaller than a thickness of the dielectric block.
(5) The antenna element according to (4), in which
   the dielectric block includes a hole portion which is drilled from a side of the other one of the pair of conductor layers and has a depth that reaches the power feeding terminal.
(6) The antenna element according to (5), in which
   the power feeding terminal has a length that is half the thickness of the dielectric block.
(7) The antenna element according to any one of (2) to (6), in which
   the waveguide plate portion includes a first waveguide plate region which protrudes in the first axial direction from the base portion by a first width and a second waveguide plate region which protrudes in the first axial direction from the first waveguide plate region by a second width larger than the first width.
(8) The antenna element according to any one of (2) to (7), in which
   the dielectric block further includes a third region which covers each of the first antenna opening and the second antenna opening.
(9) The antenna element according to (1), further including:
   a plurality of conductive columnar bodies which penetrates the dielectric block and is connected to the pair of conductor layers; and
   a post waveguide portion including at least one post waveguide surrounded by the pair of conductor layers and the plurality of conductive columnar bodies, in which
   the post waveguide portion includes a first post waveguide which is connected to the power feeding terminal and is formed from the power feeding terminal along the first axial direction, and
   the dielectric block includes a convex dielectric waveguide which is formed to protrude in front of the first post waveguide and forms, as the antenna opening portion, the first antenna opening opened in the first axial direction and the second antenna opening opened in the second axial direction.
(10) The antenna element according to (9), in which
   the post waveguide portion includes a second post waveguide which is formed adjacent to the first post waveguide along the first axial direction, the second post waveguide having one end opened and another end closed in a same direction as the first post waveguide.
(11) The antenna element according to (10), in which
   the first post waveguide and the second post waveguide are arrayed in the second axial direction at an interval that is ½ a wavelength of radio waves used.
(12) The antenna element according to (10) or (11), in which
   a width of the convex dielectric waveguide in the second axial direction is equal to or larger than a width of the first post waveguide in the second axial direction and equal to or smaller than a center-to-center distance of the second post waveguides provided on both sides of the first post waveguide.
(13) The antenna element according to any one of (10) to (12), in which
   the post waveguide includes a post wall in which the plurality of conductive columnar bodies is arranged along the first axial direction, and
   the second post waveguide is constituted of a second post wall different from a first post wall constituting the first post waveguide.
(14) The antenna element according to any one of (10) to (13), in which
   positions of opening ends of the first post waveguide and the second post waveguide in the first axial direction are the same.
(15) The antenna element according to any one of (10) to (14), in which
   depths of the first post waveguide and the second post waveguide from the opening ends thereof are different.
(16) An antenna array, including:
   a dielectric block;
   a plurality of power feeding terminals provided in the dielectric block;
   a pair of conductor layers opposing each other with the dielectric block interposed therebetween; and
   an antenna opening portion which forms, in a plane direction along the pair of conductor layers, a first antenna opening opened in a first axial direction as viewed from the power feeding terminals and a second antenna opening opened in a second axial direction orthogonal to the first axis.
(17) The antenna array according to (16), further including:
   a plurality of conductive columnar bodies which is arranged in a first region of the dielectric block and penetrates the dielectric block in a thickness direction of the dielectric block, in which
   the plurality of power feeding terminals is arranged in a second region of the dielectric block,
   the pair of conductor layers each include a base portion which is arranged in the first region and is connected to the plurality of conductive columnar bodies and a waveguide plate portion which is arranged in the second region and protrudes in the first axial direction from the base portion, and
   the waveguide plate portion forms, as the antenna opening portion, the first antenna opening opened in the first axial direction and the second antenna opening opened in the second axial direction orthogonal to the first axis.
(18) The antenna array according to (17), in which
   the plurality of power feeding terminals is arrayed in the second axial direction at an interval that is ½ or less of a wavelength of radio waves used.
(19) The antenna array according to (17) or (18), further including:
   a shield portion which is provided between the plurality of power feeding terminals and provided for suppressing radio wave interference between the power feeding terminals adjacent to each other.
(20) The antenna array according to (19), in which
   the shield portion includes a plurality of columnar bodies penetrating the second region, and
   the plurality of columnar bodies is arrayed parallel to the first axial direction from a position opposing the plurality of power feeding terminals in the second axial direction toward the base portion, on both sides of each of the plurality of power feeding terminals.
(21) The antenna array according to (16), further including:
   a plurality of conductive columnar bodies which penetrates the dielectric block and is connected to the pair of conductor layers; and
   a post waveguide portion including at least one post waveguide surrounded by the pair of conductor layers and the plurality of conductive columnar bodies, in which
   the post waveguide portion includes a first post waveguide which is connected to the power feeding terminal and is formed from the power feeding terminal along the first axial direction, and
   the dielectric block includes a convex dielectric waveguide which is formed to protrude in front of the first post waveguide and forms, as the antenna opening portion, the first antenna opening opened in the first axial direction and the second antenna opening opened in the second axial direction.
(22) The antenna array according to (21), in which
   the post waveguide portion includes a plurality of post waveguides which includes the first post waveguide provided for each of the plurality of power feeding terminals and is formed along the first axial direction, and
   a center-to-center distance of the post waveguides adjacent to each other out of the plurality of post waveguides is ½ a wavelength of radio waves used.
(23) An antenna module, including:
   a transmission antenna constituted of the antenna element according to (1); and
   a reception antenna constituted of the antenna array according to (16).
(24) An antenna module, including:
   a transmission antenna constituted of the antenna element according to (2); and
   a reception antenna constituted of the antenna array according to (17).
(25) The antenna module according to (24), in which
   an interval between a central axis of the antenna element arranged on an outermost side of the antenna array that is to become the reception antenna and the second antenna opening is larger than an interval between a central axis of the antenna element constituting the transmission antenna and the second antenna opening.
(26) The antenna module according to (24) or (25), in which
   the pair of conductor layers include an end edge portion extending to a position of the power feeding terminal in the first axial direction at least one of between the transmission antenna and the reception antenna or between the antenna elements constituting the transmission antenna.
(27) The antenna module according to (26), further including:
   a post absorption wall in which a plurality of conductive columnar bodies which penetrates the dielectric block, is connected to the end edge portion, and is electrically separated from other conductor layers is arranged along the second axial direction.
(28) The antenna module according to any one of (24) to (27), further including:
   an LC resonator which includes a separated conductive foil separated from one of the pair of conductor layers and a conductive columnar body which connects the separated conductive foil to another one of the pair of conductor layers, and is arranged between the transmission antenna and the reception antenna.
(29) An antenna module, including:
   a transmission antenna constituted of the antenna element according to (9); and
   a reception antenna constituted of the antenna array according to (21).
(30) An antenna element, including:
   a dielectric block including a first region and a second region;
   a plurality of conductive columnar bodies which is arranged in the first region and penetrates the dielectric block in a thickness direction of the dielectric block;
   a power feeding terminal arranged in the second region; and
   a pair of conductor layers opposing each other with the dielectric block interposed therebetween, in which
   the pair of conductor layers each include a base portion which is arranged in the first region and is connected to the plurality of conductive columnar bodies and a waveguide plate portion which is arranged in the second region and protrudes in a first axial direction from the base portion, and
   the waveguide plate portion forms a first antenna opening opened in the first axial direction and a second antenna opening opened in a second axial direction orthogonal to the first axis.
(31) An antenna array, including:
   a dielectric block including a first region and a second region;
   a plurality of conductive columnar bodies which is arranged in the first region and penetrates the dielectric block;
   a plurality of power feeding terminals arranged in the second region; and
   a pair of conductor layers opposing each other with the dielectric block interposed therebetween, in which
   the pair of conductor layers each include a base portion which is arranged in the first region and is connected to the plurality of conductive columnar bodies and a waveguide plate portion which is arranged in the second region and protrudes in a first axial direction from the base portion, and
   the waveguide plate portion forms a first antenna opening opened in the first axial direction and a second antenna opening opened in a second axial direction orthogonal to the first axis.
(32) An antenna element, including:
   a dielectric block;
   a power feeding terminal provided in the dielectric block;
   a pair of conductor layers opposing each other with the dielectric block interposed therebetween;
   a plurality of conductive columnar bodies which penetrates the dielectric block and is connected to the pair of conductor layers; and
   a post waveguide portion including at least one post waveguide surrounded by the pair of conductor layers and the plurality of conductive columnar bodies, in which
   the post waveguide portion includes a center post waveguide which is connected to the power feeding terminal and is formed from the power feeding terminal along a first axial direction, and
   the dielectric block includes a dielectric convex portion which is formed to protrude in front of the center post waveguide and forms a first antenna opening opened in the first axial direction and a second antenna opening opened in a second axial direction orthogonal to the first axis.
(33) An antenna array, including:
   a dielectric block;
   a plurality of power feeding terminals provided in the dielectric block;
   a pair of conductor layers opposing each other with the dielectric block interposed therebetween;
   a plurality of conductive columnar bodies which penetrates the dielectric block and is connected to the pair of conductor layers; and
   a post waveguide portion including at least one post waveguide surrounded by the pair of conductor layers and the plurality of conductive columnar bodies, in which
   the post waveguide portion includes a center post waveguide which is connected to the power feeding terminal and is formed from the power feeding terminal along a first axial direction, and
   the dielectric block includes a dielectric convex portion which is formed to protrude in front of the center post waveguide and forms a first antenna opening opened in the first axial direction and a second antenna opening opened in a second axial direction orthogonal to the first axis.

### REFERENCE SIGNS LIST

1 dielectric multilayer substrate
10, 70 dielectric block
20, 80 conductor layer
20A, 80A first conductor layer
20B, 80B second conductor layer
21 base portion
22 waveguide plate portion
30 rear post wall
40, 401, 402, 403, 404, 405, 406 power feeding portion
41 power feeding probe
43 signal line
51, 71 first antenna opening
52, 72 second antenna opening
60 shield portion
75 convex dielectric waveguide
90 post waveguide portion
91a first post waveguide
91b, 91c second post waveguide
100, 100A, 100B, 110 antenna element
200, 201, 202, 720 reception antenna array
300, 400, 500, 600, 700 antenna module
P1, P3, P4, P5 conductive columnar body
P2 columnar body
Rx1, Rx2, Rx3, Rx4 reception antenna
Tx1, Tx3 transmission antenna

1. An antenna element, comprising:
a dielectric block;
a power feeding terminal provided in the dielectric block;
a pair of conductor layers opposing each other with the dielectric block interposed therebetween; and
an antenna opening portion which forms, in a plane direction along the pair of conductor layers, a first antenna opening opened in a first axial direction as viewed from the power feeding terminal and a second antenna opening opened in a second axial direction orthogonal to the first axis.

2. The antenna element according to claim 1, further comprising:
a plurality of conductive columnar bodies which is arranged in a first region of the dielectric block and penetrates the dielectric block in a thickness direction of the dielectric block, wherein
the power feeding terminal is arranged in a second region of the dielectric block,
the pair of conductor layers each include a base portion which is arranged in the first region and is connected to the plurality of conductive columnar bodies and a waveguide plate portion which is arranged in the second region and protrudes in the first axial direction from the base portion, and
the waveguide plate portion forms, as the antenna opening portion, the first antenna opening opened in the first axial direction and the second antenna opening opened in the second axial direction.

3. The antenna element according to claim 2, wherein
the plurality of conductive columnar bodies forms a post wall in which the plurality of conductive columnar bodies is arrayed along the second axial direction at an interval that is ¼ or less of a wavelength of electromagnetic waves that propagate through the dielectric block.

4. The antenna element according to claim 2, wherein
the power feeding terminal extends from one of the pair of conductor layers to another one of the pair of conductor layers, and
a length of the power feeding terminal along the thickness direction of the dielectric block is smaller than a thickness of the dielectric block.

5. The antenna element according to claim 4, wherein
the dielectric block includes a hole portion which is drilled from a side of the other one of the pair of conductor layers and has a depth that reaches the power feeding terminal.

6. The antenna element according to claim 5, wherein
the power feeding terminal has a length that is half the thickness of the dielectric block.

7. The antenna element according to claim 2, wherein
the waveguide plate portion includes a first waveguide plate region which protrudes in the first axial direction from the base portion by a first width and a second waveguide plate region which protrudes in the first axial direction from the first waveguide plate region by a second width larger than the first width.

8. The antenna element according to claim 2, wherein
the dielectric block further includes a third region which covers each of the first antenna opening and the second antenna opening.

9. The antenna element according to claim 1, further comprising:
a plurality of conductive columnar bodies which penetrates the dielectric block and is connected to the pair of conductor layers; and
a post waveguide portion including at least one post waveguide surrounded by the pair of conductor layers and the plurality of conductive columnar bodies, wherein
the post waveguide portion includes a first post waveguide which is connected to the power feeding terminal and is formed from the power feeding terminal along the first axial direction, and
the dielectric block includes a convex dielectric waveguide which is formed to protrude in front of the first post waveguide and forms, as the antenna opening portion, the first antenna opening opened in the first axial direction and the second antenna opening opened in the second axial direction.

10. The antenna element according to claim 9, wherein
the post waveguide portion includes a second post waveguide which is formed adjacent to the first post waveguide along the first axial direction, the second post waveguide having one end opened and another end closed in a same direction as the first post waveguide.

11. The antenna element according to claim 10, wherein
the first post waveguide and the second post waveguide are arrayed in the second axial direction at an interval that is ½ a wavelength of radio waves used.

12. The antenna element according to claim 10, wherein
a width of the convex dielectric waveguide in the second axial direction is equal to or larger than a width of the first post waveguide in the second axial direction and equal to or smaller than a center-to-center distance of the second post waveguides provided on both sides of the first post waveguide.

13. An antenna array, comprising:
a dielectric block;
a plurality of power feeding terminals provided in the dielectric block;
a pair of conductor layers opposing each other with the dielectric block interposed therebetween; and
an antenna opening portion which forms, in a plane direction along the pair of conductor layers, a first antenna opening opened in a first axial direction as viewed from the power feeding terminals and a second antenna opening opened in a second axial direction orthogonal to the first axis.

14. The antenna array according to claim 13, further comprising:
a plurality of conductive columnar bodies which is arranged in a first region of the dielectric block and penetrates the dielectric block in a thickness direction of the dielectric block, wherein
the plurality of power feeding terminals is arranged in a second region of the dielectric block,
the pair of conductor layers each include a base portion which is arranged in the first region and is connected to the plurality of conductive columnar bodies and a waveguide plate portion which is arranged in the second region and protrudes in the first axial direction from the base portion, and
the waveguide plate portion forms, as the antenna opening portion, the first antenna opening opened in the first axial direction and the second antenna opening opened in the second axial direction orthogonal to the first axis.

15. The antenna array according to claim 14, wherein
the plurality of power feeding terminals is arrayed in the second axial direction at an interval that is ½ or less of a wavelength of radio waves used.

16. The antenna array according to claim 14, further comprising:
a shield portion which is provided between the plurality of power feeding terminals and provided for suppressing radio wave interference between the power feeding terminals adjacent to each other.

17. The antenna array according to claim 16, wherein
the shield portion includes a plurality of columnar bodies penetrating the second region, and
the plurality of columnar bodies is arrayed parallel to the first axial direction from a position opposing the plurality of power feeding terminals in the second axial direction toward the base portion, on both sides of each of the plurality of power feeding terminals.

18. The antenna array according to claim 13, further comprising:
a plurality of conductive columnar bodies which penetrates the dielectric block and is connected to the pair of conductor layers; and
a post waveguide portion including at least one post waveguide surrounded by the pair of conductor layers and the plurality of conductive columnar bodies, wherein
the post waveguide portion includes a first post waveguide which is connected to the power feeding terminal and is formed from the power feeding terminal along the first axial direction, and
the dielectric block includes a convex dielectric waveguide which is formed to protrude in front of the first post waveguide and forms, as the antenna opening portion, the first antenna opening opened in the first axial direction and the second antenna opening opened in the second axial direction.

19. The antenna array according to claim 18, wherein
the post waveguide portion includes a plurality of post waveguides which includes the first post waveguide provided for each of the plurality of power feeding terminals and is formed along the first axial direction, and
a center-to-center distance of the post waveguides adjacent to each other out of the plurality of post waveguides is ½ a wavelength of radio waves used.

20. An antenna module; comprising a transmission antenna constituted of the antenna element according to claim 1.
